(19) United States
(12) Patent Application Publication
(10) Pub. No.: US 2022/0058552 A1
(43) Pub. Date: Feb. 24, 2022

(54) PROJECT MANAGEMENT SYSTEM, METHOD OF OPERATING PROJECT MANAGEMENT SYSTEM, AND NON-TRANSITORY COMPUTER-READABLE MEDIUM

(71) Applicant: MANAGEMENT SOLUTIONS CO., LTD., Tokyo (JP)

(72) Inventors: Shinya TAKAHASHI, Tokyo (JP); Toshinari GOTO, Tokyo (JP)

(73) Assignee: MANAGEMENT SOLUTIONS CO., LTD., Tokyo (JP)

(21) Appl. No.: 17/520,564

(22) Filed: Nov. 5, 2021

Related U.S. Application Data
(63) Continuation of application No. PCT/JP2019/018308, filed on May 7, 2019.

(51) Int. Cl. G06Q 10/06

(52) U.S. Cl. CPC G06Q 10/06313

(57) ABSTRACT

Provided is a project management system having functions of receiving one or more inputs regarding “problem information”, “risk information”, and “task information” (all of the problem information, risk information, and task information are “project management information”), holding the project management information in association with each piece of identification information, acquiring problem solution status information in association with problem identification information, and outputting the acquired information in association with the problem information.

### CROSS-REFERENCE TO RELATED APPLICATION

This application is a continuation application of International Application PCT/JP2019/018308 filed on May 7, 2019 and designated the U.S., the entire contents of which are incorporated herein by reference.

### FIELD

The present invention relates to a system that provides a mechanism for achieving a relatively large-scale single project or relatively large-scale multiple projects with relatively less manpower and a mechanism for inputting and managing information for efficient use of resources, and further a system that can enhance the project achievement ability of the members involved in the project.

### BACKGROUND

The above-mentioned system has existed as a system for sharing the progress of a so-called project. However, since the content of this system was, so to speak, only sharing memos of respective persons in charge on the cloud, there was a problem in that it was based on the subjectivity of each person in charge and did not lead to the growth of the person in charge (no opportunity to get hints) in that it was left to the discretion of each person in charge.

Therefore, Patent Document 1 (Japanese Laid-open Patent Publication No. 2013-061694) is mentioned as an attempt to solve a part of the above problems.

### SUMMARY

According to an aspect of the present disclosure, there is provided a project management system including: a memory; a processor coupled to the memory and the processor configured to: receive one or more inputs of problem information which is project management information and indicates a problem that must be resolved to achieve a goal of a project; hold one or more problem information in association with the problem identification information; acquire problem solution status information, which indicates a status in which the held problem is solved, in association with the problem identification information; associate the held problem information and the problem solution status information with each other to output an associated result; receive one or more inputs of risk information which is the project management information and indicates a risk assumed under a predetermined condition in achieving the goal of the project; hold one or more input risk information in association with risk identification information; acquire risk manifestation risk/high risk information, which indicates that the held risk has manifested or that the risk has increased, in association with the risk identification information; associate the held risk information with the risk manifestation risk/high risk information with each other to output an associated result; receive one or more inputs of task information which is the project management information and indicates a task that must be processed to achieve the goal of the project; holding one or more input task information in association with task identification information; acquire task processing status information which indicates a processing status of the held task, in association with the task identification information; associate the held task information with the task processing status information to output an associated result; receive an input of a change request of the project management information; hold the received change request of the project management information in association with the identification information for the change request of the project management information; acquire implementation information for the change request of the project management information, which indicates the implementation of the change request of the held project management information, in association with the identification information for the change request of the project management information; and change the project management information based on the acquired implementation information for the change request of the project management information.

In addition to the above features, the processor may be further configured to: acquire premise information, which is information that is a premise capable of identifying the project management information, in association with the project management information; and hold the acquired premise information in association with the project management information.

In addition to the above features, the processor may be further configured to: generate the problem information that must be solved based on the manifested risk and record the problem information in the problem information holding unit in association with the problem identification information, when the risk manifestation risk/high risk information, which is information indicating that the held risk has manifested, is acquired in association with the risk identification information.

In addition to the above features, the processor may be further configured to: input the task information to be associated with the newly generated and held problem information, in association with the problem information.

In addition to the above features, the processor may be further configured to: receive an input of experience information which includes successful experience information indicating a successful experience or/and failure experience information indicating a failure experience; store the received experience information in association with the project identification information; receive a viewing request of the stored experience information; and allow a user to view the experience information according to the received viewing request. The experience information may include one or more pieces of text information, video information, attached document information, still image information, and audio information.

In addition to the above features, the to receive an input of the experience information may include to receive an input of the experience information in association with the project management information.

In addition to the above features, the to receive an input of the change request of the project management information may include to complete a reception by embedding information in a template for specifying contents of the change request.

In addition to the above features, the to acquire implementation information for the change request of the project management information may include to generate the implementation information for the change request of the project management information, which is information to implement the change of the project management information, by embedding information in a template for specifying information necessary to implement the change request.

In addition to the above features, the to receive one or more inputs of risk information may include to receive an input of the risk information according to a risk navigation template that prompts input of information to be clarified in order to objectify the risk.

In addition to the above features, the to receive one or more inputs of risk information may include to receive an input of the risk information according to a risk quantification navigation template that prompts an input of information for quantifying the risk.

In addition to the above features, the to associate the held risk information with the risk manifestation risk/high risk information may include to map the held risk information.

In addition to the above features, the processor may be further configured to: acquire interrelated information which is information indicating an interrelationship of the problem information, the risk information, the task information and the premise information; and hold the acquired interrelationship information.

In addition to the above features, the processor may be further configured to: when the problem information and the task information are associated with each other, generate the problem solution status information, which is information indicating that the held problem has been solved, based on the task processing status information of the associated task information, and transmit the problem solution status information to the to acquire problem solution status information.

In addition to the above features, the processor may be further configured to: receive an input of the change of premise information associated with the project management information; and prompt a correction of the project management information associated with the premise information.

In addition to the above features, the processor may be further configured to: receive an input of a stakeholder related to the achievement of the goal of the project in association with an index value indicating an attribute of the stakeholder; generate a map of the stakeholder using the stakeholder and the received index value associated with the stakeholder; and output the generated map.

In addition to the above features, the processor may be further configured to: acquire status information map which is information that maps status information; and output the acquired status information map.

In addition to the above features, the processor may be further configured to: hold member team identification information that identifies a member or a team composed of members to achieve the goal of the project; hold a member team project management information relationship that associates the member team identification information with the project management information in which a member team is engaged; and output the held member team project management information relationship.

The present disclosure also provides a method of operating the project management system, and a non-transitory computer-readable medium having stored therein a program.

Based on the above, the present disclosure intends to provide a project management system that can realize a project management system. Further, it is intended to have an educational effect by allowing a user to input information on problems, tasks, and risks and to unitarily manage and browse the information. In particular, regarding the entry items to be changed, making an entry using a template causes a person who fills out the template to consider “item to be considered” and “item to be confirmed”, so that it is intended to have an educational effect by lowering a so-called degree of freedom.

### BRIEF DESCRIPTION OF THE DRAWINGS

FIG. 1 is a diagram illustrating a hierarchy status such as “project”, “problem”, “task”, “risk”, and “premise”;

FIG. 2 is a conceptual diagram illustrating an example of a portal screen for inputting various information;

FIG. 3 is a conceptual diagram illustrating an example of an input screen of “project management information”;

FIG. 4 is a conceptual diagram illustrating an example of a new project input screen using an individual slip;

FIG. 5 is a conceptual diagram illustrating an example of a project content correction screen;

FIG. 6 is a conceptual diagram illustrating an example of a member input screen;

FIG. 7 is a conceptual diagram illustrating an example of a portal screen for inputting and correcting problem information;

FIG. 8 is a conceptual diagram illustrating an example of a new problem input screen;

FIG. 9 is a conceptual diagram illustrating an example of a problem-specific progress report input screen;

FIG. 10 is a conceptual diagram illustrating an example of a portal screen for inputting and correcting task information;

FIG. 11 is a conceptual diagram illustrating an example of a new task input screen;

FIG. 12 is a conceptual diagram illustrating an example of a screen for selecting a task attribute;

FIG. 13 is a conceptual diagram illustrating an example of a task-specific progress report input screen;

FIG. 14 is a conceptual diagram illustrating an example of a portal screen for inputting and correcting risk information;

FIG. 15 is a conceptual diagram illustrating an example of a new risk input screen;

FIG. 16 is a conceptual diagram of an example of a risk-specific progress report input screen;

FIG. 17 is a conceptual diagram illustrating an example of an input screen of change (correction) content definition received by a unit for receiving change request of project management information;

FIG. 18 is a diagram illustrating an example of a customer request content conformity check;

FIG. 19 is a conceptual diagram illustrating an example of a portal screen for inputting and correcting premise information;

FIG. 20 is a conceptual diagram illustrating an example of a new premise information input screen;

FIG. 21 is a diagram illustrating an example of a list of element attributes;

FIG. 22 is a flowchart of processing content performed by a generation problem recording unit;

FIG. 23 is a conceptual diagram illustrating an example of a portal screen for inputting and correcting experience information;

FIG. 24 is a conceptual diagram illustrating an example of a new experience information input screen;

FIG. 25 is a diagram illustrating an example of a case where input of the experience information is received by an audio file, a video file, a text file, a photo file, a WEB URL, a storage ID, or the like;

FIG. 26 is a diagram illustrating an example of mapped risk information (risk map);

FIG. 27 is a diagram illustrating an example of a stakeholder map;

FIGS. 28A to 28C are diagrams illustrating a functional configuration of a project management system according to a first embodiment;

FIGS. 29A and 29B are diagrams illustrating a hardware configuration of the project management system according to the first embodiment;

FIG. 30 is a flowchart illustrating processing when the project management system according to the first embodiment is used (problem information relation);

FIG. 31 is a flowchart illustrating processing when the project management system according to the first embodiment is used (risk information relation);

FIG. 32 is a flowchart illustrating processing when the project management system according to the first embodiment is used (task information relation);

FIG. 33 is a flowchart illustrating processing when the project management system according to the first embodiment is used (project content change relation);

FIG. 34 is a flowchart illustrating processing related to output of respective information;

FIGS. 35A to 35C are diagrams illustrating a functional configuration of the project management system according to a second embodiment;

FIGS. 36A and 36B are diagrams illustrating a hardware configuration of the project management system according to the second embodiment;

FIG. 37 is a flowchart illustrating processing when the project management system according to the second embodiment is used;

FIGS. 38A to 38C are diagrams illustrating a functional configuration of the project management system according to a third embodiment;

FIGS. 39A and 39B are diagrams illustrating a hardware configuration of the project management system according to the third embodiment;

FIG. 40 is a flowchart illustrating processing when the project management system according to the third embodiment is used;

FIGS. 41A to 41C are diagrams illustrating a functional configuration of the project management system according to a fourth embodiment;

FIGS. 42A and 42B are diagrams illustrating a hardware configuration of the project management system according to the fourth embodiment;

FIGS. 43A to 43D are diagrams illustrating a functional configuration of the project management system according to a fifth embodiment;

FIGS. 44A and 44B are diagrams illustrating a hardware configuration of the project management system according to the fifth embodiment;

FIG. 45 is a flowchart illustrating processing when the project management system according to the fifth embodiment is used;

FIGS. 46A to 46D are diagrams illustrating a functional configuration of the project management system according to a sixth embodiment;

FIGS. 47A and 47B are diagrams illustrating a hardware configuration of the project management system according to the sixth embodiment;

FIG. 48 is a flowchart illustrating processing when the project management system according to the sixth embodiment is used;

FIGS. 49A to 49C are diagrams illustrating a functional configuration of the project management system according to a seventh embodiment;

FIGS. 50A and 50B are a diagram illustrating a hardware configuration of the project management system according to the seventh embodiment;

FIG. 51 is a flowchart illustrating processing when the project management system according to the seventh embodiment is used;

FIGS. 52A to 52C are diagrams illustrating a functional configuration of the project management system according to an eighth embodiment;

FIGS. 53A and 53B are diagrams illustrating a hardware configuration of the project management system according to the eighth embodiment;

FIG. 54 is a flowchart illustrating processing when the project management system according to the eighth embodiment is used;

FIGS. 55A to 55C are diagrams illustrating a functional configuration of the project management system according to a ninth embodiment;

FIGS. 56A and 56B are diagrams illustrating a hardware configuration of the project management system according to the ninth embodiment;

FIG. 57 is a flowchart illustrating processing when the project management system according to the ninth embodiment is used;

FIGS. 58A to 58C are diagrams illustrating a functional configuration of the project management system according to a tenth embodiment;

FIGS. 59A and 59B are diagrams illustrating a hardware configuration of the project management system according to the tenth embodiment;

FIG. 60 is a flowchart illustrating processing when the project management system according to the tenth embodiment is used;

FIGS. 61A to 61C are diagrams illustrating a functional configuration of the project management system according to an eleventh embodiment;

FIGS. 62A and 62B are diagrams illustrating a hardware configuration of the project management system according to the eleventh embodiment;

FIG. 63 is a flowchart illustrating processing (i.e., processing related to output) when the project management system according to the eleventh embodiment is used;

FIGS. 64A to 64C are diagrams illustrating a functional configuration of the project management system according to a twelfth embodiment;

FIGS. 65A and 65B are diagrams illustrating a hardware configuration of the project management system according to the twelfth embodiment;

FIG. 66 is a flowchart illustrating processing when the project management system according to the twelfth embodiment is used;

FIGS. 67A to 67C are diagrams illustrating a functional configuration of the project management system according to a thirteenth embodiment;

FIGS. 68A and 68B are diagrams illustrating a hardware configuration of the project management system according to the thirteenth embodiment;

FIG. 69 is a flowchart illustrating processing when the project management system according to the thirteenth embodiment is used;

FIG. 70A to 70C are diagrams illustrating a functional configuration of the project management system according to a fourteenth embodiment;

FIGS. 71A and 71B are diagrams illustrating a hardware configuration of the project management system according to the fourteenth embodiment;

FIG. 72 is a flowchart illustrating processing when the project management system according to the fourteenth embodiment is used;

FIGS. 73A to 73C are diagrams illustrating a functional configuration of the project management system according to a fifteenth embodiment;

FIGS. 74A and 74B are diagrams illustrating a hardware configuration of the project management system according to the fifteenth embodiment;

FIG. 75 is a flowchart illustrating processing when the project management system according to the fifteenth embodiment is used;

FIGS. 76A to 76C are diagrams illustrating a functional configuration of the project management system according to a sixteenth embodiment;

FIGS. 77A and 77B are diagrams illustrating a hardware configuration of the project management system according to the sixteenth embodiment;

FIG. 78 is a flowchart illustrating processing when the project management system according to the sixteenth embodiment is used;

FIGS. 79A to 79D are diagrams illustrating a functional configuration of the project management system according to a seventeenth embodiment;

FIGS. 80A and 80B are diagrams illustrating a hardware configuration of the project management system according to the seventeenth embodiment; and

FIG. 81 is a flowchart illustrating processing when the project management system according to the seventeenth embodiment is used.

### DESCRIPTION OF EMBODIMENTS

Patent Document 1 (Japanese Laid-open Patent Publication No. 2013-061694) is a risk management tool that manages a plurality of risks of a project, and a risk management system that updates a degree of impact on the risks and the probability of occurrence of the risks, and a weight of risk measures as the project progresses, and generates a priority of the risk measures.

However, Patent Document 1 disclose a function intended to calculate the risks in consideration of a potential possibility and the degree of impact. However, since Patent Document 1 does not disclose the specific contents of the risk management, and it is important to take measures based on the progress of the project as a whole, the management of only the risks is not necessarily a significant contribution to the success of the project. Although the risk management is important for the success of the project, it is also important to have accurate understanding of the risks and problems, to manage the progress based on the accurate understanding, and to have accurate understanding of the dynamic modification of the project tasks and other aspects of the project in the event of delays in progress or the appearance of risks, as well as the expected impact in response to the modification.

It is an object of the present disclosure to provide a project management system that unitarily manage information on problems, tasks, and risks.

Hereinafter, embodiments of the present disclosure will be described with reference to the accompanying drawings. The interrelationship between the embodiments and claims is as follows. A first embodiment relates to claims 1, 19, and 20. A second embodiment relates to claim 3. A third embodiment relates to claim 4. A fourth embodiment relates to claim 4. A fifth embodiment relates to claims 5 and 6. A seventh embodiment relates to claim 8. An eighth embodiment relates to claim 9. A ninth embodiment relates to claim 10. A tenth embodiment relates to claim 11. An eleventh embodiment relates to claim 12. A twelfth embodiment relates to claim 13. A thirteenth embodiment relates to claim 14. A fourteenth embodiment relates to claim 15. A fifteenth embodiment relates to claim 16. A sixteenth embodiment relates to claim 17. A seventeenth embodiment relates to claim 18. Each claim is not limited to the above embodiment, and various changes and modifications may be made to the embodiments without departing from the scope of the invention disclosed in the claims.

<Hardware Capable of Executing the Present Disclosure>

In principle, this disclosure uses a computer, but it can be realized by software, by hardware, or by the collaboration of software and hardware. The hardware that realizes all or part of each element in each claim includes the basic components of a computer such as a CPU, a memory, a bus, an input/output device, various peripheral devices, and an user interface. Various peripheral devices include storage devices, interfaces such as Internet, devices connected to Internet, displays, keyboards, mice, speakers, cameras, video devices, televisions, various sensors for monitoring production status in laboratories or factories (e.g. flow sensors, temperature sensors, weight sensors, liquid volume sensors, infrared sensors, shipping piece counters, packing piece counters, foreign material inspection devices, defective product counters, radiation inspection devices, surface condition inspection devices, circuit inspection devices, motion sensors, worker work status monitoring devices (by video, ID, PC workload, etc.), CD machines, DVD machines, Blu-ray machines, USB memory, USB memory interface, removable hard disks, general hard disks, projector devices, SSDs (Solid State Drive), telephones, fax machines, copiers, printing devices, movie editing devices, various sensor devices, or the like. This system does not necessarily have to be configured by one housing, but may be configured by combining a plurality of housings by communication. The communication may be a LAN, WANWifi, Bluetooth (registered trademark), infrared communication, ultrasonic communication, and a part of the communication may be installed across national borders. Furthermore, each of the plurality of housings may be operated by a different operational entity, or by a single operational entity. It does not matter whether the system of the present disclosure is operated by one or more entities. In addition to this system, the invention can be configured as a system including a terminal used by a third party and a terminal used by another third party. In addition, these terminals may be installed across national borders. Furthermore, in addition to this system and the terminals, a device used for registering related information and related persons of a third party, a device used for a database for recording the contents of registration, and the like may be prepared. These devices may be provided in this system, or they may be provided outside of this system, and this system may be configured to make information of these devices available.

<Sufficiency of Use of Natural Law>

This invention works in cooperation with a computer, communication facilities, and software. This invention makes it possible not only to use ICT (Information and Communication Technology) to handle processes that were previously done by project participants in interviews, but also to use ICT to determine the effects of many complex information exchanges, procedures, authentication, and settlements related to projects, and to support the accumulation, retention, and exchange of effective information via ICT that meets all the necessary requirements that could not be created without skill. This invention is a so-called business model patent because it includes a process unique to ICT. In addition, various types of identification information, risk information, task information, and task information are held or processed in each part. From this point of view, if the invention is judged on the basis of the resources such as computers described in the claims and the specification, and the common sense of the art related to those matters, the invention is based on the use of natural laws.

<Significance of Use of Natural Law as Required by Patent Law>

The use of the laws of nature required by the Patent Law is required to ensure that an invention is industrially useful from the viewpoint that the invention must have industrial applicability and contribute to the development of industry, based on the purpose of the law. In other words, it requires that the invention be industrially useful, i.e., that the effect of the invention declared in the application can be reproduced with a certain degree of certainty through the implementation of the invention. From this point of view, natural law usability is interpreted to mean that the function of each of the invention specific matters (invention constituent requirements), which are the composition of the invention to realize the effect of the invention, should utilize natural laws. Furthermore, the effect of an invention should be the possibility of providing a given usefulness to the users of the invention, not how the users feel or think about the usefulness. Therefore, even if the effect that the user obtains from this system is a psychological effect, the effect itself is an event that is not subject to the required natural law usability.

### First Embodiment

The embodiments provides a project management system having functions of (1) receiving one or more inputs for each of problem information indicating the problems that must be resolved in order to achieve a goal of a project, risk information indicating a risk that is assumed under certain conditions in order to achieve the goal of the project, and task information indicating a task that must be processed in order to achieve the goal of the project (the problem information, the risk information, and the task information are all “project management information”); (2) holding project management information in association with respective identification information; (3) acquiring problem solution status information in association with problem identification information and outputting the problem solution status information in association with the problem information; (4) acquiring risk manifestation risk/high risk information in association with risk identification information and output the risk manifestation risk/high risk information in association with the risk information; (5) acquiring task processing status information in association with task identification information and outputting the task processing status information in association with the task information; and (6) receiving necessary input of a change request of the project management information, holding the received change request of the project management information in association with identification information for the change request of the project management information, acquiring implementation information for the change request of the project management information, which indicates the implementation of the change request of the project management information, in association with identification information for the change request of the project management information, and changing the project management information based on the acquired implementation information for the change request of the project management information.

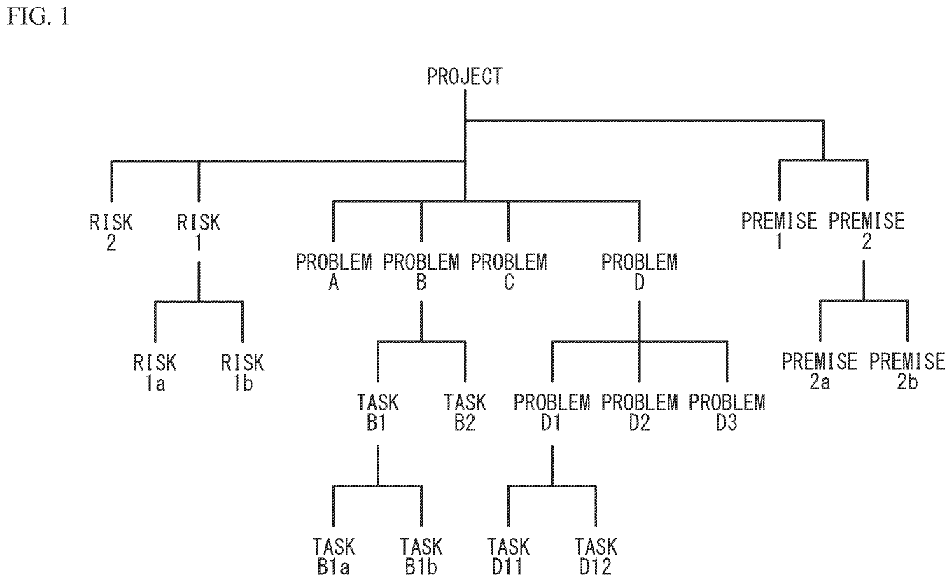

FIG. 1 is a diagram illustrating a hierarchy status such as “project”, “problem”, “task”, “risk”, and “premise”. As illustrated in FIG. 1, there is a concept of a project, “problem” as a sub-concept of the project, and “task” as a further sub-concept of the “problem”. Then, “risk” and “premise” are ultimately associated with the “project”, but they may be associated with each “problem” and each “task”. The “problem” and the “task” may have a hierarchical structure of problems and tasks, respectively. Specifically, as illustrated in FIG. 1, there may be a problem A, a problem B, a problem C, and a problem D as sub-concepts of the project, and a problem D1, a problem D2 and a problem D3 as sub-concepts of the problem D. This applies not only to the “problem” but also to the “premise”, the “risk” and the “task”. Furthermore, there may be another generic concept than the “project”, which collectively represents a plurality of projects.

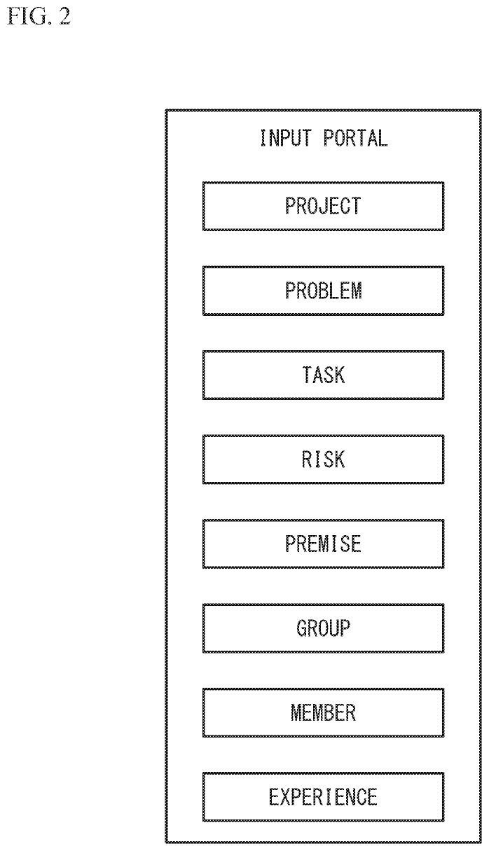

FIG. 2 is a conceptual diagram illustrating an example of a portal screen for inputting various information. The portal screen has selection parts such as “project”, “problem”, “task”, “risk”, “premise”, “group”, “member” and “experience”. By selecting one of them, the portal screen shifts to a next screen. Note that this is only a conceptual drawing and is not limited to such a design (the same applies to each drawing below). The feature of this disclosure is that the screen receives input of information by means of individual slips in a unit of identification of information. By forcing the input of the information using the individual slip in the identification unit of information, the screen is an interface that requires the input person to input the required information specified in the individual slip without fail, which prevents the omission of input of necessary information and brings about an effect that information is accurate in the unit of identification.

Hereinafter, the functional configuration, the hardware configuration and the flow of processing of the project management system in this embodiment are described in order.

<Functional Configuration>

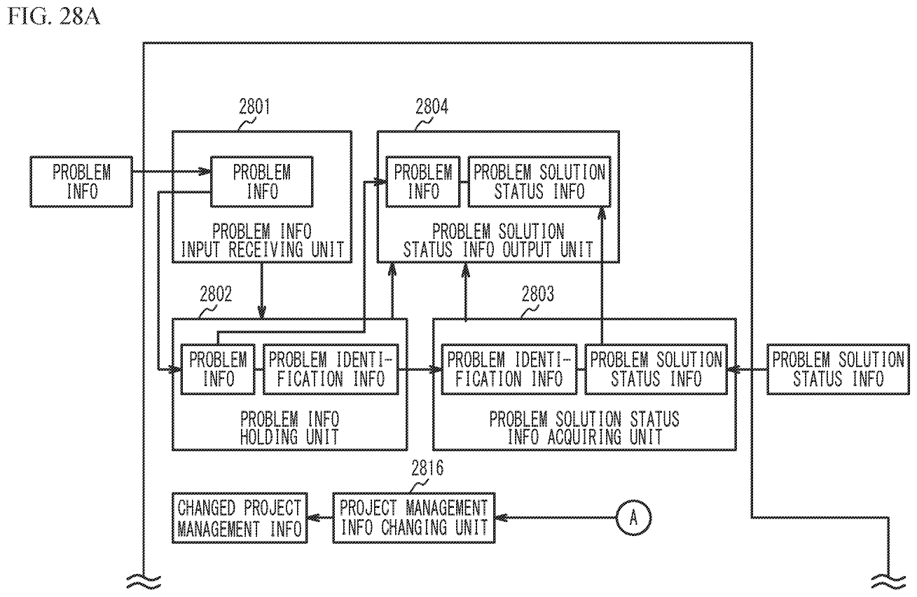

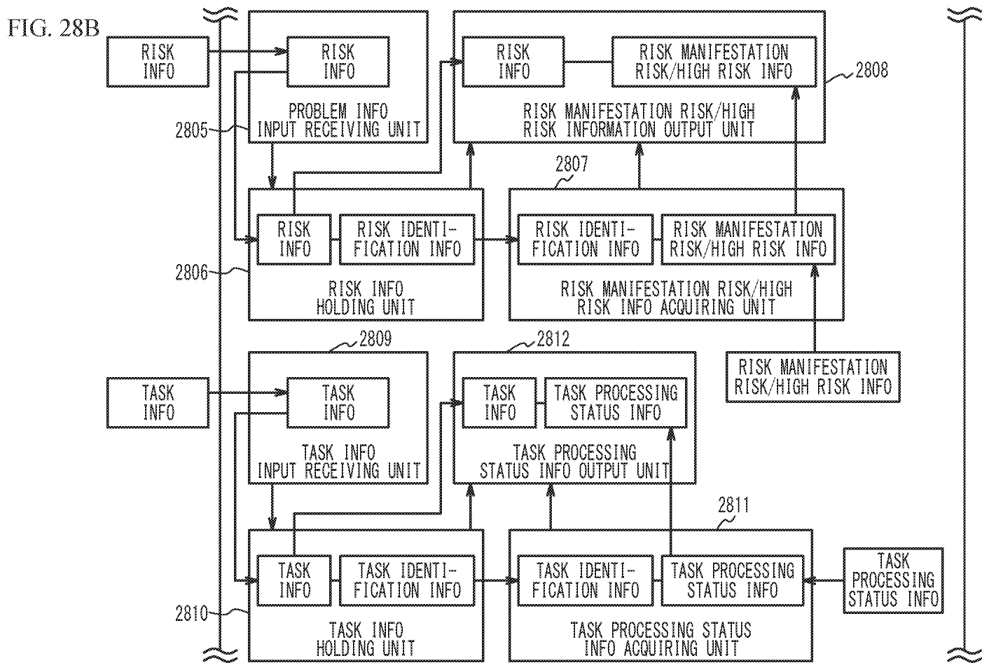

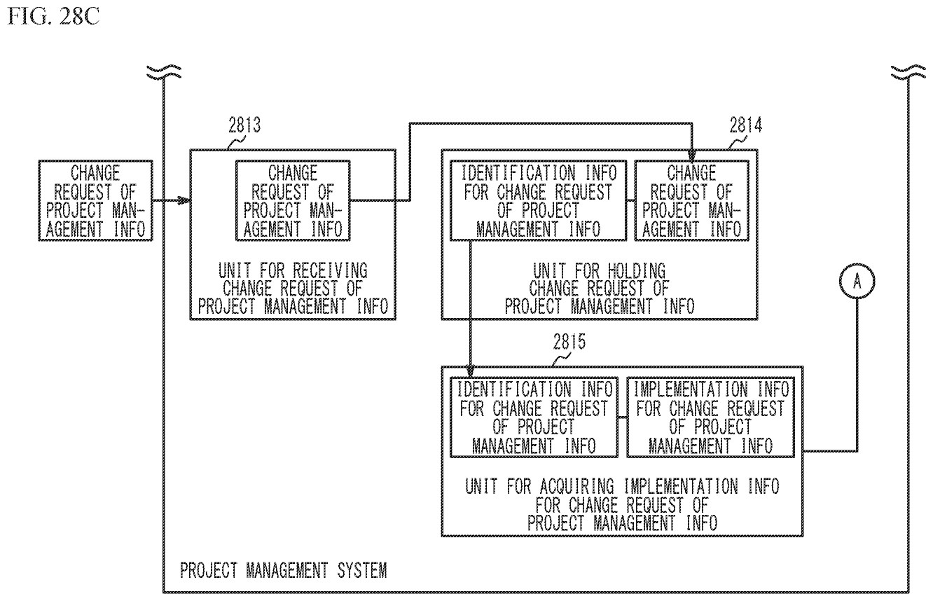

FIGS. 28A to 28C are diagrams illustrating the functional configuration of the project management system according to the first embodiment. The project management system according to the first embodiment includes a problem information input receiving unit (2801), a problem information holding unit (2802), a problem solution status information acquiring unit (2803), a problem solution status information output unit (2804), a risk information input receiving unit (2805), a risk information holding unit (2806), a risk manifestation risk/high risk information acquiring unit (2807), a risk manifestation risk/high risk information output unit (2808), a task information input receiving unit (2809), a task information holding unit (2810), a task processing status information acquiring unit (2811), a task processing status information output unit (2812), a unit for receiving change request of project management information (2813), a unit for holding change request of project management information (2814), a unit for acquiring implementation information for change request of project management information (2815), a project management information changing unit (2816). Hereinafter, the basic matters that apply to the entire disclosure are first described, and then the contents of each function will be described in detail.

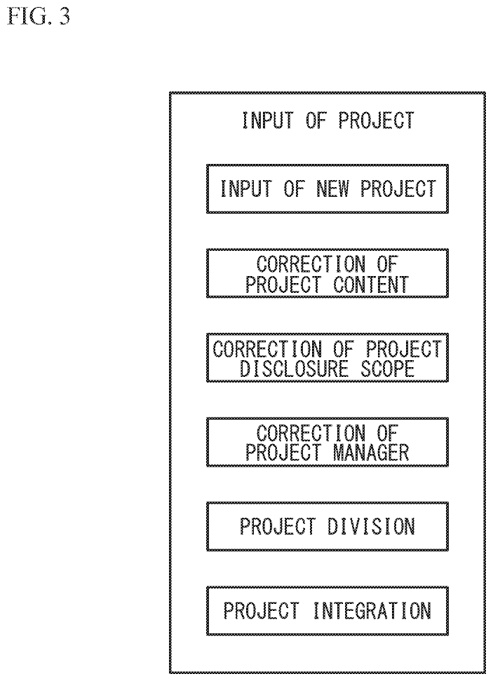

FIG. 3 is a conceptual diagram illustrating an example of an input screen of “project management information”. The input screen includes items such as “input of new project”, “correction of project content”, “correction of project disclosure scope”, “correction of project manager”, “project division”, and “project integration”. By selecting one of these, the input screen shifts to a corresponding screen. The “input of new project” and the “correction of project content” are described later. The “correction of project disclosure scope” is for correcting the scope of those who are authorized to view the project. The “correction of project manager” is for correcting a manager of the project. The “project division” is for dividing a single project into two or more, and the “project integration” is for combining a plurality of projects into the single project.

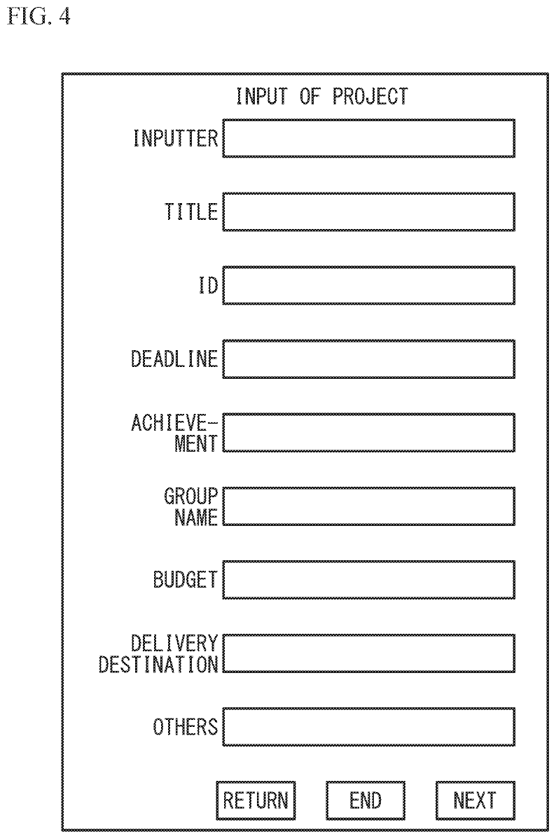

FIG. 4 is a conceptual diagram illustrating an example of a new project input screen using an individual slip. The new project input screen includes items such as “inputter”, “title”, “ID”, “deadline”, “achievement”, “group name”, “budget”, “delivery destination”, and “others”, and the project is registered by inputting data into the items. After inputting data into the items, the project is registered when “end” is selected, the input screen returns to a previous screen without registering the project when “return” is selected, and the input screen shifts to a second page of “input of project” or shifts to another screen such as problem input when “next” is selected. The term “individual slip” indicates an information input format that is prepared for each unit of identifying information, and is not a term that can be interpreted as limited to a single sheet on a screen. The items “inputter”, “title”, “ID”, “deadline”, “achievement”, “group name”, “budget”, “delivery destination”, and “others” are illustrated as free-format input, but they may be selected by pull-down menus or other methods, or they may look like free-format inputs but actually accept only registered character strings. It is preferable that the input information is held in association with the input time based on the time information from a separately installed timekeeping unit, and that measures be taken to prevent tampering with the input information. Measures to prevent tampering include retaining input information in a non-rewritable form, obtaining a hash value of the input information and holding it in a safe area in association with the project ID, and so on. When inputting a project, a face image of the inputter may be acquired from a camera or other device on the input terminal, and the authority of the inputter may be checked using an authority database linked to the face recognition data. In this case, the system may be configured to determine whether the value text-inputted as the inputter matches the inputter associated with the authority database. Alternatively, the inputter may be automatically input based on the content of the check in the authority database.

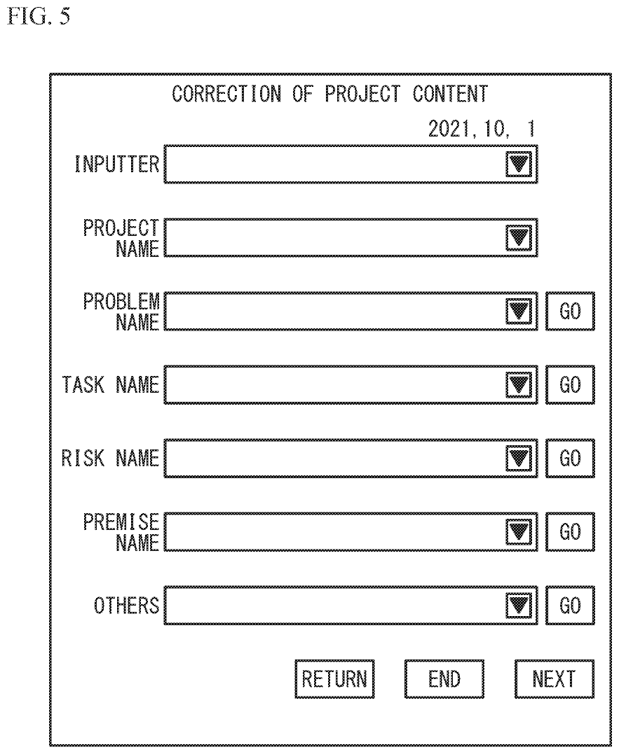

FIG. 5 is a conceptual diagram illustrating an example of a project content correction screen. The project content correction screen includes items such as “inputter”, “project name”, “problem name”, “task name”, “risk name”, “premise name” and “others”, and the contents of the project are corrected by inputting data into the items. Since it is assumed that the contents of the project have already been registered, each item may be selected by a pull-down menu. After inputting data into the items, the project is registered when “end” is selected, the correction screen returns to a previous screen without registering the project when “return” is selected, and the correction screen shifts to another screen such as problem input when “next” is selected. Since the correction of the project content is an important matter regarding the achievement of the project, it is desirable to have the same authority check as the input of the project.

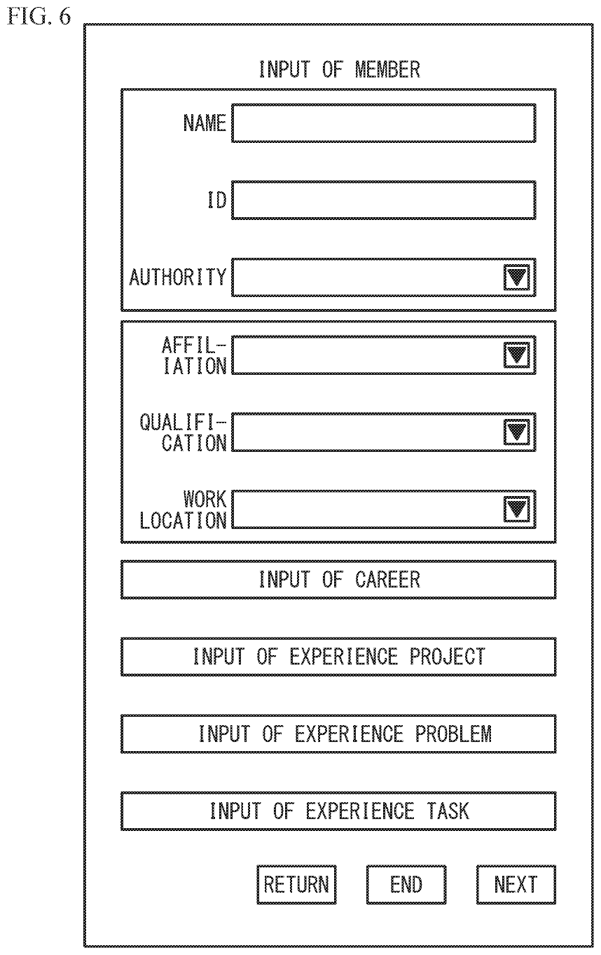

FIG. 6 is a conceptual diagram illustrating an example of a member input screen. The member input screen includes items such as “name”, “ID”, “authority”, “affiliation”, “qualification” and “work location”, and the member information is registered by inputting data into the items. In this case, since the candidate of the content to be input in advance can be predicted, each item may be selected by the pull-down menu. In addition, when “input of career”, “input of experience project”, “input of experience problem” or “input of experience task” is selected, the member input screen may shift to a detailed input screens corresponding to the selected item. The screen after the shift can be the free input format or the pull-down system. After inputting data into the items, the member information is registered when “end” is selected, the member input screen returns to a previous screen without registering the member information when “return” is selected, and the member input screen shifts to another screen such as problem input when “next” is selected. It is preferable that the career, the experience project, the experience problem, the experience task entered here be stored in a database so that they can be searched and viewed by people other than those involved in the project. In this case, the system can be configured to search with the name hidden, or the system can be configured to search with the name displayed. Even if the name is not displayed, the system can be configured so that the inputter of the career discloses himself/herself only to the searcher upon the searcher's request. This can be used to gather the right members for a new project when the new project is launched, or to provide information to accomplish the next project to the searcher, thereby enlarging the width of the use.

The problem information input receiving unit has a function of receiving one or more inputs of problem information which is project management information and indicates the problem that must be resolved in order to achieve the goal of the project. The “problem information” described here, and the “task information”, “risk information” and “premise information” described below are all included in the “project management information”. The reception of each information input may be automatically migrated from Excel or Word data through the present invention. The present invention may be equipped with a function to provide compatibility for such automatic migration. This is also applied to embodiments below.

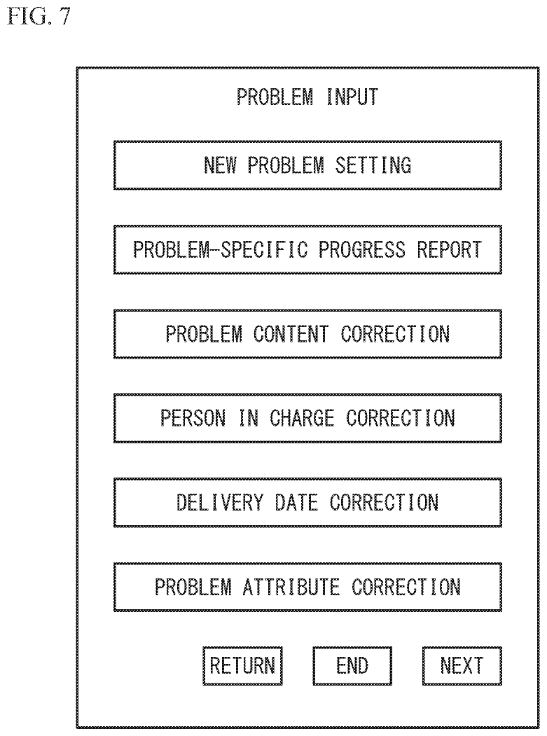

FIG. 7 is a conceptual diagram illustrating an example of a portal screen for inputting and correcting problem information. The portal screen includes items such as “new problem setting”, “problem-specific progress report”, “problem content correction”, “assignment correction”, “delivery date correction”, and “problem attribute correction”. By selecting one of these items, the portal screen shifts to the next screen corresponding to the selected item.

The “problem” is an element that must be solved in order to achieve the purpose of the project. Conversely, solving all the planned problem will automatically achieve the purpose of the project. Thus, the problem should be set by a person who has a generic conceptual understanding of the project, and the system should be designed to allow a person having a prescribed qualification authenticated by an input ID to perform the setting of the problem. The system can also be designed so that the problem is associated with a predetermined category in the system and the project attribute is set prior to the input of problem to encourage the input of necessary problem into the category.

For example, if the project attribute is sales promotion of a magazine, the category of the problem includes various item such as procuring the budget for the sales promotion activities, selecting the sales promotion format to be adopted in the sales promotion activities, selecting the most appropriate media and activities to be applied to the selected sales promotion format, planning the magazine structure to be proposed to the magazine production side for the sales promotion activities, and obtaining the approval of the magazine production side for the proposed plan. Alternatively, if the project is the development of a new model car, it is preferable to prepare categories of problems that are relevant to the project, and design the system in such a way that the inputter can input information in a fail-safe manner without being aware of it. It is preferable to have the inputter input the data using the individual slip of a predetermined format.

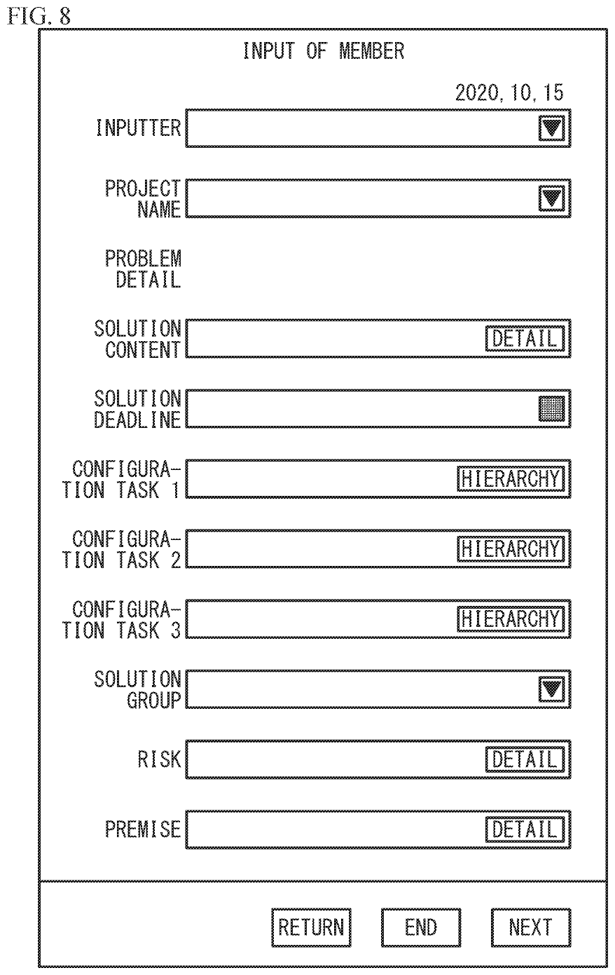

FIG. 8 is a conceptual diagram illustrating an example of a new problem input screen. The new problem input screen includes such as “inputter”, “project”, and further “solution content”, “solution deadline”, “configuration task (this may be a plurality of configuration tasks)”, “solution group”, “risk”, “premise” as problem details, and the project is registered by inputting data into the items. Since it is assumed that the contents of the project have already been registered, each item may be selected by the pull-down menu. The deadline may be selected from a calendar. It is assumed that selecting a “detail” button shifts from the new problem input screen to a screen for inputting details. The “hierarchy” button allows the inputter to select the hierarchy of each task when there is a hierarchy between the tasks. After inputting data into the items, the project is registered when “end” is selected, the new problem input screen returns to the previous screen without registering the project when “return” is selected, and the new problem input screen shifts to another screen such as problem input when “next” is selected.

The “problem information holding unit” has a function of holding one or more problem information in association with the problem identification information. It is preferable that the problem identification information can be recognized as the identification information of the specific concept with respect to the project identification information of the generic concept. This is because of facilitating the information management by the computer. In addition, there is the deadline for holding the problem information, but it is preferable to hold the problem information as historical information even after the project is completed. This is because it is possible to perform machine learning from the historical information in the future. Furthermore, the system can be configured so that AI (Artificial Intelligence) learns this historical information and the final project results to suggest a setting method of optimum problems. The problem identification information is associated with all the information about the input task.

The “problem solution status information acquiring unit” has a function of acquiring the problem solution status information, which indicates a status in which the held problem is solved, in association with the problem identification information.

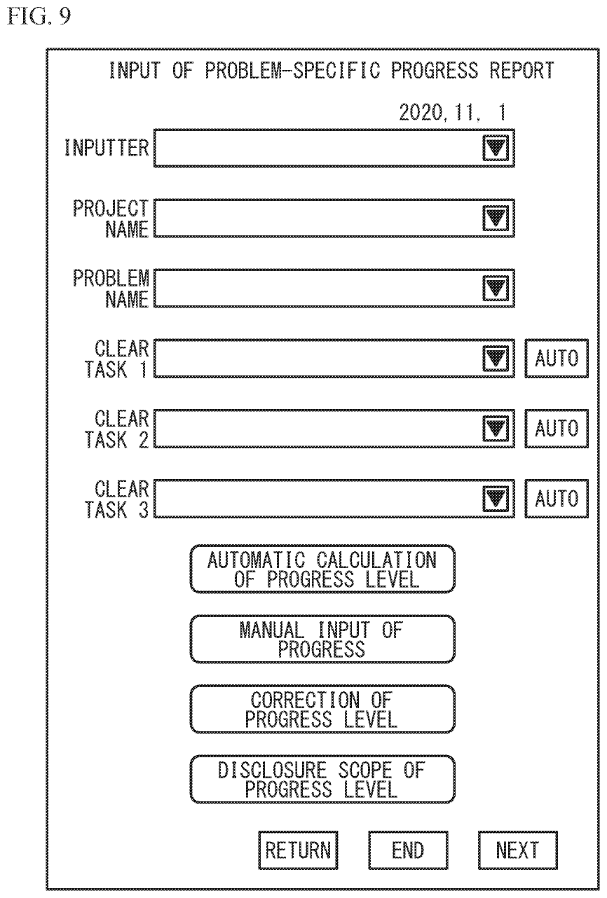

FIG. 9 is a conceptual diagram illustrating an example of a problem-specific progress report input screen. For example, “inputter”, “project name”, “problem name”, “clear task(s)” and the like are inputted in the problem-specific progress report input screen. Since it is assumed that the contents of the project have already been registered, each item may be selected by the pull-down menu. Selecting the “Auto” button automatically inputs the task that is cleared there by referring to the registration information in the task. In addition, the problem-specific progress report input screen has buttons such as “automatic calculation of progress level”, “manual input of progress level”, “correction of progress level” and “disclosure scope of progress level”. For example, if “automatic calculation of progress level” is selected, the system automatically calculates a progress level of the problem itself by referring to the input clear task and the status of the registered tasks. In this case, the system may automatically calculate the progress level with higher accuracy not only simply by considering the overall task volume and the number of clear tasks, but also by considering the weighting of, for example, the time and manpower required to clear each task. Next, “manual input of progress level” and “correction of progress level” are registered by inputting the progress level by the inputter. In this case, there may be a request for confirmation by an authority since the progress level depends on the subjectivity of the inputter. The “disclosure scope of progress level” is a registration related to the scope of people who are authorized to view the progress level.

The “problem solution status information output unit” has a function of associating the held problem information and the problem solution status information with each other to output an associated result. It is preferable to configure the system in such a way that a participant of the project, an orderer of the project, and a manager of the project can view the solution status of the problem in order to know the progress of the project. However, in some projects, each problem itself may be highly confidential information, and the system may be designed so that not all project participants can view the solution status of all problems, but an authorizer can view the solution status of only a limited scope of problems for the authorizer. In addition, the problem solution status information may be divided into several information hierarchies and viewed. For example, there are a case where only the problem ID is disclosed instead of the problem name, a case where the problem content is disclosed, a case where the problem content is not disclosed, a case where the progress level of the problem is disclosed precisely and precisely, and a case where the progress level of the problem is disclosed roughly in three or five steps. Thus, the system may be designed so as to optimize a disclosure method of the problem according to the information access authority of the viewer by incorporating various disclosure systems. In addition, it is possible to configure the system to optimize the case where the information can be viewed in real time and the case where the information can be viewed with a predetermined time lag, depending on the information access authority of the viewer. It is also possible to design the system so that a person who wants to view the information can inquire about it to a project leader who has the authority to make the information available to the public at the time of the request for viewing, and can view the information in a specified scope based on the access authority granted by the approval if the approval is obtained. The output of each information may be automatically migrated to Excel or Word data through the present invention. The present invention may be equipped with a function to provide compatibility for such automatic migration. This is also applied to embodiments below.

The “risk information input receiving unit” has a function of receiving one or more inputs of risk information, which is project management information and indicates the risk assumed under a predetermined condition in achieving the goal of the project.

The “risk information” is an event that does not affect the progress of the project unless it becomes apparent, but if it becomes apparent, it will affect the project in some way. For example, in the case of the construction of a large facility, the risk information may include: soaring material costs, occurrence of natural disasters, failure to secure workers, business crisis of the client, occurrence of legal problems (environmental problems, pollution, residents' movements, scandals), occurrence of serious accidents during construction, shortage of construction equipment (e.g. tunnel shield machines, dump trucks, trailers, excavators, or the like), suspension or cancellation of construction due to political reasons (e.g., cancellation of dam construction, cancellation of highway construction, or the like), soaring labor costs, large fluctuations in foreign exchange rates if the project is affected by foreign exchange rates, and the like.

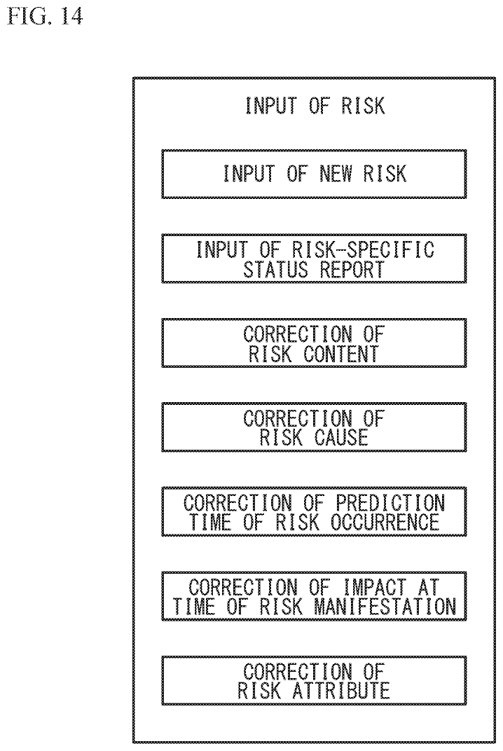

FIG. 14 is a conceptual diagram illustrating an example of a portal screen for inputting and correcting risk information. For example, the portal screen has selection parts such as “input of new risk”, “input of risk-specific status report”, “correction of risk content”, “correction of risk cause”, “correction of prediction time of risk occurrence”, “correction of impact at time of risk manifestation”, and “correction of risk attribute”. By selecting one of them, the portal screen shifts to a next screen.

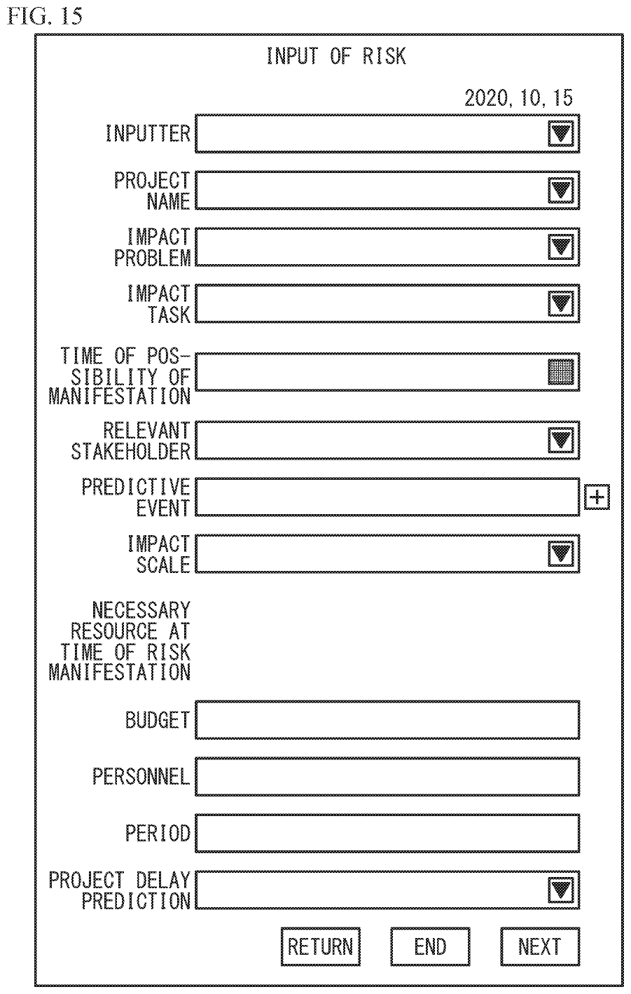

FIG. 15 is a conceptual diagram illustrating an example of a new risk input screen. The new risk input screen includes items such as “inputter”, “project name”, “impact problem”, “impact task”, “time of possibility of manifestation”, “relevant stakeholder”, “predictive event” and “impact scale”, and further “budget”, “personnel”, “period” and “project delay prediction” which are necessary resources at time of risk manifestation, and the risk information is registered by inputting data into the items. Since it is assumed that the contents of the project have already been registered, each item may be selected by the pull-down menu. The “time of possibility of manifestation” may be selected from the calendar. After inputting data into the items, the risk information is registered when “end” is selected, the new risk input screen returns to a previous screen without registering the risk information when “return” is selected, and the new risk input screen shifts to another screen such as task input when “next” is selected.

It is preferable that the “risk information input receiving unit” can receive the input of the attributes of the information acquired in the risk manifestation risk/high risk information acquiring unit described below, and indicators of the risk judgment level. In the example of the large facility described above, in the case of budgetary requirements such as “soaring material costs”, a case where the cost rises by 10% or more compared to the initially set amount defines is defined as a high risk status, and a case where the cost rises by 20% is defined as a risk manifestation status. For example, when non-expected work such as “occurrence of natural disasters” is involved, a case where the time required to return to normal work exceeds 5% of the total project period is defined as the high risk status, and a case where the time required to return to normal work exceeds 10% is defined as the risk manifestation status. In the case of failure to secure the required number of workers such as “failure to secure workers”, a shortage of more than 5% of the expected number of workers is defined as the high risk status, and a shortage of more than 10% of the expected number of workers is defined as the risk manifestation status. In the case of the management crisis on the order side of the project such as “management crisis of the client”, one default is defined as the high risk status, and two defaults are defined as the risk manifestation status. In the case of “occurrence of legal problems (environmental problems, pollution, residents' movements, scandals)”, the high risk status and the risk manifestation status are determined according to an amount and a percentage of negative posts on the Internet. In the case of accidents during the project such as “occurrence of serious accidents during construction”, a case where the degree of injury exceeds serious injury is defined as the high risk status, and a case where the degree of injury exceeds more serious injury is defined as the risk manifestation status. In the case of “shortage of construction equipment (e.g. tunnel shield machines, dump trucks, trailers, excavators, or the like)”, a delay of more than 5% of the total project period is defined as the high risk status, and a delay of more than 10% of the total project period is defined as the risk manifestation status. In the case of “suspension or cancellation of construction due to political reasons (e.g., cancellation of dam construction, cancellation of highway construction, or the like)”, a case where the fact of the suspension or cancellation of the construction is reported in the mass media is defined as the high risk status, and a case where the actual intention to the suspension or cancellation of the construction is expressed is defined as the risk manifestation status. In the case of “large fluctuations in foreign exchange rates if the project is affected by foreign exchange rates”, a case where the loss due to exchange rate fluctuations exceeds 5% of the project budget is defined as the high risk status, and a case where the loss due to exchange rate fluctuations exceeds 10% of the project budget is defined as the risk manifestation status. In this way, it is preferable for the risk information input receiving unit to include the definition information of what events and how much occur for risk items to be in the high risk status or the risk manifestation status. The definition information is used to automatically generate the display in a predetermined format by the risk manifestation risk/high risk information acquiring unit. For example, if the risk information is related to the required budget such as “soaring material costs”, the input screen would be generated and presented with instructions such as “enter the percentage of the increase compared to the originally set amount”, or a pull-down menu, or a screen where the user can enter the percentage by moving the bar of the bar indicator. In general, the high risk and the risk manifestation in risk definitions are often expressed in terms of quantities or percentages, so in the case of such input, the risk definition information is transmitted to the risk manifestation risk/high risk information acquiring unit so that the above screen is automatically generated by the risk manifestation risk/high risk information acquiring unit as a general-purpose interface. In addition, it is preferable to configure the system so that all information related to the input risk that is necessary for the interface generation of the risk manifestation risk/high risk information acquiring unit is transmitted to the risk manifestation risk/high risk information acquiring unit. If predictive information can be defined by the risk definition, the system is configured to receive the input of the predictive information and to transmit the predictive information to the risk manifestation risk/high risk information acquiring unit. For example, if the risk information is the occurrence of the natural disaster, “typhoon information” can be used as the predictive information. The prediction of a large typhoon passing over the construction site of the large facility can be used as the predictive information.

The “risk information holding unit” has a function of holding one or more pieces of input risk information in association with the risk identification information. The risk identification information is associated with all information about the input task.

The “risk manifestation risk/high risk information acquiring unit” has a function of acquiring the risk manifestation risk/high risk information, which indicates that the held risk has manifested or that the risk has increased, in association with the risk identification information.

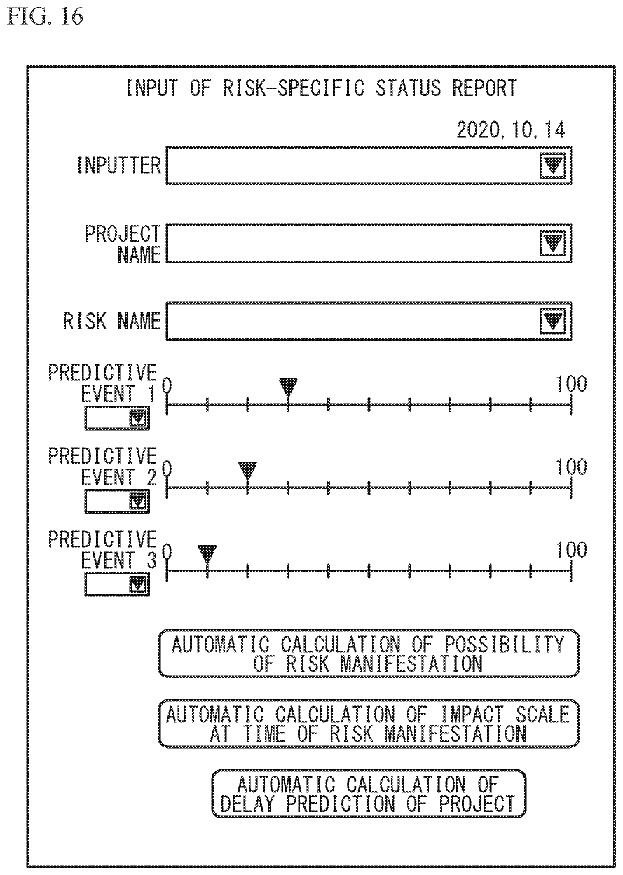

FIG. 16 is a conceptual diagram of an example of a risk-specific progress report input screen. For example, “inputter”, “project name”, “risk name” and “predictive event(s)” can be input in the risk-specific progress report input screen. Since it is assumed that the contents of the project, the problem information and the risk information have already been registered, each item may be selected by the pull-down menu. For the predictive event, the event (can be a pull-down) is selected, and then a degree of occurrence of the event is selected. The degree of occurrence of the predictive event can be entered numerically, or by using a risk quantification navigation template (e.g., an arrow is placed on an axis from 0% to 100%) as illustrated in FIG. 16. Alternatively, the degree of occurrence of the predictive event can be determined by automatic calculation by causing the inputter to enter individually the answers to questions related to the degree of occurrence of the predictive event. In addition, the risk-specific progress report input screen has buttons such as “automatic calculation of possibility of risk manifestation”, “automatic calculation of impact scale at time of risk manifestation” and “automatic calculation of delay prediction of project”. For example, if “automatic calculation of possibility of risk manifestation” is selected, the system automatically calculates a possibility of the risk manifestation by referring to the contents and the degree of occurrence of the input predictive event. Next, the “automatic calculation of impact scale at time of risk manifestation” automatically calculates a degree of impact on the problem, the task or the entire project at the time of the risk manifestation. In this case, for example, each predictive event can be weighted (e.g., the time, money, and manpower required to respond to the risk that has occurred) to enable automatic calculation of impact with higher accuracy. Next, the “automatic calculation of delay prediction of project” automatically calculates how much the entire project is delayed when the risk is manifested. In addition, although not shown in the figure, it may be possible to register the scope of those who are authorized to view a risk-specific status report.

If the risk manifestation risk/high risk information can be obtained externally through the Internet or other means, it may be obtained using a communication network without relying on human input. The risk manifestation risk/high risk information is, for example, market prices of materials, wage rates of workers, exchange rates, forecast information of natural disasters such as typhoons, heavy snowfall, and wind gusts, or the like. The risk manifestation risk/high risk information can be obtained by allowing the inputter to select the definition for receiving the input of the risk information in the risk information input receiving unit and the method of receiving input of the indicator values of the items in the definition. For example, the market prices of materials can be set to be retrieved periodically by specifying certain items on the Internet website into the input of the definition of risk information.

The “risk manifestation risk/high risk information output unit” has a function of associating the held risk information with the risk manifestation risk/high risk information with each other to output an associated result. It is preferable to configure the system in such a way that the participant of the project, the orderer of the project, and the manager of the project can view output information from the risk manifestation risk/high risk information output unit in order to know the status of the risk. However, in some projects, each risk itself may be highly confidential information, and the system may be designed so that not all project participants can view the status of all risks, but an authorizer can view the risk status of only a limited scope of risks for the authorizer. In addition, the risk manifestation risk/high risk information may be divided into several information hierarchies and viewed. For example, there are a case where only the risk ID is disclosed instead of the risk name, a case where the content of the risk is disclosed, a case where the content of the risk is not disclosed, a case where the status of the risk is disclosed precisely and precisely, and a case where the status of the risk is disclosed roughly in three or five steps. Thus, the system may be designed so as to optimize a disclosure method of the risk according to the information access authority of the viewer by incorporating various disclosure systems. In addition, it is possible to configure the system to optimize the case where the information can be viewed in real time and the case where the information can be viewed with the predetermined time lag, depending on the information access authority of the viewer. It is also possible to design the system so that a person who wants to view the information can inquire about it to a project leader who has the authority to make the information available to the public at the time of the request for viewing, and can view the information in a specified scope based on the access authority granted by the approval if the approval is obtained.

The “task information input receiving unit” has a function of receiving one or more inputs of the task information which is project management information and indicates a task that must be processed to achieve the goal of the project.

The “task information” indicates tasks that must be completed by small group units or individual units in principle. The “task information” generally refers to the tasks required to solve the problems indicated by the problem information. Therefore, when all tasks associated with the problems are completed, the problems indicated by the problem information are determined to be the resolved problems and recorded. Therefore, task information is information that clearly defines what, how, where and when the person executing the task should execute. However, in some projects, it is also possible to define the task in associated with the problem, to place the tasks in a hierarchical structure, or to define the problem that is not associated with the task.

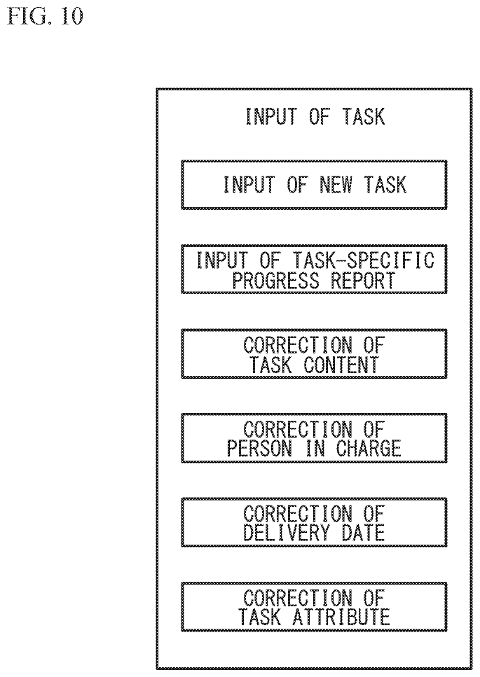

FIG. 10 is a conceptual diagram illustrating an example of a portal screen for inputting and correcting the task information. For example, the portal screen has selection parts such as “input of new task”, “input of task-specific progress report”, “correction of task content”, “correction of assignment”, “correction of delivery date” and “correction of task attribute”. By selecting one of them, the portal screen shifts to a next screen. Also, as for task input, it is preferable to design the system in such a way that the authority of the inputter is restricted so that only a person with a given authority is allowed to input the task. Each attribute of the input task is associated with the task identification information. If the task is associated with another task or with the problem indicated by the problem information, the task information must be entered in association with the task identification information of the associated task and the problem identification information of the associated problem. Even if the task is not associated with another task or with the problem indicated by another problem information, the task information must be entered in association with the project ID. If the task is associated with the another task, a hierarchical order with the another task must be entered. For example, if the task is located above the associated task, the system requires the input of information indicating its location relationship, and if the task is located below the associated task, the system requires the input of information indicating its location relationship. It is preferable to automatically request the information indicating its location relationship from the inputter when the identification information of the another task associated with the task is entered. It is also necessary to enter the person in charge, and if there is a work instruction relationship between the persons in charge, it is preferable to enter the work instruction relationship as well. The order of the work instructions is, for example, a section chief in charge of a regenerative brake circuit, a chief, and a person in charge. Since the completion and accomplishment of the task are closely related to an ability of the person in charge to execute his or her duties, it is preferable that a member ID registered in a project member registration database is also associated with the person in charge. In this case, a person who wants to view the progress of the task or a task execution plan should enter the information registered in the database about the person in charge, such as the past project execution history of the person in charge stored in the project member registration database for the person in charge, the expertise field of the person in charge, past assigned tasks, and evaluation results of the task execution capability. By using the task attribute information described below, a unique task attribute of this person in charge may be stored in the database, which can be viewed by a third party.

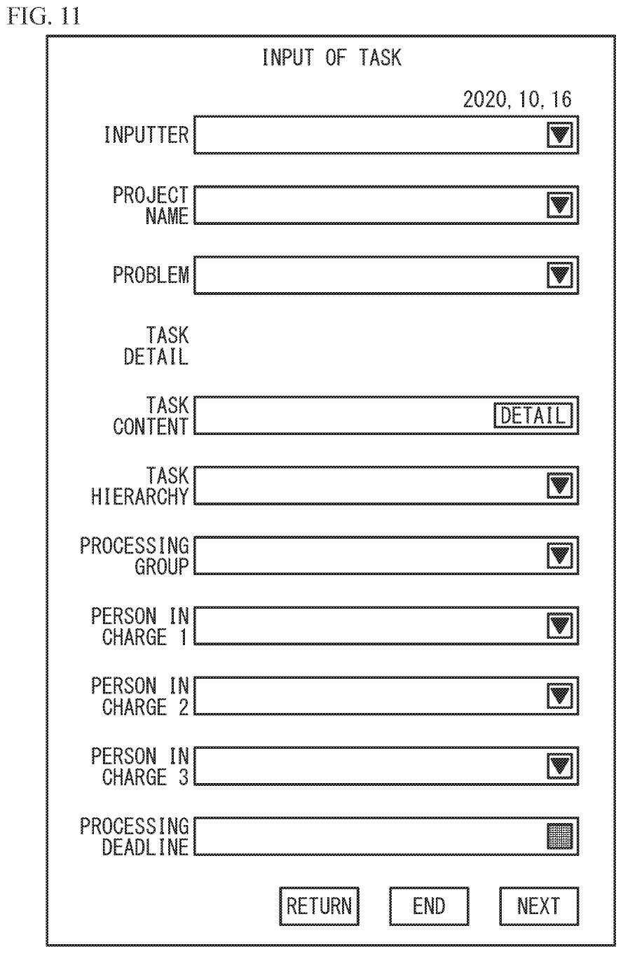

FIG. 11 is a conceptual diagram illustrating an example of a new task input screen. The new task input screen includes items such as “inputter”, “project name” and “problem”, and further “task content”, “task hierarchy”, “processing group”, “person(s) in charge” and “processing deadline” as task details, and the task information is registered by inputting data into the items. Since it is assumed that the contents of the project have already been registered, each item may be selected by the pull-down menu. The deadline may be selected from the calendar. It is assumed that selecting the “detail” button shifts from the new problem input screen to a screen for inputting details. In addition, the “task hierarchy” allows the inputter to select the relationship with the task, i.e., which task it is associated with, or a hierarchy with the task if there is the hierarchy between the tasks. After inputting data into the items, the task information is registered when “end” is selected, the new task input screen returns to the previous screen without registering the task information when “return” is selected, and the new task input screen shifts to another screen when “next” is selected. In addition, the task attribute may be selected.

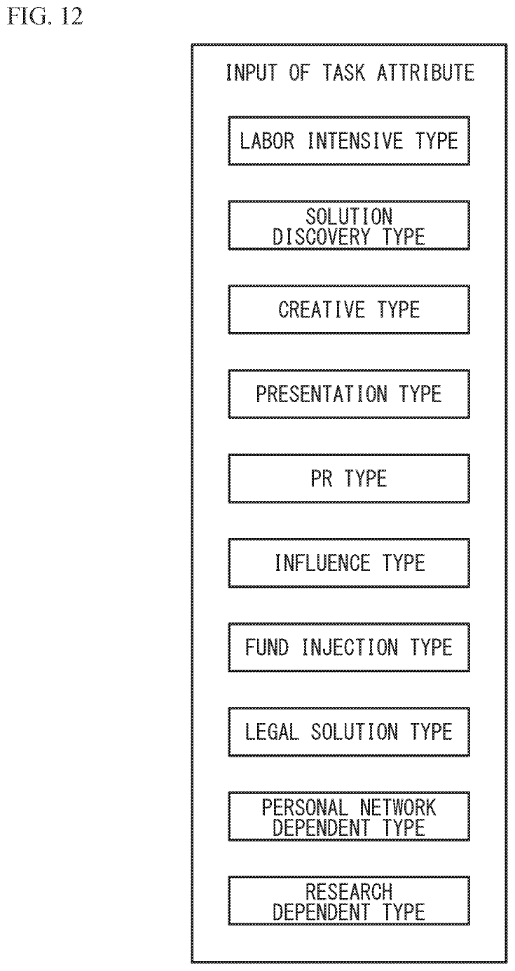

FIG. 12 is a conceptual diagram illustrating an example of a screen for selecting the task attribute. The inputter may select one or more task attributes from “labor intensive type”, “solution discovery type”, “creative type”, “presentation type”, “PR type”, “influence type”, “fund injection type”, “legal solution type”, “personal network dependent type” and “research dependent type”. These attributes are neither mandatory nor conversely limited.

The “task information holding unit” has a function of holding one or more pieces of input task information in association with the task identification information. The task identification information is associated with all the information about the input task.

The “task processing status information acquiring unit” has a function of acquiring the task processing status information that indicates the processing status of the held task, in association with the task identification information.

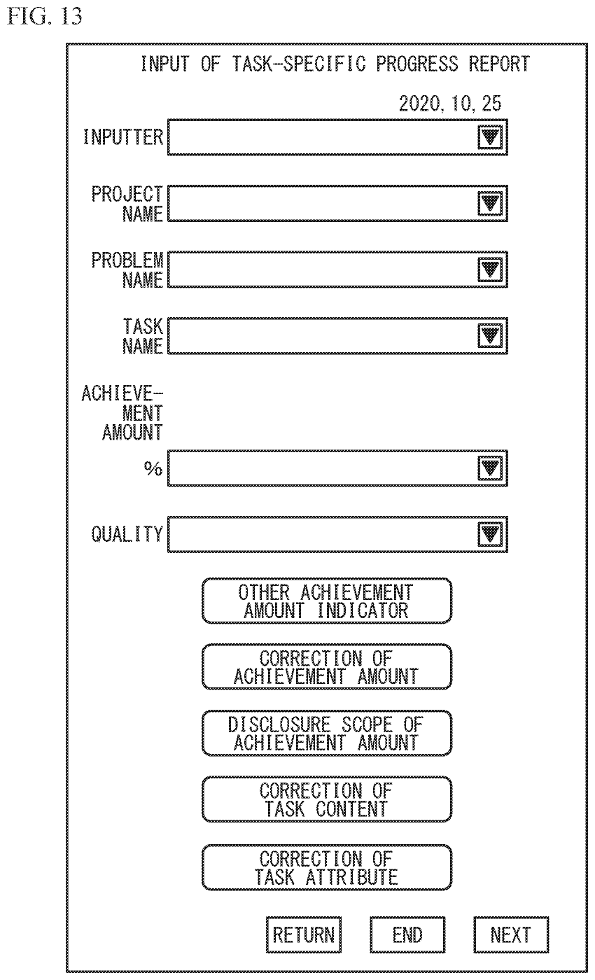

FIG. 13 is a conceptual diagram illustrating an example of a task-specific progress report input screen. In the task-specific progress report input screen, “inputter”, “project name”, “problem name”, “task name” and “achievement amount” are entered, for example. A percentage and a quality are entered as the achievement amount. Since it is assumed that the contents of the project have already been registered, each item may be selected by the pull-down menu. The achievement amount may be entered numerically. Alternatively, the task achievement amount may be determined by automatic calculation by causing the inputter to individually enter the answers to questions related to the task achievement amount. In addition, the task-specific progress report input screen has buttons such as “other achievement amount indicator”, “correction of achievement amount”, “disclosure scope of achievement amount”, “correction of task content” and “correction of task attribute”. For example, if the “other achievement amount indicator” is selected, the achievement amount may be indicated not by numbers but by a specific completion process, or by receiving an input indicating the remaining process or period, such as “pending approval, expected to be approved on date/month/year”. The input of “other achievement amount indicator” may be executed together with indicating the achievement amount in numbers. Next, when the “correction of achievement amount”, “correction of task content” or “correction of task attribute” is selected, the registration content may be corrected. Next, the “disclosure scope of achievement amount” is a registration of the scope of people who have the authority to view with respect to the achievement amount.

The task processing status information may be manually entered by a person or automatically obtained by the system from an external source. For example, a production management system in a factory is generally configured to keep track of the production status of products in the factory. On the other hand, the system can be configured to periodically acquire management data from the production management system through communication, and to use the management data to generate or hold the task processing status information. Specifically, in order to grasp the production status in a laboratory or factory, the production management system performs the production management using various sensors, such as flow sensors, temperature sensors, weight sensors, liquid volume sensors, infrared sensors, shipping quantity counters, packing quantity counters, foreign object inspection devices, defective product counters, radiation inspection devices, surface condition inspection devices, circuit inspection devices, motion sensors, and worker-work status monitoring devices (by video, ID, PC workload, etc.). Therefore, the data processed or edited by the production management system from these sensor data can be acquired to generate the task processing status information, and in some cases, the system can be configured to directly acquire data from the sensors in the production plant to generate the task processing status information. The task processing status information is not limited to data on objects, such as products, but can also include data on persons, such as their movements. The data on persons includes information on person's movements, information on the relationship between the persons and the devices, and data on the relationship between the persons. The data on persons includes person's movements, person's comments, and information issued by the person. The information on the relationship between the persons and the devices includes which devices the persons operate and which functions of which devices the persons use. In addition, the data on the relationship between the persons includes information on conversations through contact of the persons and an amount of opportunities for contact of the persons. Note that the data on the relationship between the persons can also be obtained from social networking sites and other sources outside offices and factories. Therefore, the task processing status information acquiring unit may have an SNS information acquiring unit capable of performing Internet communication to acquire information from SNS, and an SNS task processing status information generating unit that analyzes the SNS information and generates task processing status information (a rule to generate task processing status information by analyzing the SNS information is inherent in the unit).

The “task processing status information output unit” has a function of associating the held task information with the task processing status information to output an associated result. It is preferable to be able to output the task processing status information in various output formats. For example, a graph can be configured to allow the inputter to select a desired display format from among multiple types such as bar graphs, line graphs, pie charts, band graphs, histograms, radar charts, scatter plots, box-and-whisker plots, triangular graphs, and candle charts. In addition, the output can be configured to include not only the current task processing status information, but also the past history. Furthermore, it is also desirable to configure the system to superimpose the processing status information of a plurality of tasks and problems, or so that the processing status information of the plurality of tasks and tasks can be output in a comparable manner. The output of the task processing status information can include all or part of the task information and the problem information, or the viewer can select which part of their information to use according to his or her wishes.

If there is a task that has already been completed in other project, the system may be configured to select a comparable task and allow comparison of the completed task with a task currently processed. For example, the elapsed time and the progress of task in the task that has been completed can be compared with the elapsed time and the progress of task in the task currently processed. The system may also include a communication tool unit in which members executing the task or managing the task can write comments on the output of the progress of the task and respond to the comments. In addition, the system may have a comparable task recommendation unit that recommends a comparable task to the user using the task attribute information. By selecting the comparable task recommended by the comparable task recommendation unit, it is possible to compare the progress of the recommended task with that of the task being executed. The system may also include a warning and advice output unit in which the AI analyzes the information of the completed task, holds problematic processes in task execution, and outputs a warning and an advice based on past task analysis cases to a task executor. It is preferable to configure the warning and advice output unit to give the warning or the advice when the task processing is judged to be behind schedule based on the task processing status information. This is because, it is psychologically oppressive to receive the warning or advice at a stage where no problem has occurred, and on the other hand, if there is a delay in task processing, some problem may have occurred, and a situation is likely to be fostered where the executor is more likely to accept the warning or advice. The “disclosure scope of achievement amount” is a register of the scope of persons who are authorized to view the achievement amount.

The “unit for receiving change request of project management information” has a function of receiving an input of a change request of the project management information.

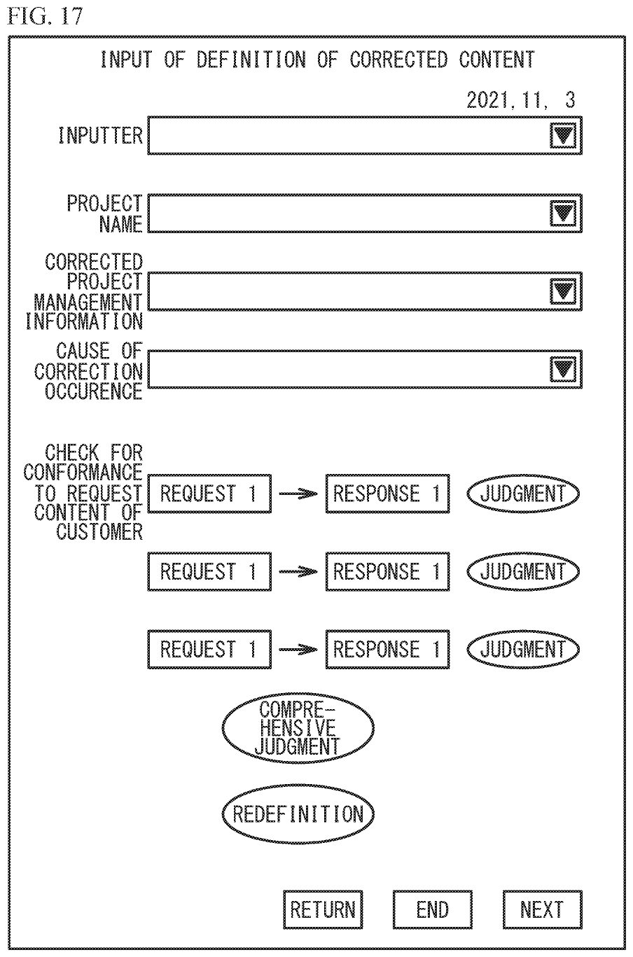

FIG. 17 is a conceptual diagram illustrating an example of an input screen of change (correction) content definition received by the unit for receiving change request of project management information. The input screen of the change (correction) content definition includes items such as “inputter”, “project name”, “corrected project management information”, “cause of correction occurrence” and “check for conformance to request content of customer”, and the change request of the project management information is received by inputting data into the items. Since it is assumed that the contents of the project have already been registered, each item may be selected by the pull-down menu. The “cause of correction occurrence” includes, for example, “risk manifestation” and “customer request”. The “check for conformance to request content of customer” checks whether the content of the change conforms to the change (correction) request from the customer, or in other words, whether the change (correction) request from the customer can be achieved if the relevant action is taken. If there are a plurality of requests from the customer, the “check for conformance to request content of customer” may be configured to check each of the requests and then make a final comprehensive judgment. If the result of the judgment is “nonconformance of customer request content”, the “redefinition” button is pushed to shift this input screen to a redefinition screen. After inputting data into the items, the project management information is registered when “end” is selected, the input screen returns to the previous screen without registering the project management information when “return” is selected, and the input screen shifts to another screen such as task input when “next” is selected.

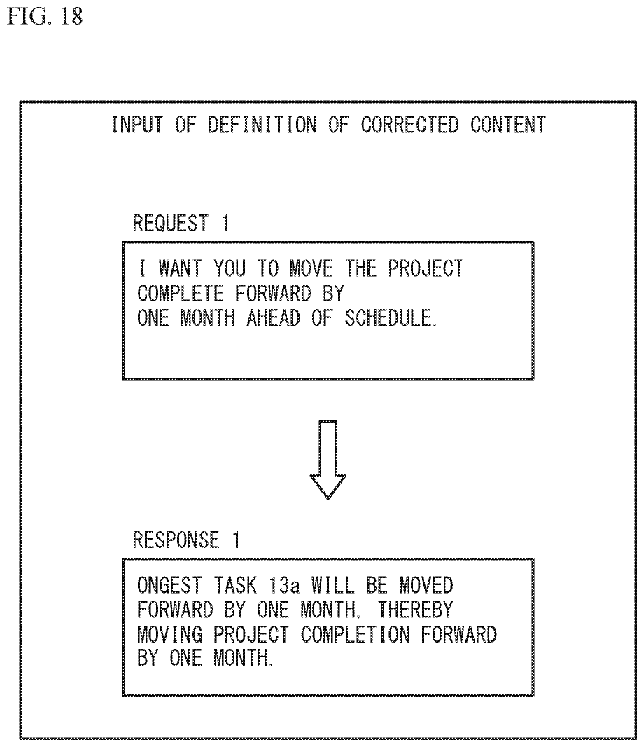

FIG. 18 is a diagram illustrating an example of the “check for conformance to request content of customer”. When the request content is “I want you to move the project complete forward by one month ahead of schedule”, the response is “longest task 13a will be moved forward by one month, thereby moving project completion forward by one month”. In this case, it is basically considered that the request content “I want you to move the project complete forward by one month ahead of schedule” can be achieved, so the judgment is “conformance of customer request content”. For example, it is not easy to say whether the completion of the entire project can be moved forward by one month if one task is moved forward by one month. Therefore, the system can be configured to determine whether the request “I want you to move the project complete forward by one month ahead of schedule” can really be achieved by taking into account the stakeholder information, the information of the person in charge and the team, the budget, and the overall task schedule.

For example, the task 13a is defined by its task information, but it can be configured so that the analysis unit analyzes whether the execution result of the task will not change by bringing schedule forward by one month and whether the required resources can be secured, by pressing the “judgment” button in FIG. 17. For example, if the materials consumed to perform the task are highly seasonally variable, bringing the task forward may cause quality fluctuations in the raw material to be input, which may lead to fluctuations in the quality of the final product. Therefore, in such a case, the system is configured to output a warning that the quality of the final product may fluctuate. If four financial experts are needed as resources, but only three can be deployed because they are engaged in other tasks during the period brought forward, the judgment concludes that it is difficult to change the project management information, and such results will be output. Alternatively, the project management information changing unit can be configured to calculate that four financial experts can be deployed if the other task, task 8c, is moved forward by one week, and determine that the project information can be changed by moving forward the task 8c by one week, and output a conclusion that includes such a recommendation. In this way, the task information holds all the factors that may affect the outcome of the task in relation to the task identification information, and also holds information about the events that affect the factors. In addition, the system can be configured to qualitatively or quantitatively identify the event and qualitatively or quantitatively output its impact from the task information. If the event has relevance to other tasks or to the risk situation, the system should be configured to analyze the factors contained in the relevant task and risk information to derive a solution in which changes to the project do not have a negative impact on the final outcome of the project.

The “unit for holding change request of project management information” has a function of holding the received change request of the project management information in association with the identification information for the change request of the project management information.

The “unit for acquiring implementation information for change request of project management information” has a function of acquiring the implementation information for the change request of the project management information, which indicates the implementation of the change request of the held project management information, in association with the identification information for the change request of the project management information.

The “project management information changing unit” has a function of changing the project management information based on the acquired implementation information for the change request of the project management information. The “project management information” is any one or more of the problem information, the risk information and the task information. Changing the project management information means changing or adding any one or more of the problem information, the risk information and the task information. Also, the above change or addition may change the interdependence which is an interrelated relationship between the problem information, the risk information and the task information.

The “interdependence” refers to a relationship that affects multiple tasks mutually or in one direction, and mainly occurs when a subsequent task uses the results of a preceding task (result use relationship), or when a resource used by a preceding task is also used by a subsequent task (resource reuse relationship). The “interdependence” is essentially a function that represents a value with the attribute that the task requires and that must be met for the implementation of the task, and one of the variables in the function is time. Basically, the value with the attribute must satisfy a given range or a given value (satisfaction condition) within a given time. Therefore, when there is a change in the project management information, the change in the project is achieved by adjusting the changed value to be within a range required by the task. If a single task is not achievable, it may be possible to change the project as a whole by adjusting the value of another task.

The “interdependence” can also occur between different problems when the project management information is the problem. The “interdependence” can also occur between the problem, and the task under a different problem which is not a task under the problem. An interdependence information holding unit can be configured to hold task interdependence information which is information indicating the interdependence between the tasks, problem interdependency information which is information indicating the interdependence between the problems, and problem/task interdependence information which is information indicating the interdependence between the problem, and the task of the different problem. The project management information changing unit can use the information held in the interdependence information holding unit, and can determine whether the change in the project management information is appropriate using the information held in the interdependence information holding unit. Note that interdependence information and the change request of the project management information are also a part of the project management information.

The “implementation information for change request of project management information” indicates the content of changes to the project management information based on the change request of the project management information, and is any one or more of the problem information, the risk information, and the task information. Changing the “implementation information for change request of project management information” is information that includes an instruction to change or add any one or more of the problem information, the risk information and the task information. The problem information, the risk information, the task information, and other project management information are configured so that they are identified by the identification information, and in the case of a change thereof, the identification information is identified and the change content is described. The change content may include deletion of a part of information, change of a part of information, addition of a part of information, deletion of all information, change of all information, or the like. In the case of addition, new project management information is added by associating new identification information and indicating the interdependence. Change pattern identification information, which indicates the change pattern by means of the identification information, may be associated with the implementation information for the change request of the project management information. For example, the reason for the change, such as “1. amount of fund, stock price, bond, loan amount, investment amount”, “2. cooperation, alliance, joint development, joint business, merger”, “3. president, executive, leader, developer, salesperson, programmer, SE”, “4. land, building, research facility, development equipment”, “5. interest rate, dividend, maturity period”, “6. economic trend, price index, industrial index”, “7. number of employees, number of seconded employees, number of part-timers, number of outsourced employees”, “8. law on communication, law on transportation, law on finance”, “9. communication technology progress, computing technology progress, transportation technology progress, biotechnology progress”, “10. administrative approval, bill enactment, test success/failure, performance test pass” and “11. climate, weather, disaster (earthquake, tsunami, volcano, flood), pollution”, may be represented by identification information to indicate what the change is. It is also possible to use the identification information as a key to retrieve search results from a vast amount of data stored in the project management system.

<Hardware Configuration>

The hardware configuration of the project management system in this embodiment will be described with reference to the figures.

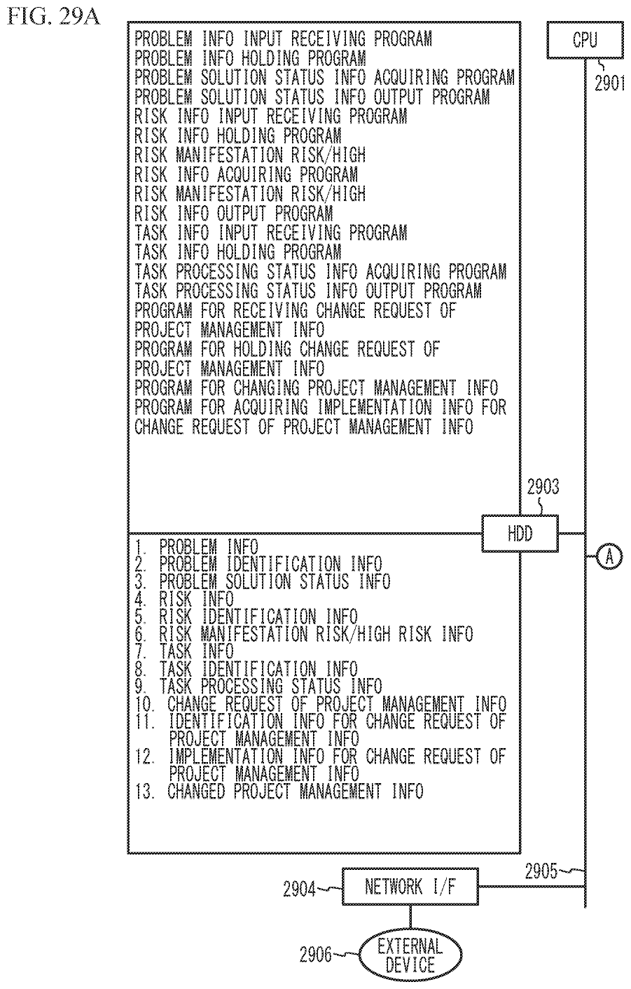

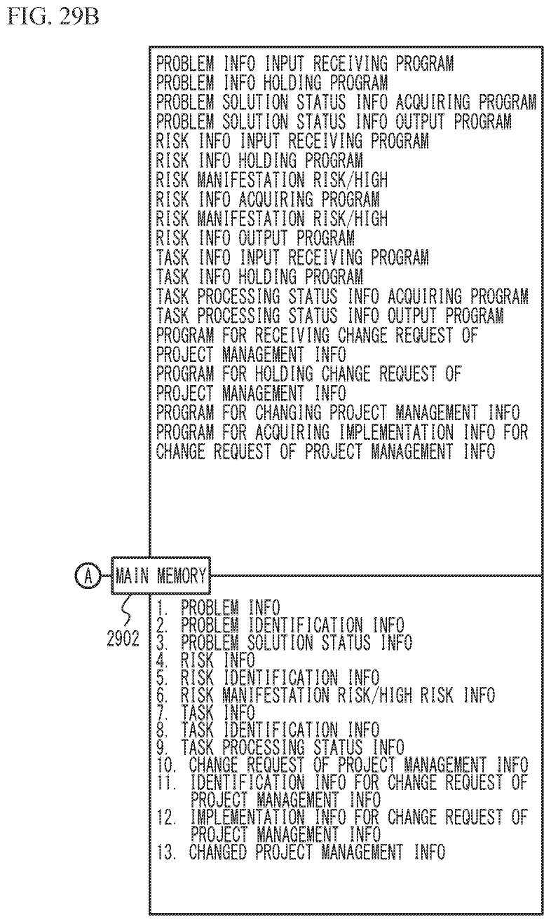

FIGS. 29A and 29B are diagrams illustrating the hardware configuration of the project management system according to the first embodiment. As illustrated in FIGS. 29A and 29B, the project management system according to the first embodiment includes a “CPU (central processing unit)” (2901) which performs various arithmetic operations, and a “main memory” (2902). Further, the project management system includes a “HDD” (2903) that holds predetermined information, and a “network I/F (interface)” (2904) that transmits and receives information to and from user terminal devices (2906) associated with a plurality of user identification information. The CPU, the main memory, the HDD and the network I/F are connected to each other by a data communication path such as a “system bus” (2905) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address. In the present embodiment, the programs stored in the main memory are a problem information input receiving program, a problem information holding program, a problem solution status information acquiring program, a problem solution status information output program, a risk information input receiving program, a risk information holding program, a risk manifestation risk/high risk information acquiring program, a risk manifestation risk/high risk information output program, a task information input receiving program, a task information holding program, a task processing status information acquiring program, a task processing status information output program, a program for receiving change request of project management information, a program for holding change request of project management information, a program for acquiring implementation information for change request of project management information, and a program for changing project management information. In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

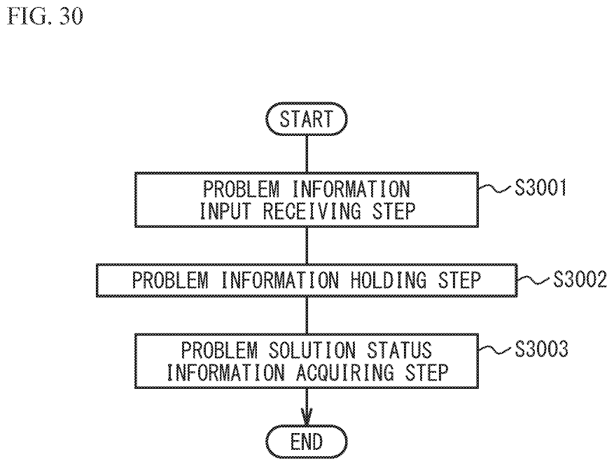

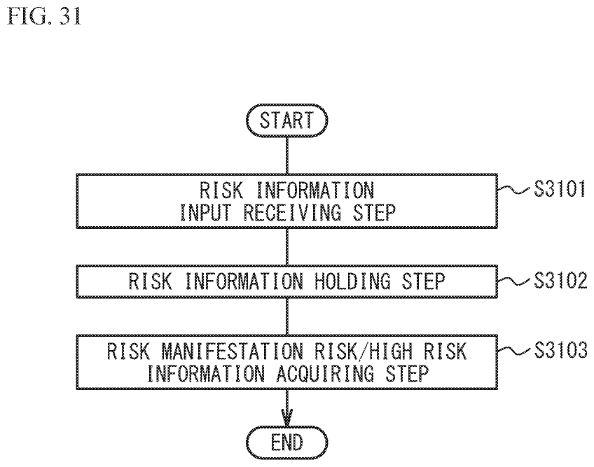

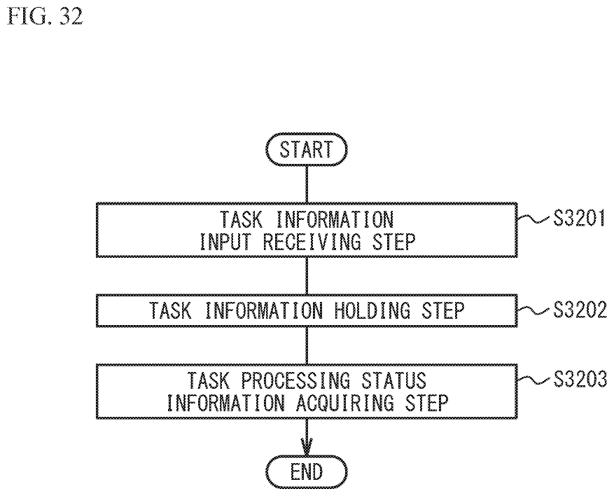

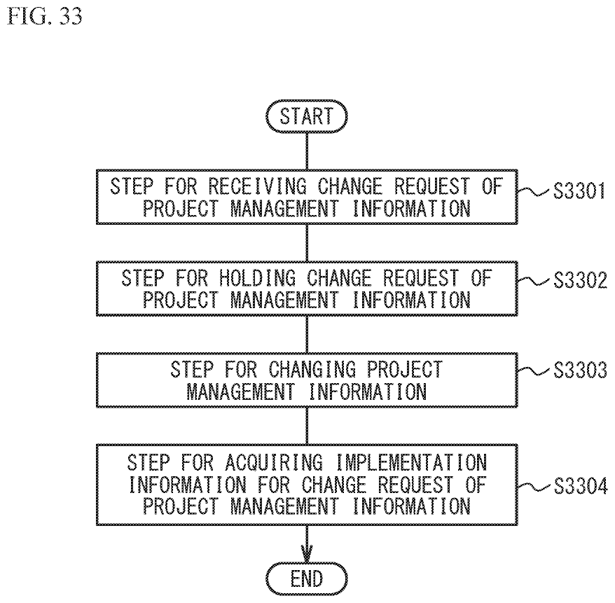

FIGS. 30 to 33 are flowcharts illustrating processing when the project management system according to the first embodiment is used. FIGS. 30 to 33 illustrate the overall flow of the processing, which is divided into processes related to the problem information, the risk information, the task information, and the project management information. There is no antecedent or consequent relationship between the respective flowcharts, which applies to the other embodiments as well.

As illustrated in FIGS. 30 to 33, a processing method includes a problem information input receiving step (3001), a problem information holding step (3002), a problem solution status information acquiring step (3003), a risk information input receiving step (3101), a risk information holding step (3102), a risk manifestation risk/high risk information acquiring step (3103), a task information input receiving step (3201), a task information holding step (3202), a task processing status information acquiring step (3203), a step for receiving change request of project management information (3301), a step for holding change request of project management information (3302), a step for changing project management information (3303), and a step for acquiring implementation information for change request of project management information (3304).

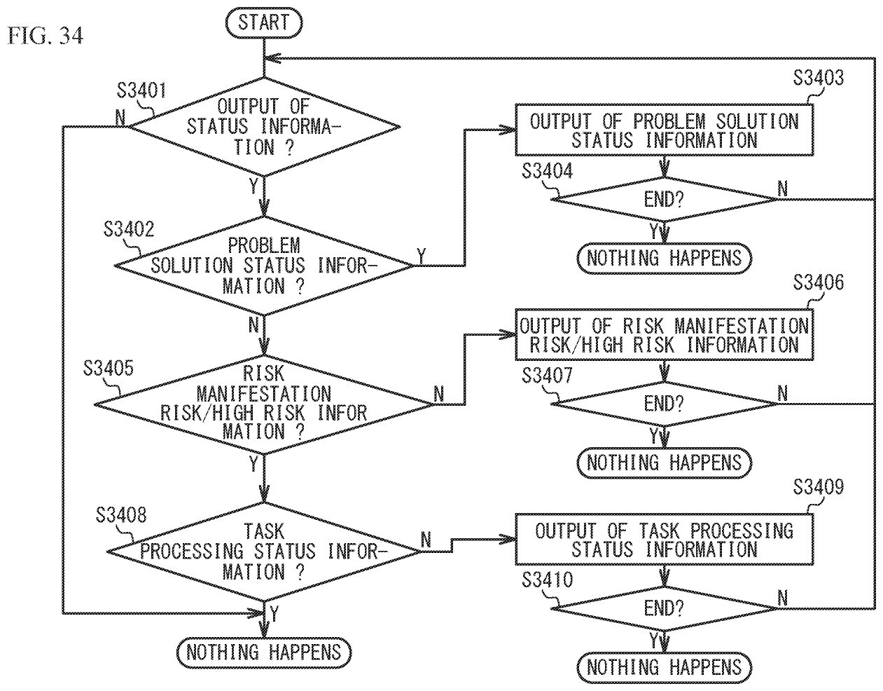

FIG. 34 is a flowchart illustrating processing related to output of respective information. The output of each piece of information can be in any order. First, the CPU determines whether to output the status information (here, the status information includes, but not limited to, information indicating the progress of the problem information, the risk information, and the task information) (S3401). When the determination of S3401 is YES, the CPU determines whether to output the problem solution status information (S3402). When the determination of S3402 is YES, the CPU outputs the problem solution status information (S3403). The CPU determines whether to end the output (S3404). When the determination of S3404 is NO, the procedure returns to S3401. When the determination of S3402 is NO, the CPU determines whether to output the risk manifestation risk/high risk information (S3405). When the determination of S3405 is YES, the CPU outputs the risk manifestation risk/high risk information (S3406). The CPU determines whether to end the output (S3407). When the determination of S3407 is NO, the procedure returns to S3401. When the determination of S3405 is NO, the CPU determines whether to output the task processing status information (S3408). When the determination of S3408 is YES, the CPU outputs the task processing status information (S3409). The CPU determines whether to end the output (S3410). When the determination of S3410 is NO, the procedure returns to S3401. When the determination of S3401 is NO, the determination of S3404 is YES, the determination of S3407 is YES, the determination of S3408 is NO, and the determination of S3410 is YES, nothing happens. The overall flow is as described above. The processing method can be simply configured to have a problem solution status information output step, a risk manifestation risk/high risk information output step, and a task processing status information output step as output steps, so such an example is simply described.

The “problem information input receiving step” receives one or more inputs of problem information, which is the project management information and indicates the problem that must be resolved in order to achieve the goal of the project.

The “problem information holding step” holds one or more pieces of problem information in association with the problem identification information.

The “problem solution status information acquiring step” acquires the problem solution status information, which indicates a status in which the held problem is solved, in association with the problem identification information.

The “problem solution status information output step” associates the held problem information and the problem solution status information with each other to output an associated result.

The “risk information input receiving step” receives one or more inputs of the risk information, which is the project management information and indicates the risk assumed under the certain condition in achieving the goal of the project.

The “risk information holding step” holds one or more pieces of input risk information in association with the risk identification information.

The “risk manifestation risk/high risk information acquiring step” acquires the risk manifestation risk/high risk information, which indicates that the held risk has manifested or that the risk has increased, in association with the risk identification information.

The “risk manifestation risk/high risk status output step” associates the held risk information and the risk manifestation risk/high risk information with each other to output an associated result.

The “task information input receiving step” receives one or more inputs of the task information, which is project management information and indicates the task that must be processed in order to achieve the goal of the project.

The “task information holding step” holds one or more pieces of input task information in association with the task identification information.

The “task processing status information acquiring step” acquires the task processing status information that indicates the processing status of the held task in association with the task identification information.

The “task processing status information output step” outputs the task processing status information in association with the held task information.

The “step for receiving change request of project management information” receives the input of the change request of the project management information.

The “step for holding change request of project management information” holds the change request of the held project management information in association with the identification information for the change request of the project management information.

The “step for acquiring implementation information for change request of project management information” acquires the implementation information for the change request of the project management information, which indicates the implementation of the change request of the held project management information, in association with the identification information for the change request of the project management information.

The “project management information changing step” changes the project management information based on the acquired implementation information for the change request of the project management information.

<Conclusion>

As described above, it is possible to provide the project management system that unitarily manage the information on problems, tasks, and risks.

### Second Embodiment

The second embodiment provides the project management system that, in addition to the features of the first embodiment, is configured to acquire premise information which is information that is a premise capable of identifying the project management information, and to hold the premise information in association with the project management information.

Hereinafter, the functional configuration, the hardware configuration, and the flow of processing of the project management system according to the second embodiment will be described in order.

<Functional Configuration>

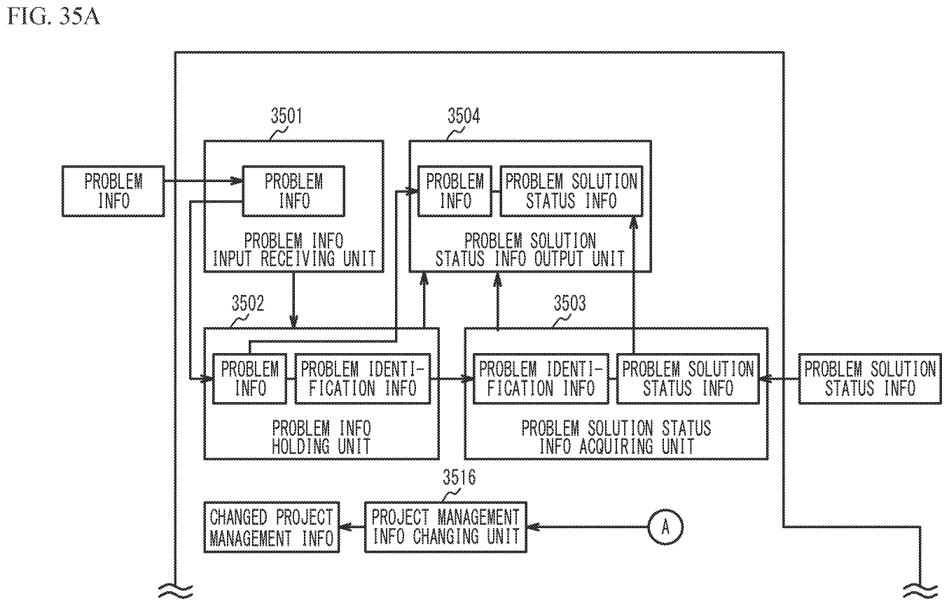

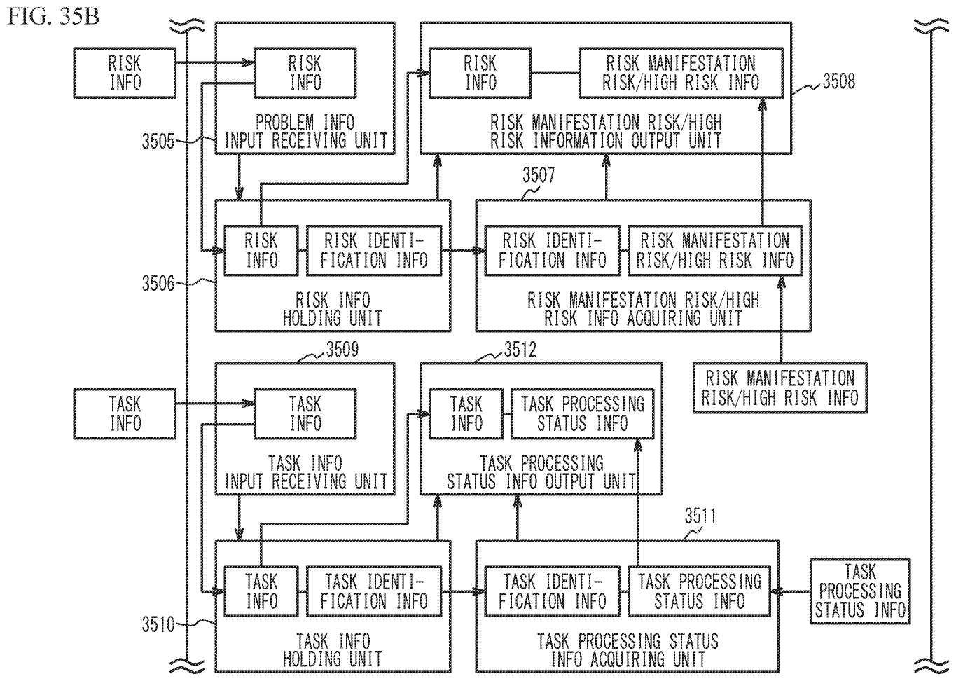

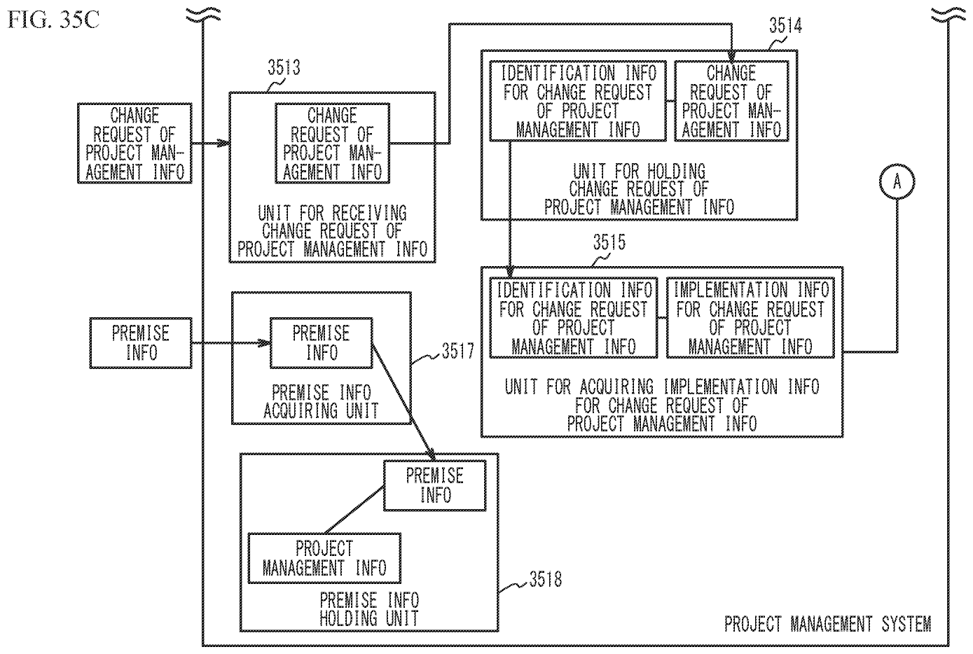

FIGS. 35A to 35C are diagrams illustrating a functional configuration of the project management system according to the second embodiment. The project management system according to the present embodiment includes a problem information input receiving unit (3501), a problem information holding unit (3502), a problem solution status information acquiring unit (3503), a problem solution status information output unit (3504), a risk information input receiving unit (3505), a risk information holding unit (3506), a risk manifestation risk/high risk information acquiring unit (3507), a risk manifestation risk/high risk information output unit (3508), a task information input receiving unit (3509), a task information holding unit (3510), a task processing status information acquiring unit (3511), a task processing status information output unit (3512), a unit for receiving change request of project management information (3513), a unit for holding change request of project management information (3514), a unit for acquiring implementation information for change request of project management information (3515), a project management information changing unit (3516), a premise information acquiring unit (3517), and a premise information holding unit (3518). Hereinafter, the content of each function will be specifically described. Since each function except for the premise information acquiring unit and the premise information holding unit is the same as that in the first embodiment, the explanation is limited to the functions of the premise information acquiring unit and the premise information holding unit.

The “precondition information acquiring unit” has a function of acquiring the premise information, which is information that is the premise capable of identifying the project management information (e.g. premise information for defining each information (problem, task, risk) of the project management information and/or premise information for defining conditions that each information (problem, task, risk) should satisfy), in association with the project management information.

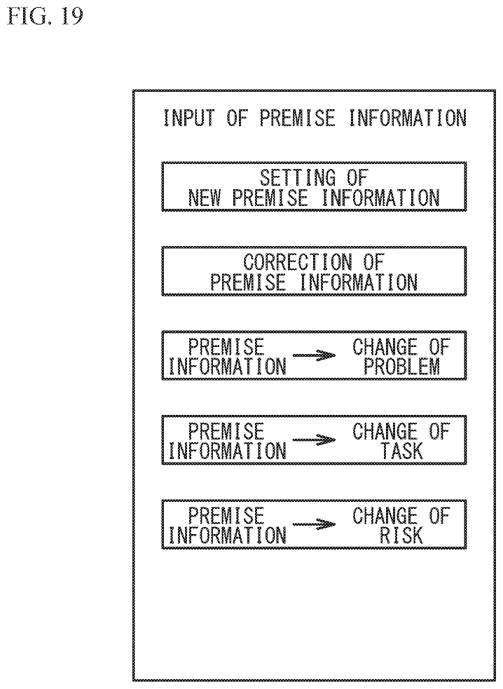

FIG. 19 is a conceptual diagram illustrating an example of a portal screen for inputting and correcting the premise information. The portal screen has selection parts such as “setting of new premise information”, “correction of premise information”, “premise information→change of problem”, “premise information→change of task”, and “premise information→change of risk”. By selecting one of them, the portal screen shifts to a next screen. Since a change in premise information may require a change in problem information, task information and risk information, the “premise information→change of problem”, the “premise information→change of task” and the “premise information→change of risk” are designed to automatically change the problem information, the task information, and the risk information based on the input premise information, respectively.

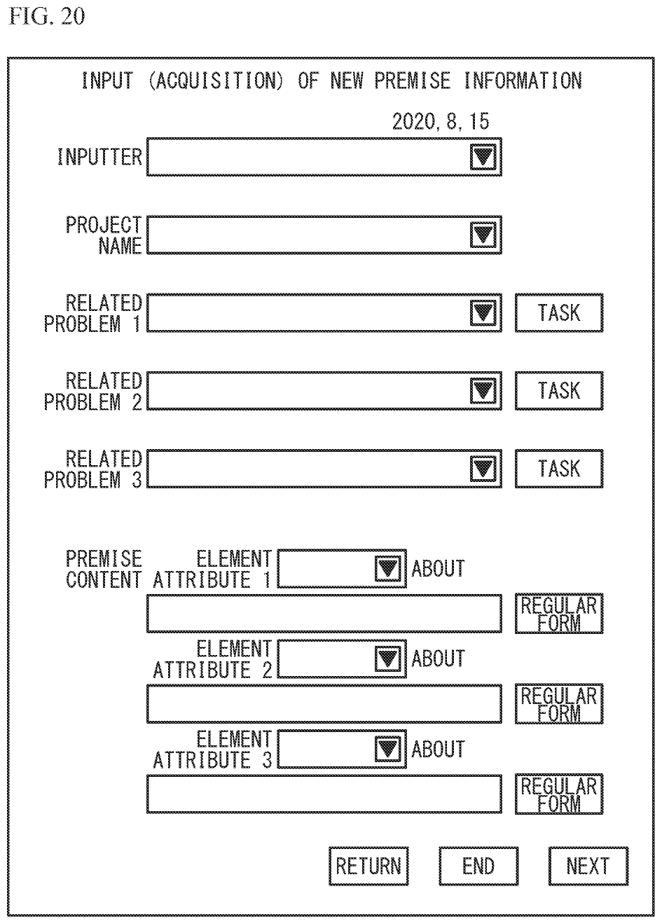

FIG. 20 is a conceptual diagram illustrating an example of a new premise information input screen. The new premise information input screen includes items such as “inputter”, “project name” and “related problem(s)”, and further “element attribute(s)” as premise content, and the premise information is registered by inputting data into the items. Since it is assumed that the contents of the project have already been registered, each item may be selected by the pull-down menu. Selecting a “task” button shifts from the new premise information input screen to an input screen of the task associated with the problem. The “element attribute(s)” is as described below. After inputting data into the items, the premise information is registered when “end” is selected, the new premise information input screen returns to a previous screen without registering the premise information when “return” is selected, and the new premise information input screen shifts to a next screen when “next” is selected. In addition, the task attribute may be selected.

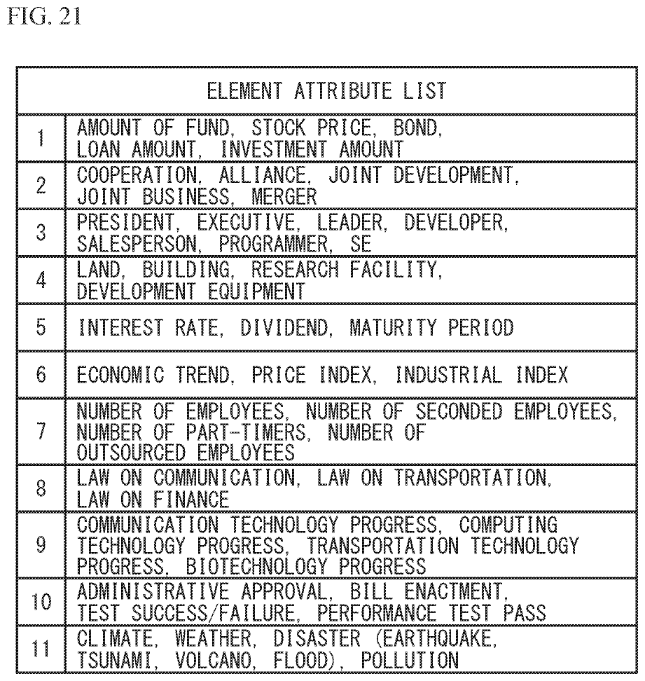

FIG. 21 is a diagram illustrating an example of a list of the element attributes. The element attributes may include “1. amount of fund, stock price, bond, loan amount, investment amount”, “2. cooperation, alliance, joint development, joint business, merger”, “3. president, executive, leader, developer, salesperson, programmer, SE”, “4. land, building, research facility, development equipment”, “5. interest rate, dividend, maturity period”, “6. economic trend, price index, industrial index”, “7. number of employees, number of seconded employees, number of part-timers, number of outsourced employees”, “8. law on communication, law on transportation, law on finance”, “9. communication technology progress, computing technology progress, transportation technology progress, biotechnology progress”, “10. administrative approval, bill enactment, test success/failure, performance test pass”, and “11. climate, weather, disaster (earthquake, tsunami, volcano, flood), pollution”

The “premise information holding unit” has a function of holding the acquired premise information in association with the project management information. If there is a change in the premise information, it is likely that the project management information associated with the premise information will need to be changed. Therefore, it is necessary to check for no changes in the premise information periodically or irregularly. When there is the change in the premise information, the warning output indicating the change of the premise information is output from a premise information change warning output unit. The change in premise information may be acquired manually or automatically. The system may also have a response guiding unit for guiding the project manager to respond periodically to whether there is the change in the premise information. Automatic acquisition of the change in premise information means that financial information such as stock prices and bonds, economic information such as business trends and price indexes, legal information such as laws, and weather information such as climate can be acquired via the Internet. The premise information may be expressed by language in a free-form, or expressed by numerical values such as information available on the Internet. If the premise information can be acquired in numerical values, the range of the premise information is specified in numerical values, and hence the system can be configured to output the warning information when the premise information falls outside the range of values.

<Hardware Configuration>

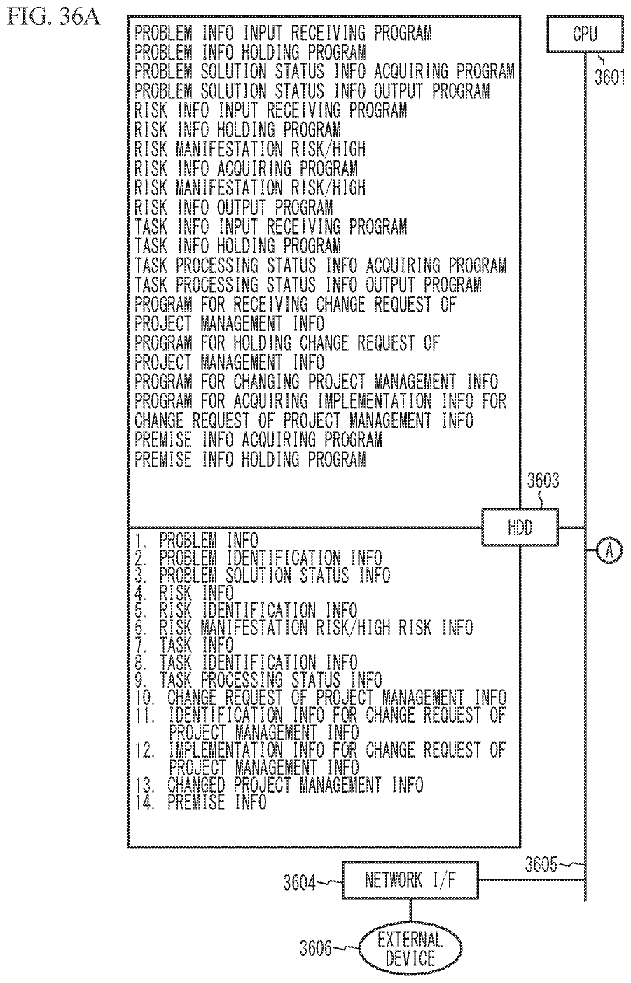

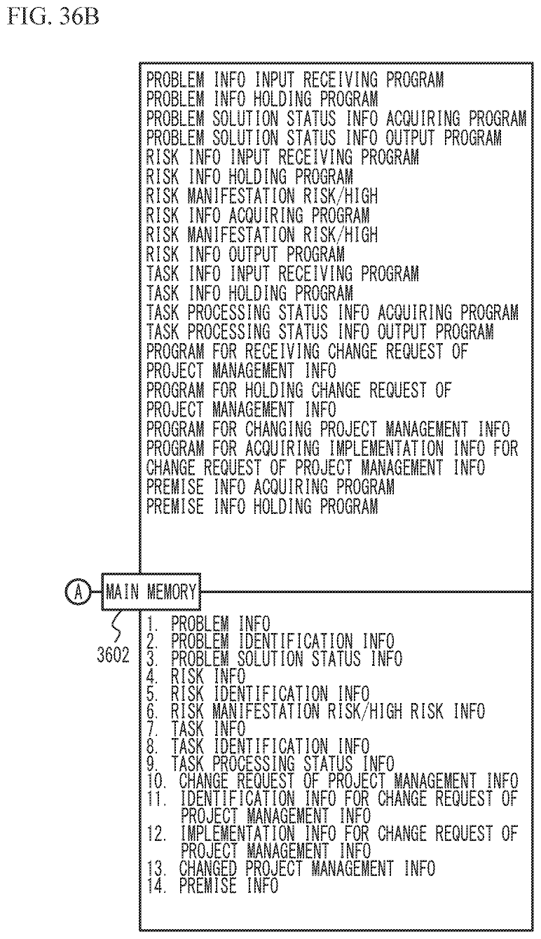

FIGS. 36A and 36B are diagrams illustrating the hardware configuration of the project management system according to the second embodiment. As illustrated in FIGS. 36A and 36B, the project management system according to the second embodiment includes a “CPU (central processing unit)” (3601) which performs various arithmetic operations, and a “main memory” (3602). Further, the project management system includes a “HDD” (3603) that holds predetermined information, and a “network I/F (interface)” (3604) that transmits and receives information to and from user terminal devices (3606) associated with a plurality of user identification information. The CPU, the main memory, the HDD and the network I/F are connected to each other by a data communication path such as a “system bus” (3605) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, a premise information acquiring program, and a premise information holding program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment. Further, in the present embodiment, the premise information is stored.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the premise information acquiring program stored in the main memory to acquire the premise information, which is information that is the premise capable of identifying the project management information through the network interface, in association with the project management information. The CPU executes the premise information holding program to hold the acquired premise information in association with the project management information.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

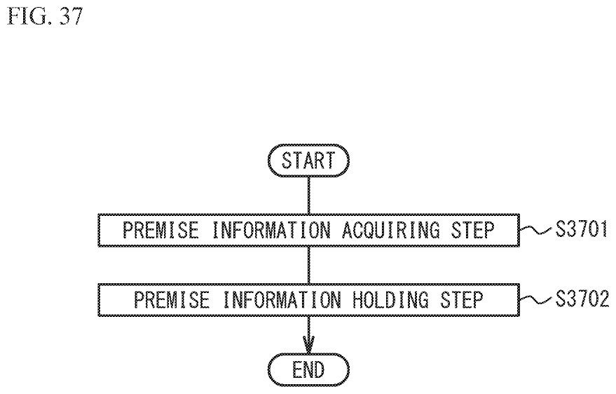

FIG. 37 is a flowchart illustrating processing when the project management system according to the second embodiment is used. The parts that overlap with the first embodiment are not illustrated in the figure, but it is assumed that the flow of processing in the first embodiment exists. In the second embodiment, there are a premise information acquiring step and a premise information holding step, in addition to the processing of the first embodiment, in any order. Hereinafter, the premise information acquiring step and the premise information holding step will be described.

The “premise information acquiring step” acquires the premise information, which is information that is the premise capable of identifying the project management information, in association with the project management information.

The “premise information holding step” holds the acquired premise information in association with the project management information.

<Conclusion>

As a result, it is possible to provide the project management system that can manage the project along with the premise of the project.

### Third Embodiment

The third embodiment provides the project management system that, in addition to the features of the first embodiment, is configured to generate problem information that must be resolved based on the manifested risk and record the problem information in association with the problem identification information when the risk manifestation risk/high risk information, which is information indicating that the held risk has manifested, is acquired in association with the risk identification information.

Hereinafter, the functional configuration, the hardware configuration, and the flow of processing of the project management system according to the third embodiment will be described in order.

<Functional Configuration>

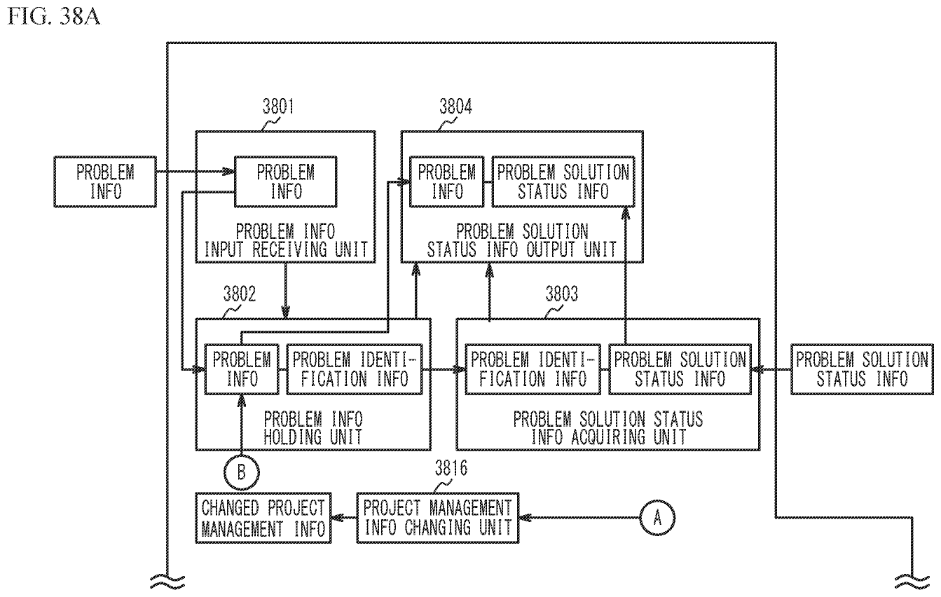

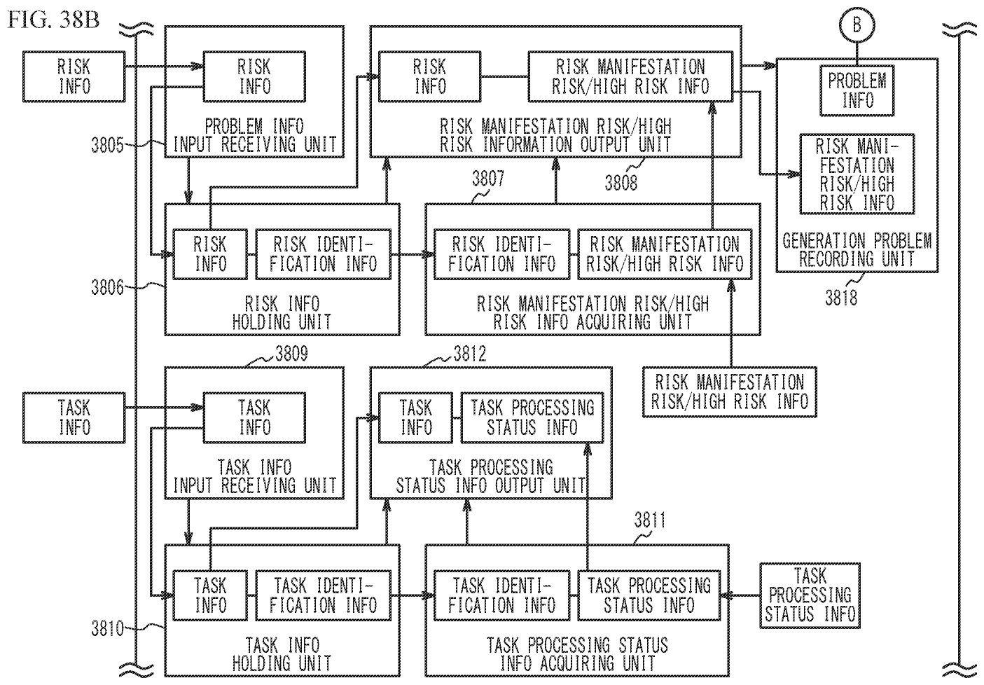

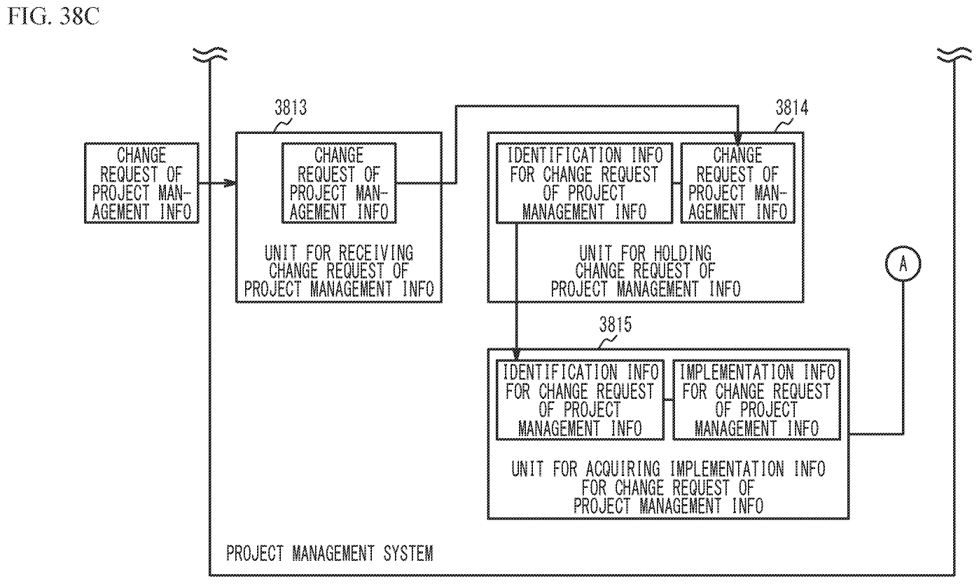

FIGS. 38A to 38C are diagrams illustrating a functional configuration of the project management system according to the third embodiment. The project management system according to the present embodiment includes a problem information input receiving unit (3801), a problem information holding unit (3802), a problem solution status information acquiring unit (3803), a problem solution status information output unit (3804), a risk information input receiving unit (3805), a risk information holding unit (3806), a risk manifestation risk/high risk information acquiring unit (3807), a risk manifestation risk/high risk information output unit (3808), a task information input receiving unit (3809), a task information holding unit (3810), a task processing status information acquiring unit (3811), a task processing status information output unit (3812), a unit for receiving change request of project management information (3813), a unit for holding change request of project management information (3814), a unit for acquiring implementation information for change request of project management information (3815), a project management information changing unit (3816), and a generation problem recording unit (3817). Hereinafter, the content of each function will be specifically described. Since each function except for the generation problem recording unit is the same as that in the first embodiment, the explanation is limited to the function of the generation problem recording unit.

The “risk” includes the impossibility of procuring the resource or the loss of the resource, the loss of infrastructure to handle the task and the problem, and the loss of demand for the goal to be achieved by the execution of the project. For example, the impossibility of procuring the resource is a case where war breaks out in an oil field area and crude oil as the raw material cannot be imported. For example, the loss of the resource is a case in which stored valuable raw materials are lost in a fire. For example, the loss of infrastructure is a case where a major earthquake disrupts the transportation routes for raw materials, or a factory where the project was going to be implemented collapses. If these risks are replaced with the problems, the risk of “impossibility of importing crude oil” becomes the problem of “procuring stockpiled crude oil”, the risk of “burning of stored valuable raw materials” becomes the problem of “early procurement of valuable raw materials”, the risk of “collapse of raw material transportation routes” becomes the problem of “establishing alternative transportation routes”, and the risk of “collapse of factories” becomes the problem of “contracting with alternative factories”.

In such a case where a risk is manifested, it is preferable to have an automatic problem registration unit that records what kind of problem the risk turns into at the time of registration of the risk information or after registration of the risk information, in association with the risk identification information, and automatically registers it as a problem that is the project management information when the risk is manifested.

In addition, the system (i.e., the automatic problem registration unit) may be configured to automatically register the problem in the case of high risk. For example, if the war breaks out in the oil field area, but the crude oil as the raw material can still be imported, the system registers a problem “importing crude oil ahead of schedule” in advance, and automatically registers the problem in the state of the high risk. If the weather forecast indicates that a large typhoon may occur and cause serious damage to the production area of the raw materials, a new problem “transporting the raw materials to the site while the large typhoon is over the Southern Ocean” occurs.

The “generation problem recording unit” has a function of generating the problem information that must be solved based on the manifested risk or acquiring information that has been held in advance and recording it in the problem information holding unit in association with the problem identification information, when the risk manifestation risk/high risk information, which is information indicating that the held risk has manifested, is acquired in association with the risk identification information. The problem information stored in the problem information holding unit is output from the problem resolution status information output unit in the same way as normal problem information. Initially, the problem resolution status is usually output as zero.

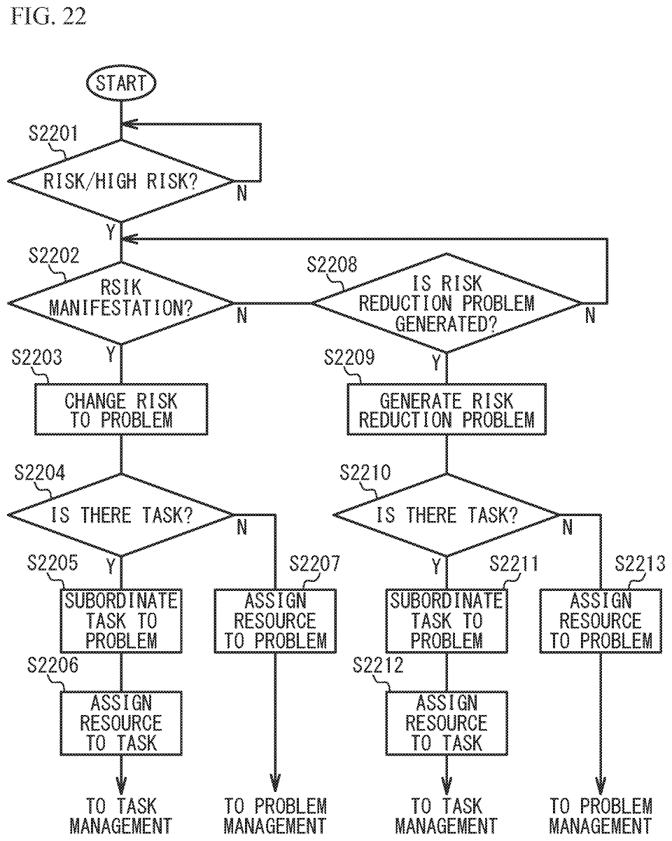

FIG. 22 is a flowchart of processing content performed by the generation problem recording unit. First of all, for “high risk”, it is determined whether the risk is increasing or not (S2201), and if not, there is no problem, but if the risk is increasing (YES in S2201), it is determined whether the risk is manifested (S2202). If it is determined that the risk is manifested (YES in S2202), the risk is changed to the problem (S2203). Further, it is determined whether the problem includes the task (S2204). When the problem includes the task (YES in S2204), the task is subordinated to the problem (S2205) and the resources are assigned to the task for task management (S2206). When the problem does not include the task (NO in S2204), the resources are assigned to the problem for problem management (S2207). On the other hand, if it is not determined that the risk is manifested (NO in S2202), it is determined whether to generate a risk reduction problem (S2208). If there is no need to generate the risk reduction problem (NO in S2208), the procedure returns to S2202. On the other hand, if there is a need to generate the risk reduction problem (YES in S2208), the risk reduction problem is generated (S2209). Further, it is determined whether the problem includes the task (S2210). When the problem includes the task (YES in S2210), the task is subordinated to the problem (S2211) and the resources are assigned to the task for task management (S2212). When the problem does not include the task (NO in S2210), the resources are assigned to the problem for problem management (S2213). This processing is just an example, and is not limited to such a processing procedure.

<Hardware Configuration>

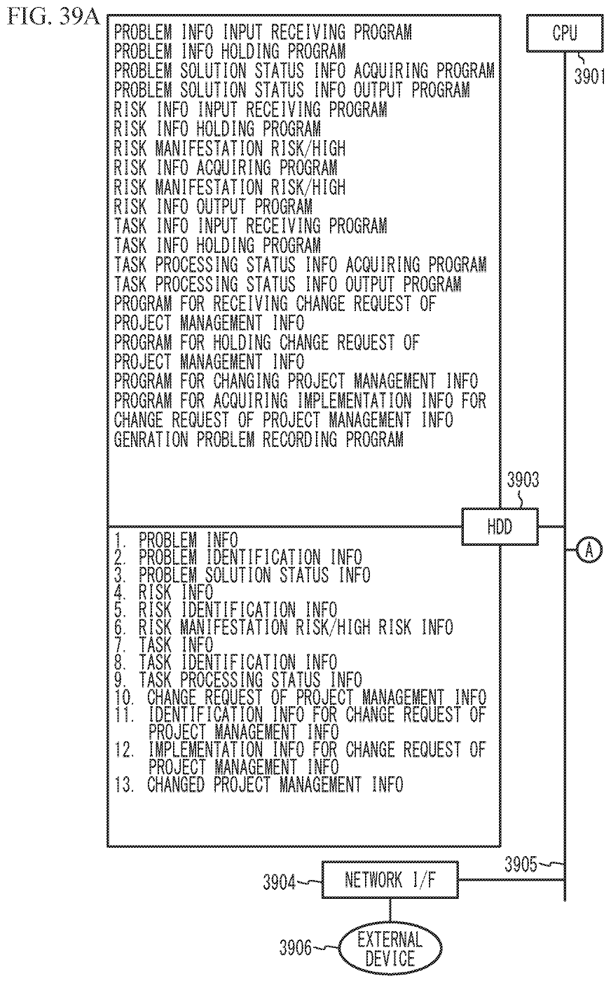

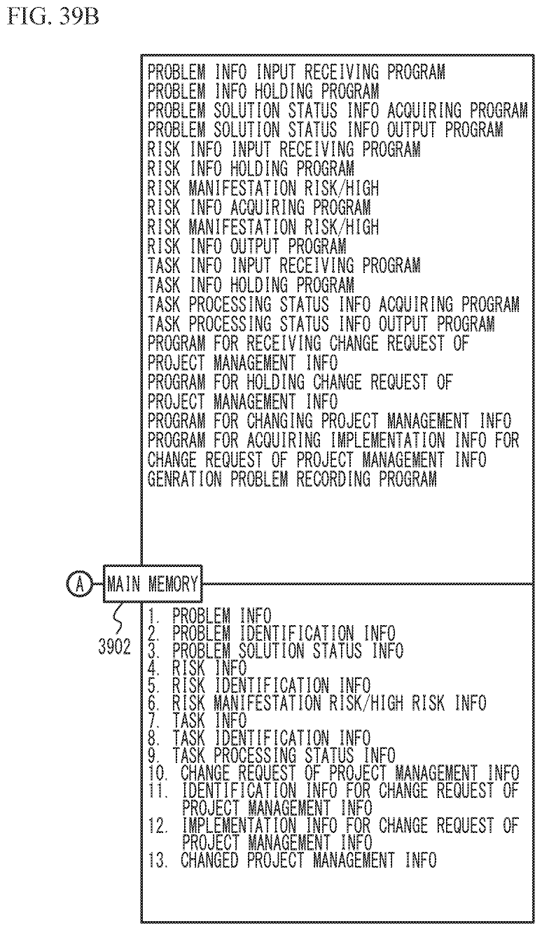

FIGS. 39A and 39B are diagrams illustrating the hardware configuration of the project management system according to the third embodiment. The parts that overlap with the first embodiment are not illustrated in the figure, but it is assumed that the flow of processing in the first embodiment exists. As illustrated in FIGS. 39A and 39B, the project management system according to the third embodiment includes a “CPU (central processing unit)” (3901) which performs various arithmetic operations, and a “main memory” (3902). Further, the project management system includes a “HDD” (3903) that holds predetermined information, and a “network I/F (interface)” (3904) that transmits and receives information to and from user terminal devices (3906) associated with a plurality of user identification information. The CPU, the main memory, the HDD and the network I/F are connected to each other by a data communication path such as a “system bus” (3905) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, and a generation problem recording program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result. The CPU executes the generation problem recording program stored in the main memory to generate the problem information that must be solved based on the manifested risk (e.g., generates problems by artificial intelligence) or acquires pre-registered problem information to additionally record the problem information in the problem information holding unit in association with the problem identification information, when the risk manifestation risk/high risk information, which is information indicating that the held risk has manifested, is acquired in association with the risk identification information. If the newly recorded problem information is positioned hierarchically in relation to another problem information, information indicating the hierarchical relationship with the another problem information is also recorded. The information indicating this hierarchical relationship should be configurated in such a way that it can be referred to when accessing all problem information that has a direct relationship.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result. When a new problem is additionally recorded by acquiring the risk manifestation risk/high risk information, it is preferable to output a warning to the authorized project participants to encourage them to input the task to solve the new problem.

It is also preferable to register in advance the problem information that must be newly added and the task that must be processed to solve the problem when the risk is manifest by the risk manifestation risk/high risk information or when the high-risked risk is registered. In this way, if there is a pre-registered task, it is preferable to configure the system so that the task information is newly and automatically added along with the additional recording of the problem information that has occurred according to the risk manifestation risk/high risk information. Note that all newly added problem information and task information that must be handled in accordance with them does not need to be recorded automatically. For example, it is preferable to prompt the project participant who has the authority to input the elements that need to be considered dynamically, such as personnel assignments.

Next, the CPU executes the program for receiving change request of project management information stored in the main memory to receive input of the change request of the project management information through the network interface. When the risk manifestation risk/high risk information is acquired, there are additional problem information to be recorded and additional task information to be recorded. Therefore, it is preferable to have this program function to allow the authorized project participant to enter the change request of the project management information In this case, the project management information includes two cases, i.e., a case where the project management information indicates the newly added problem or the newly added task information, and a case where a change is made to the project management information in order to make a change to the previous project management information. The system may be designed so that the former is done automatically and the latter is left to the project participant who has the authority, or the former may be configured so that the process of change request of the project management information is skipped and completed by additionally recording the project management information. In any case, in most cases where the risk manifestation risk/high risk information is acquired, changes to the previous project management information will be necessary. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

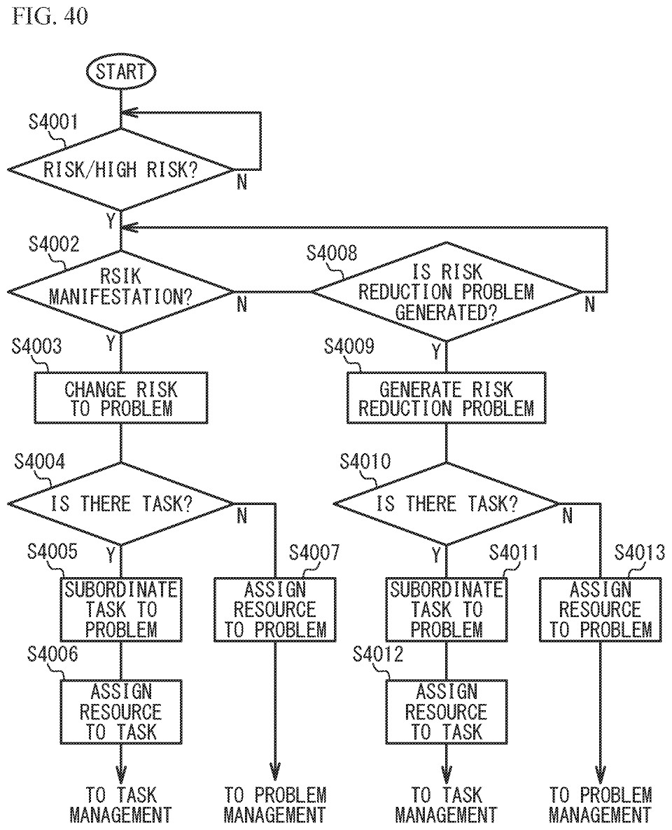

FIG. 40 is a flowchart illustrating processing when the project management system according to the third embodiment is used. The parts that overlap with the first embodiment are not illustrated in the figure, but it is assumed that the flow of processing in the first embodiment exists. First of all, for “high risk”, it is determined whether the risk is increasing or not (S4001), and if not, there is no problem, but if the risk is increasing (YES in S4001), it is determined whether the risk is manifested (S4002). If it is determined that the risk is manifested (YES in S4002), the risk is changed to the problem (S4003). Further, it is determined whether the problem includes the task (S4004). When the problem includes the task (YES in S4004), the task is subordinated to the problem (S4005) and the resources are assigned to the task for task management (S4006). When the problem does not include the task (NO in S2204), the resources are assigned to the problem for problem management (S4007). On the other hand, if it is not determined that the risk is manifested (although the risk is high-risked) (NO in S4002), it is determined whether to generate a risk reduction problem (S4008). If there is no need to generate the risk reduction problem (NO in S4008), the procedure returns to S4002. On the other hand, if there is a need to generate the risk reduction problem (YES in S4008), the risk reduction problem is generated (S4009). Further, it is determined whether the problem includes the task (S4010). When the problem includes the task (YES in S4010), the task is subordinated to the problem (S4011) and the resources are assigned to the task for task management (S4012). When the problem does not include the task (NO in S4010), the resources are assigned to the problem for problem management (S4013). The overall flow is as described above. The processing method can be simply configured to have a generation problem recording step, so such an example is simply described.

The “generation problem recording step” generates the problem information that must be resolved based on the manifested risk and records it in the problem information holding unit in association with the problem identification information when the risk manifestation risk/high risk information, which is information indicating that the held risk has manifested, is acquired in association with the risk identification information.

<Conclusion>

As described above, it is possible to provide a project management system that can automatically present a measure when the risk is manifested or high-risked.

### Fourth Embodiment

The fourth embodiment provides the project management system that, in addition to the features of the third embodiment, is configured to input the task information to be associated with the newly generated and held problem information, in association with the problem information.

Hereinafter, the functional configuration, the hardware configuration, and the flow of processing of the project management system according to the second embodiment will be described in order.

<Functional Configuration>

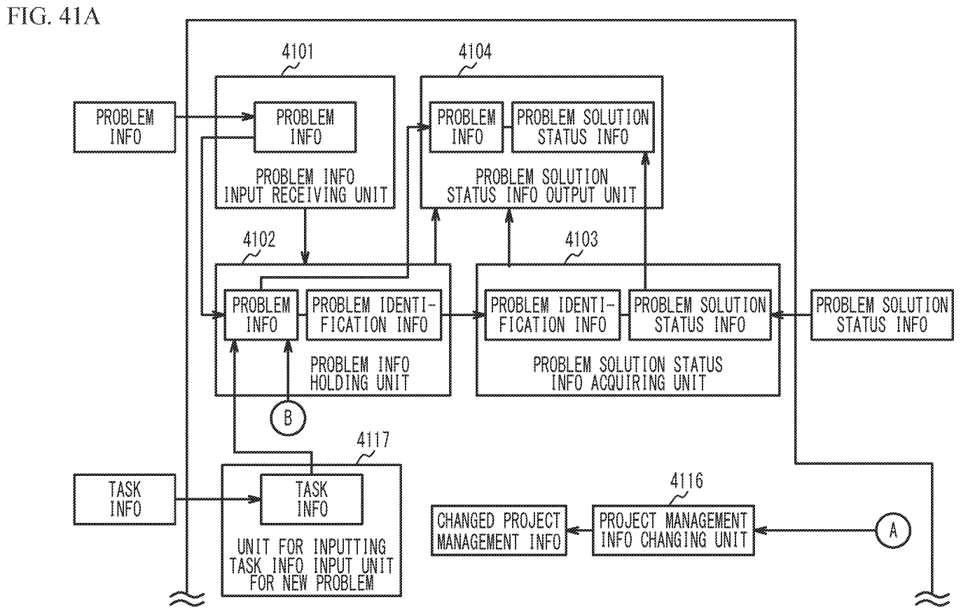

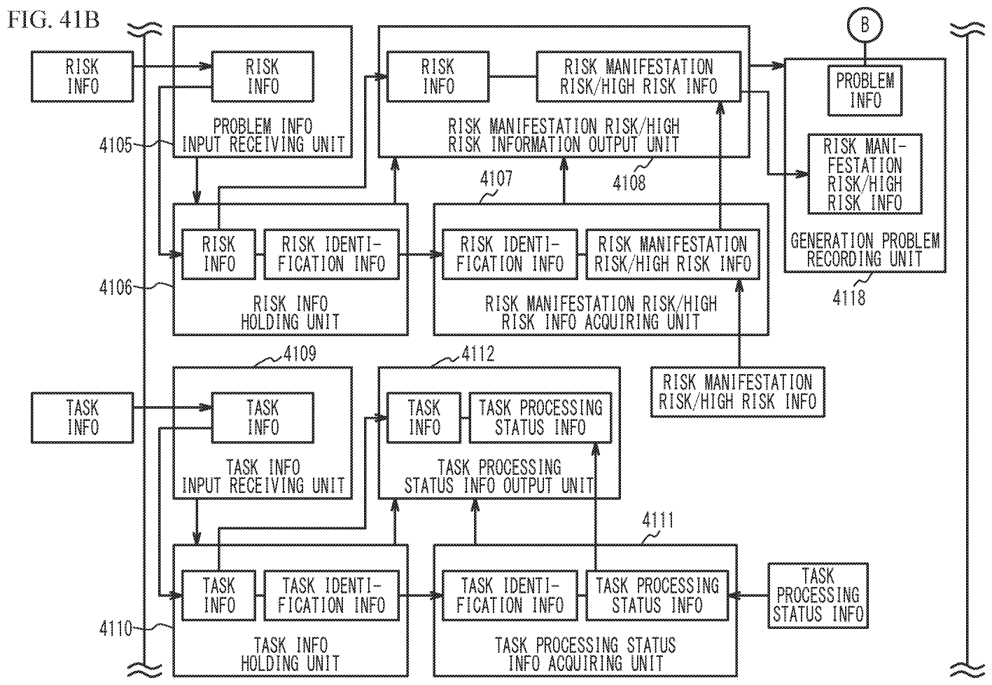

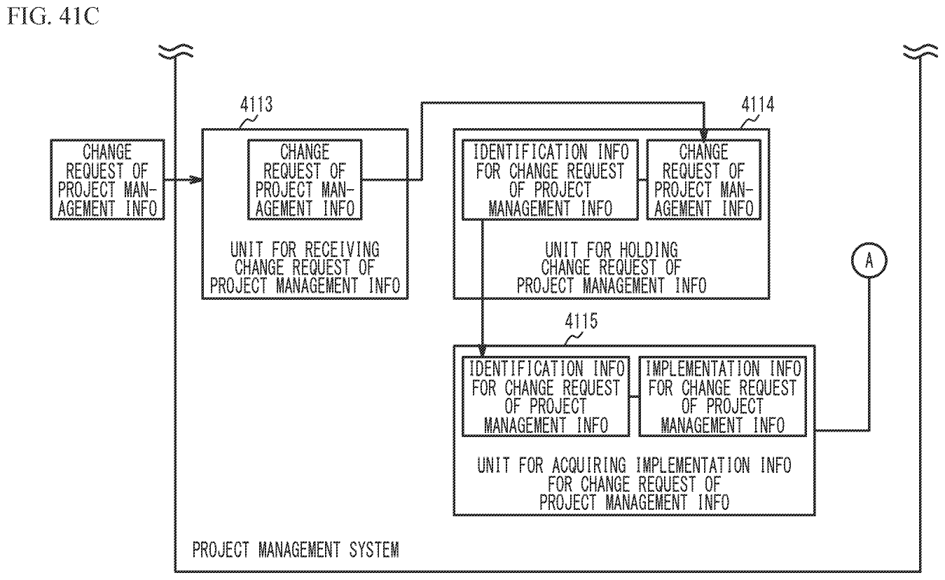

FIGS. 41A to 41C are diagrams illustrating a functional configuration of the project management system according to the fourth embodiment. The project management system according to the present embodiment includes a problem information input receiving unit (4101), a problem information holding unit (4102), a problem solution status information acquiring unit (4103), a problem solution status information output unit (4104), a risk information input receiving unit (4105), a risk information holding unit (4106), a risk manifestation risk/high risk information acquiring unit (4107), a risk manifestation risk/high risk information output unit (4108), a task information input receiving unit (4109), a task information holding unit (4110), a task processing status information acquiring unit (4111), a task processing status information output unit (4112), a unit for receiving change request of project management information (4113), a unit for holding change request of project management information (4114), a unit for acquiring implementation information for change request of project management information (4115), a project management information changing unit (4116), and a unit for inputting task information for new problem (4117). Hereinafter, the content of each function will be specifically described. Since each function except for the unit for inputting task information for new problem is the same as that in the third embodiment, the explanation is limited to the function of the unit for inputting task information for new problem.

The “unit for inputting task information for new problem” has a function of inputting the task information to be associated with the newly generated and held problem information, in association with the problem information.

<Hardware Configuration>

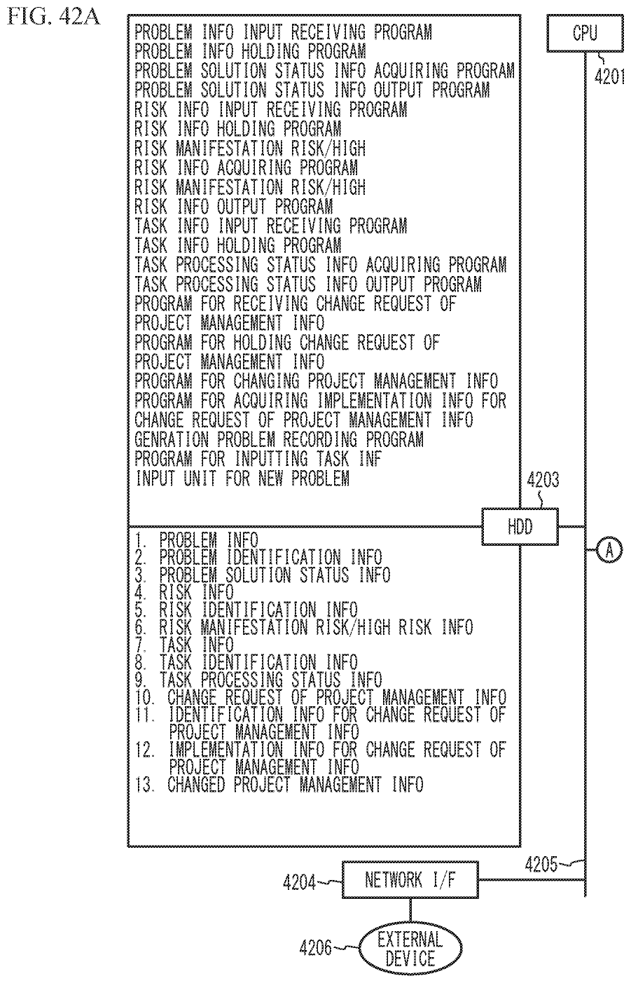

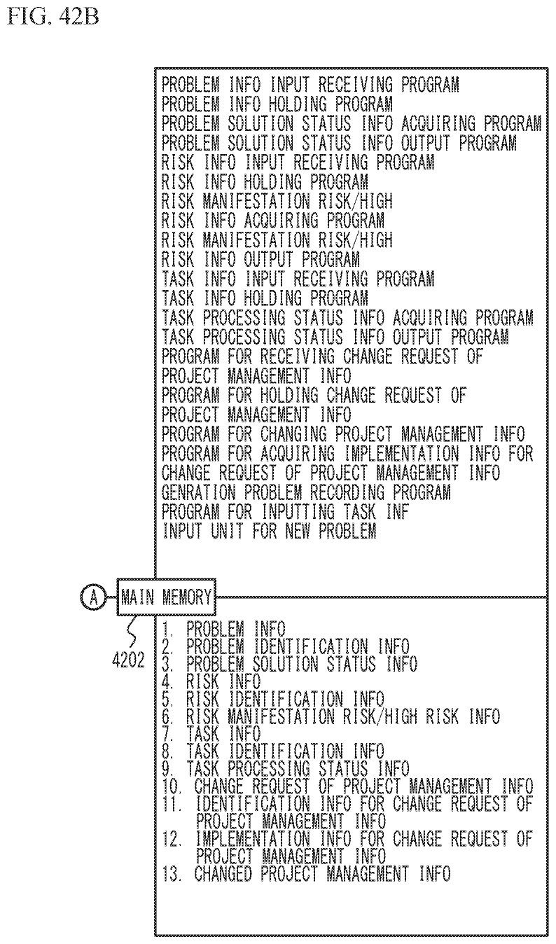

FIGS. 42A and 42B are diagrams illustrating the hardware configuration of the project management system according to the fourth embodiment. As illustrated in FIGS. 42A and 42B, the project management system according to the fourth embodiment includes a “CPU (central processing unit)” (4201) which performs various arithmetic operations, and a “main memory” (4202). Further, the project management system includes a “HDD” (4203) that holds predetermined information, and a “network I/F (interface)” (4204) that transmits and receives information to and from user terminal devices (4206) associated with a plurality of user identification information. The CPU, the main memory, the HDD and the network I/F are connected to each other by a data communication path such as a “system bus” (4205) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, the generation problem recording program, and a program for inputting task information for new problem.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result. The CPU executes the generation problem recording program stored in the main memory to generate the problem information that must be solved based on the manifested risk (e.g., generates problems by artificial intelligence) or acquires the problem information registered together with the risk information in advance to record the problem information in the problem information holding unit in association with the problem identification information, when the risk manifestation risk/high risk information, which is information indicating that the held risk has manifested, is acquired in association with the risk identification information. The CPU executes the program for inputting task information for new problem stored in the main memory to input the task information to be associated with the newly generated and held problem information, in association with the problem information. As mentioned above, all task information may be prepared and registered in advance, and the system may be configured to automatically register the task information.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

The flow of processing when the project management system according to the fourth embodiment is used is not illustrated in the figure, but it is assumed that the flow of processing in the first embodiment exists. In the fourth embodiment, there is a step for inputting task information for new problem, in addition to the processing of the first embodiment, in any order. Hereinafter, the step for inputting task information for new problem will be described.

The “step for inputting task information for new problem” inputs the task information to be associated with the newly generated and held problem information, in association with the problem information.

<Conclusion>

As described above, it is possible to provide a project management system that can manage the project including task positioned below the generated problem.

### Fifth Embodiment

The fifth embodiment provides the project management system that, in addition to the features of the first embodiment, is configured to receive an input of experience information which includes successful experience information indicating a successful experience or/and failure experience information indicating a failure experience.

Hereinafter, the functional configuration, the hardware configuration, and the flow of processing of the project management system according to the fifth embodiment will be described in order.

<Functional Configuration>

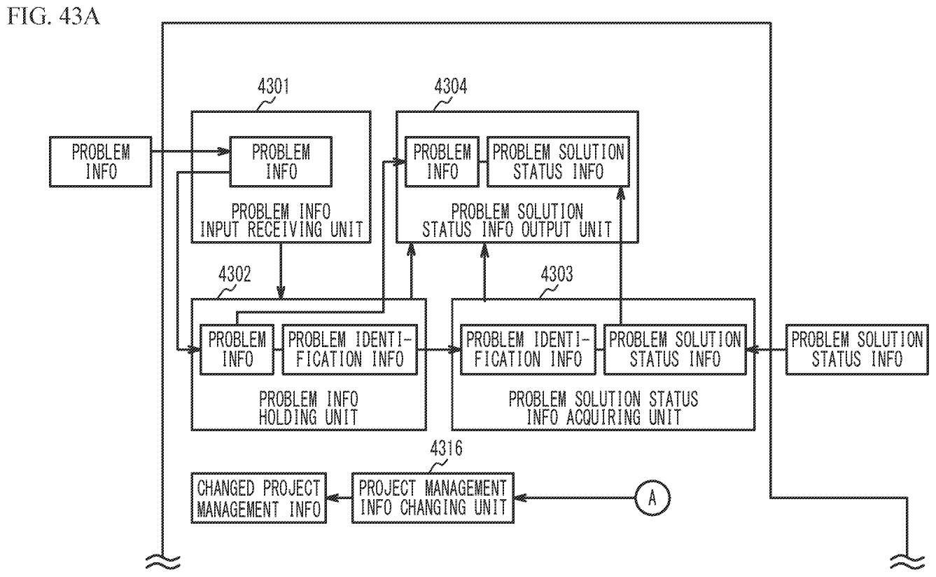

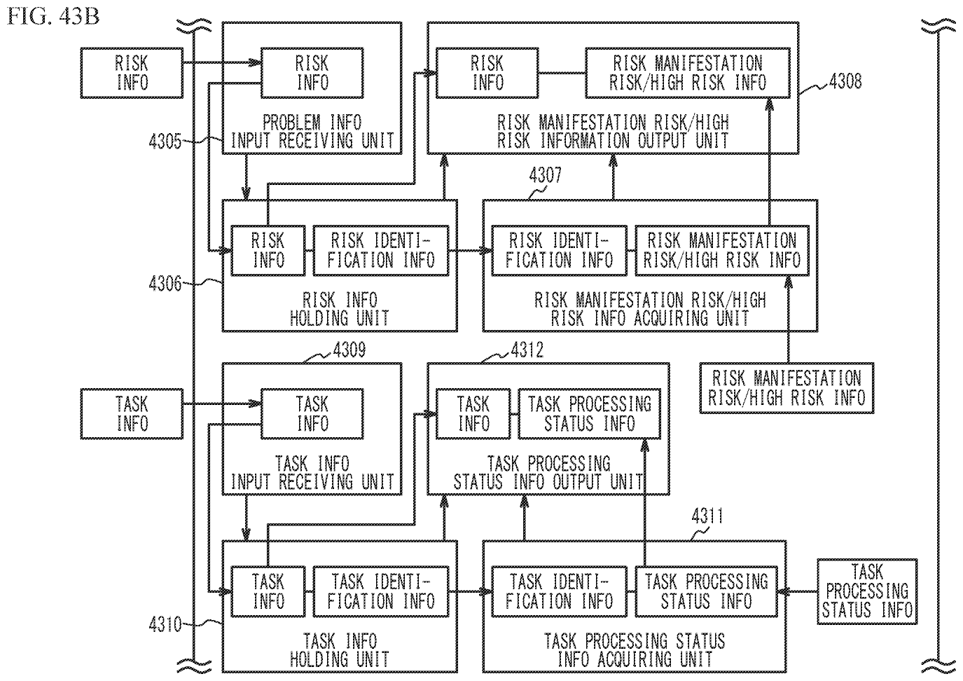

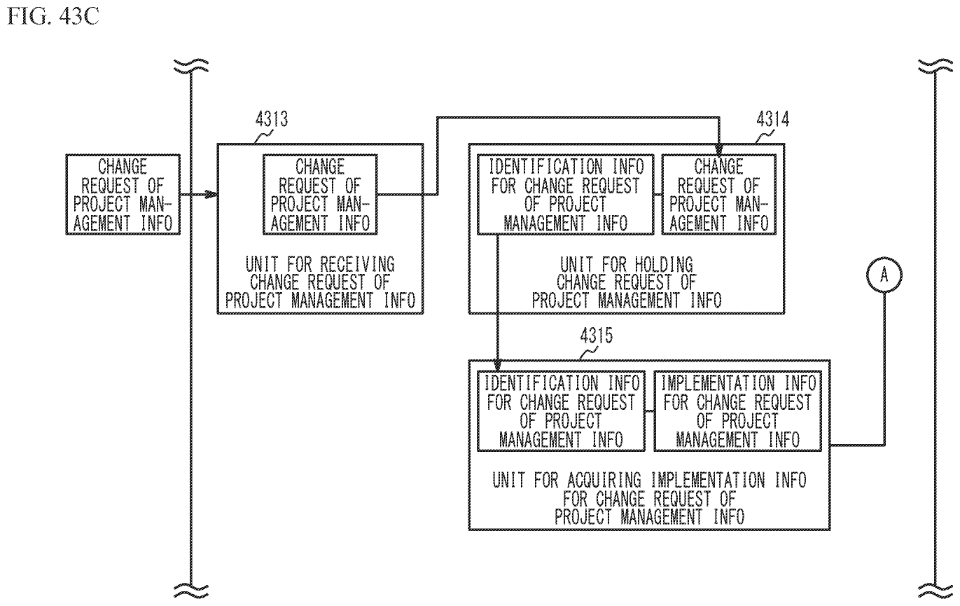

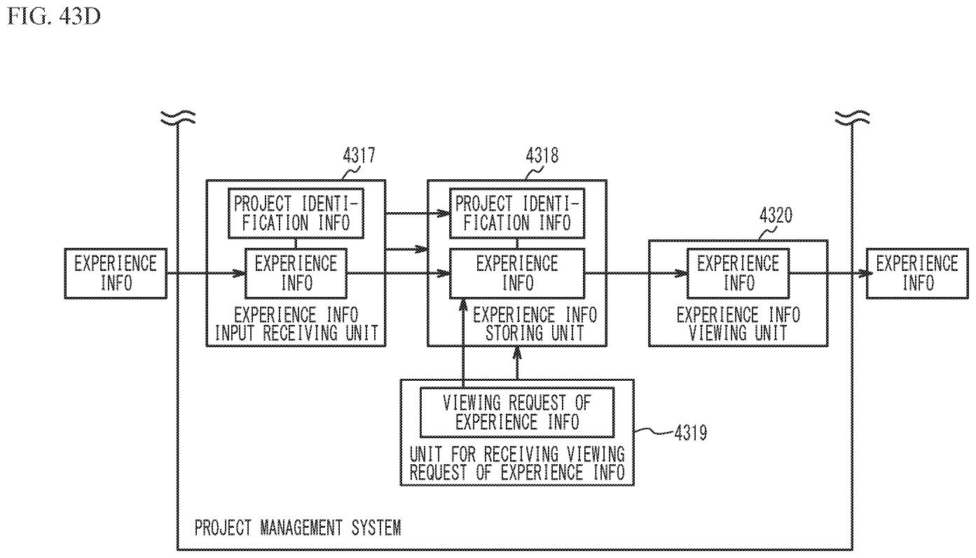

FIGS. 43A to 43D are diagrams illustrating a functional configuration of the project management system according to the fifth embodiment. The project management system according to the present embodiment includes a problem information input receiving unit (4301), a problem information holding unit (4302), a problem solution status information acquiring unit (4303), a problem solution status information output unit (4304), a risk information input receiving unit (4305), a risk information holding unit (4306), a risk manifestation risk/high risk information acquiring unit (4307), a risk manifestation risk/high risk information output unit (4308), a task information input receiving unit (4309), a task information holding unit (4310), a task processing status information acquiring unit (4311), a task processing status information output unit (4312), a unit for receiving change request of project management information (4313), a unit for holding change request of project management information (4314), a unit for acquiring implementation information for change request of project management information (4315), a project management information changing unit (4316), an experience information input receiving unit (4317), an experience information storing unit (4318), a unit for receiving viewing request of experience information (4319), and an experience information viewing unit (4320). Hereinafter, the content of each function will be specifically described. Since each function except for the experience information input receiving unit, the experience information storing unit, the unit for receiving viewing request of experience information, and the experience information viewing unit is the same as that in the first embodiment, the explanation is limited to the functions of the experience information input receiving unit, the experience information storing unit, the unit for receiving viewing request of experience information, and the experience information viewing unit.

The “experience information input receiving unit” has a function of receiving the input of the experience information which includes successful experience information indicating the successful experience or/and failure experience information indicating the failure experience. The experience information preferably includes one or more pieces of text information, video information, attached document information, still image information, and audio information.

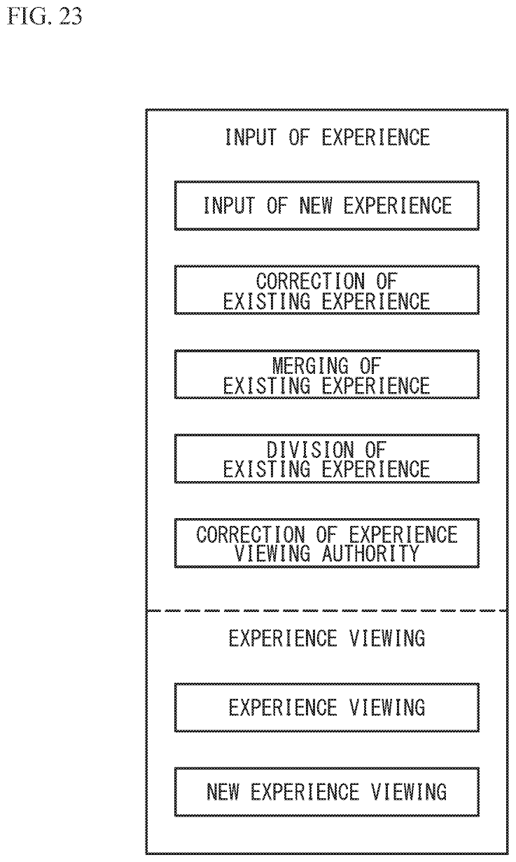

FIG. 23 is a conceptual diagram illustrating an example of a portal screen for inputting and correcting the experience information. The portal screen has selection parts such as “input of new experience”, “correction of existing experience”, “merging of existing experience”, “division of existing experience” and “correction of experience viewing authority” as items related to the experience input, and selection parts such as “experience viewing” and “new experience viewing” as items related to the experience viewing. By selecting one of them, the portal screen shifts to a next screen. The “correction of experience viewing authority” is for correcting the scope of persons who are authorized to view the experience information.

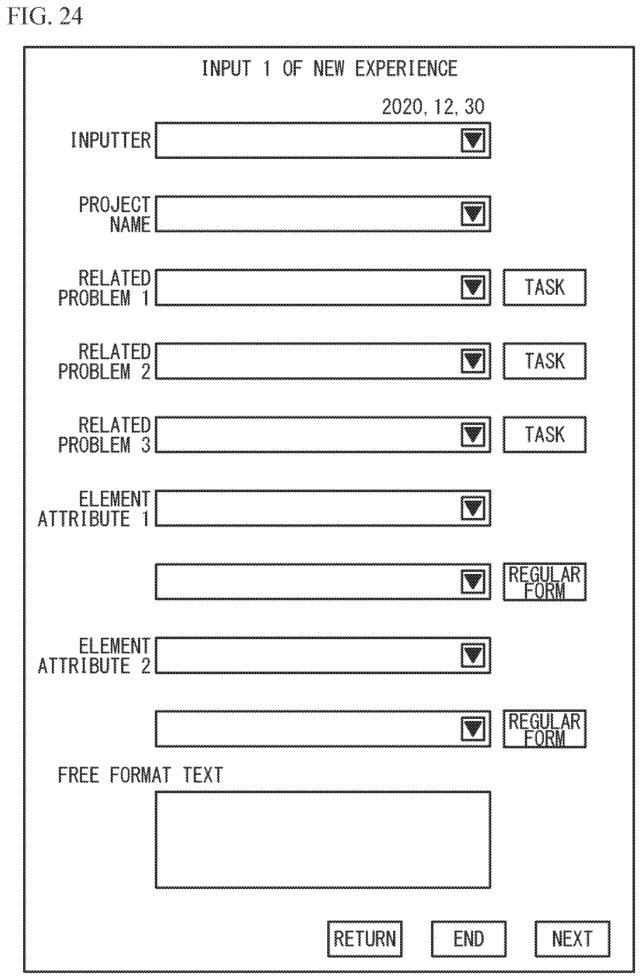

FIG. 24 is a conceptual diagram illustrating an example of a new experience information input screen. The new experience information input screen includes items such as “inputter”, “project name” and “related problem(s)”, and further “element attribute(s)” as the premise content, and the experience information is registered by inputting data into the items. Since it is assumed that the contents of the project have already been registered, each item may be selected by the pull-down menu. Selecting a “task” button shifts from the new experience information input screen to an input screen of the task associated with the problem. The “element attribute” is as described above in the explanation of the premise information. Although not illustrated in the figure, the scope of persons who are authorized to view the experience information may be specified. After inputting data into the items, the experience information is registered when “end” is selected, the new experience information input screen returns to a previous screen without registering the experience information when “return” is selected, and the new experience information input screen shifts to a next screen when “next” is selected. In addition, the task attribute may be selected. Here, the experience information is an example of free-format text.

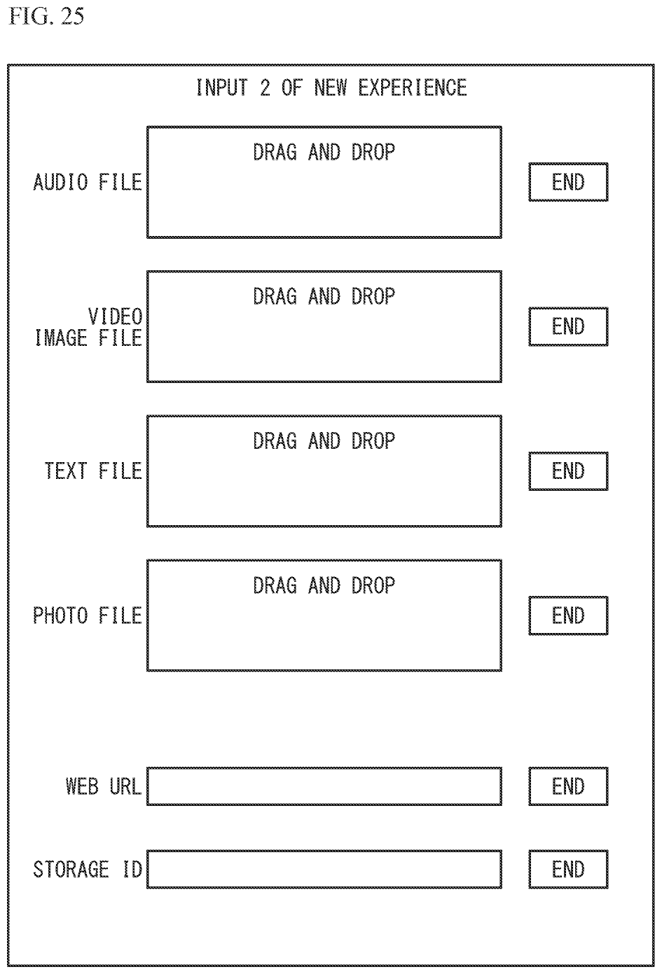

FIG. 25 is a diagram illustrating an example of a case where input of the experience information is received by an audio file, a video file, a text file, a photo file, a WEB URL, a storage ID, or the like. Files such as audio files, video files, text files, photo files, WEB URLs, storage IDs, etc. that are suitable for conveying the experience are saved by dragging and dropping, and the experience information is registered by selecting the “end” button. The experience information input screen in FIG. 25 is based on the assumption that data is entered into the items in FIG. 24. The audio file is often the voice of the person who experienced the event, but it can also be a recording of a meeting where important decisions were made, a recording of negotiations that influenced the project, or any other audio information that is closely related to the execution of the project. It would be useful to design the system in such a way that the inputter can input commentary information and other information as text synchronously with the audio information. The commentary information is, for example, notes for better understanding of the speech, such as who the speaker is, what the term refers to, and the moment when the flow changed is here. The video files are, for example, videos that provide easy-to-understand explanations of successful cases in experiments and contemplation sites, or conversely, videos that introduce cases of failure, in addition to the scenes described above. In the case of experiments, the commentary may be entered as text along with the video, so that the video and commentary can be viewed in synchronization with each other. It is advisable to use high-definition video as much as possible, and to use the video that has clear image quality even when enlarged. For example, the video is 4K and 8K videos. The text file may include various types of information. The text file may include autobiographical text about the project, as well as a text that clearly conveys the main points by reading and analyzing know-how, ideas that have been successfully put into practice, and big data used for analysis. In the case of big data which is difficult to refer to on its own, a data analysis program in associated with it is available to make effective use of the information. The data analysis program may be held and made available with the text data, or the link information to the data analysis program may be recorded and made available with the text data. In order to do this, the system can be configured to let the inputter input the information using templates. The photo files may include various types, for example, micrographs, scenes of meetings, scenes of negotiations, and so on. In addition, various types of photos such as disassembled photos of competitors' products or photos of data collections obtained in secret may be included in the photo files.

The “experience information storing unit” has a function of storing the experience information that received the input, in association with the project identification information.

The “unit for receiving viewing request of experience information” has a function of receiving a viewing request of the stored experience information.

The “experience information viewing unit” has a function that allows the users to view the experience information according to the received viewing request.

<Hardware Configuration>

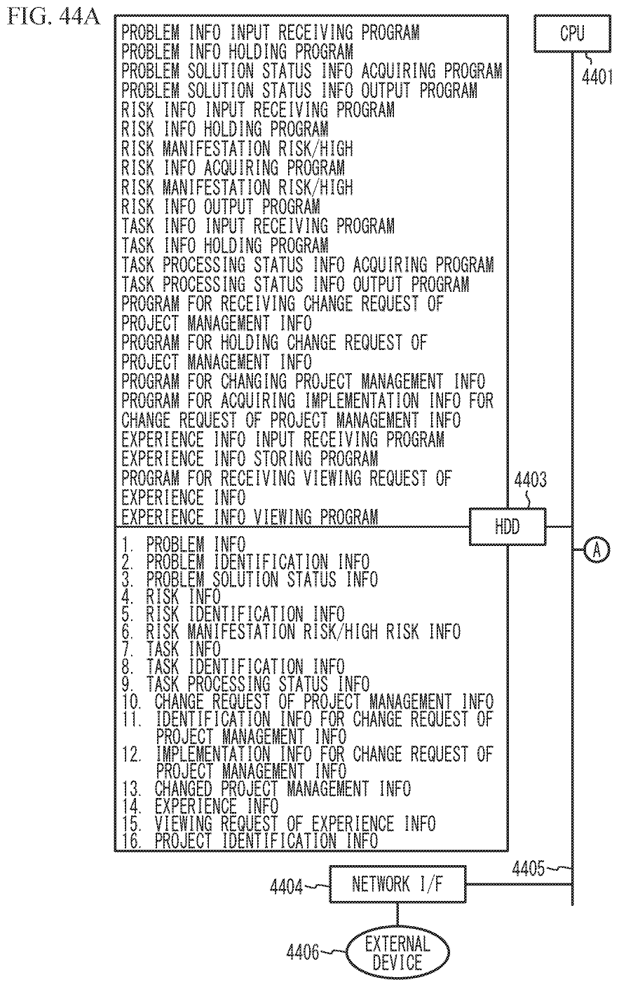

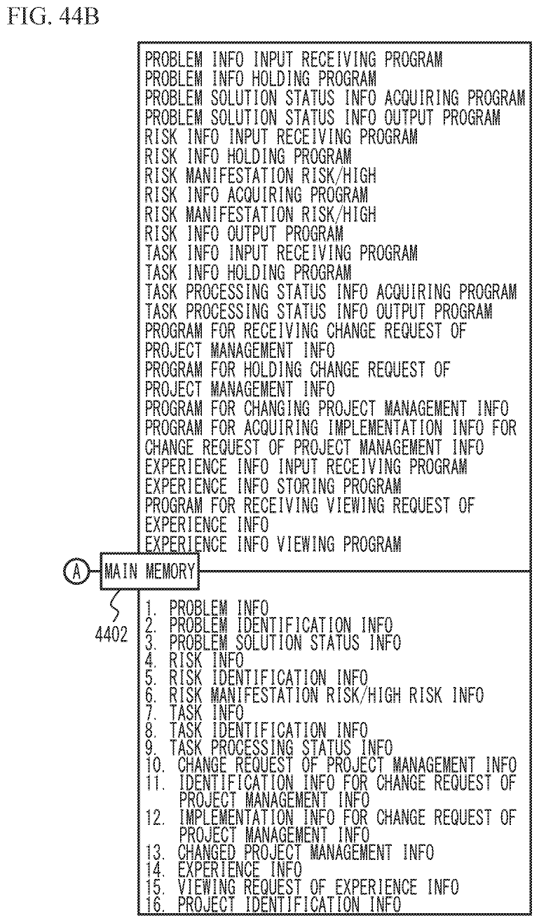

FIGS. 44A and 44B are diagrams illustrating the hardware configuration of the project management system according to the fifth embodiment. As illustrated in FIGS. 44A and 44B, the project management system according to the fifth embodiment includes a “CPU (central processing unit)” (4401) which performs various arithmetic operations, and a “main memory” (4402). Further, the project management system includes a “HDD” (4403) that holds predetermined information, and a “network I/F (interface)” (4404) that transmits and receives information to and from user terminal devices (4406) associated with a plurality of user identification information. The CPU, the main memory, the HDD and the network I/F are connected to each other by a data communication path such as a “system bus” (4405) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, an experience information input receiving program, an experience information storing program, a program for receiving viewing request of experience information, and an experience information viewing program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment. Further, in the present embodiment, the experience information and the viewing request are stored.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the experience information input receiving program stored in the main memory to receive the input of the experience information, which includes the successful experience information indicating the successful experience or/and the failure experience information indicating the failure experience, in association with the project identification information that identifies the project through the network interface. The CPU executes the experience information storing program to store the experience information that received the input, in association with the project identification information. The CPU executes the program for receiving viewing request of experience information stored in the main memory to receive the viewing request of the stored experience information. The CPU executes the experience information viewing program stored in the main memory to allow the user to view the experience information according to the received viewing request.

My project may be improved based on the viewing of the experience information of another project. In that case, a change request of the project management information will be implemented. Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

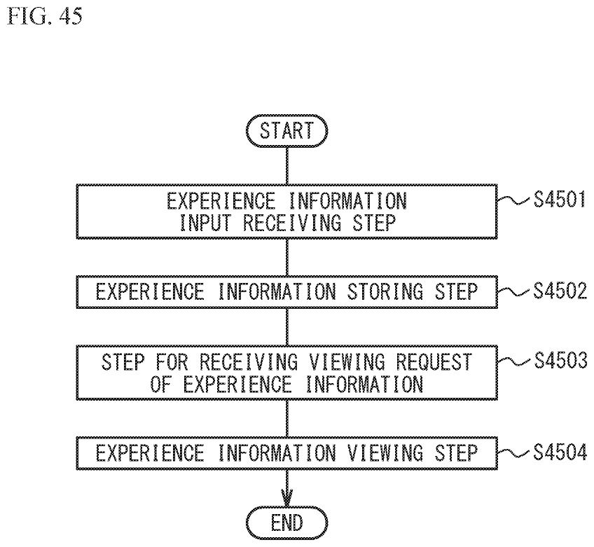

FIG. 45 is a flowchart illustrating processing when the project management system according to the fifth embodiment is used. The parts that overlap with the first embodiment are not illustrated in the figure, but it is assumed that the flow of processing in the first embodiment exists. In the fifth embodiment, there are an experience information input receiving step, an experience information storing step, a step for receiving viewing request of experience information, and an experience information viewing step, in addition to the processing of the first embodiment, in any order. Hereinafter, the experience information input receiving step, the experience information storing step, the step for receiving viewing request of experience information, and the experience information viewing step will be described.

The “experience information input receiving step” receive the input of the experience information which includes the successful experience information indicating the successful experience or/and the failure experience information indicating the failure experience.

The “experience information storing step” receives the experience information that received the input, in association with the project identification information.

The “step for receiving viewing request of experience information” receives the viewing request of the stored experience information.

The “experience information viewing step” allows the users to view the experience information according to the received viewing request.

<Conclusion>

As described above, it is possible to provide a project management system that can utilize past experience information for an ongoing project.

### Sixth Embodiment

The sixth embodiment provides the project management system that, in addition to the features of the fifth embodiment, is configured to receive an input of the experience information in association with the project identification information.

Hereinafter, the functional configuration, the hardware configuration, and the flow of processing of the project management system according to the sixth embodiment will be described in order.

<Functional Configuration>

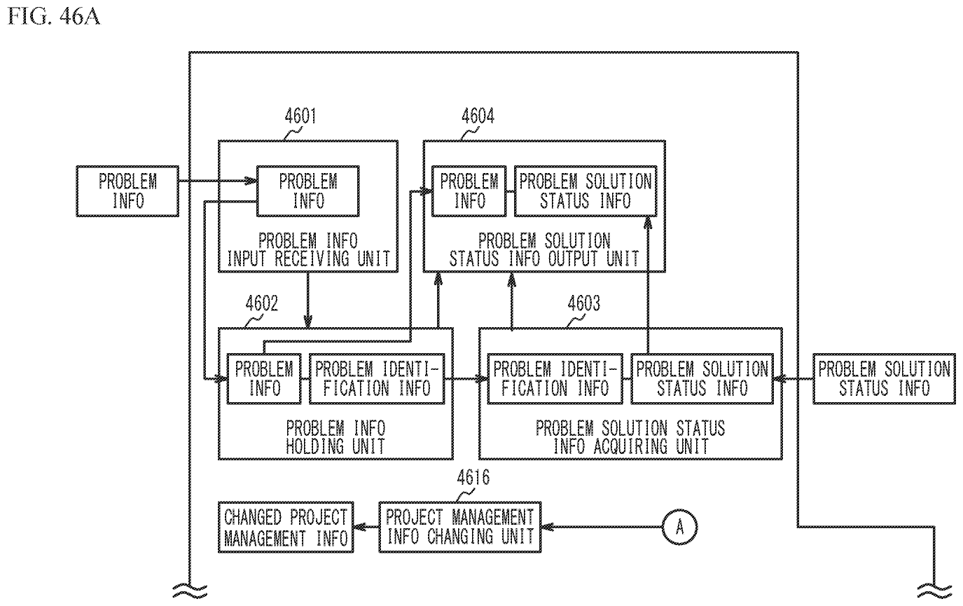

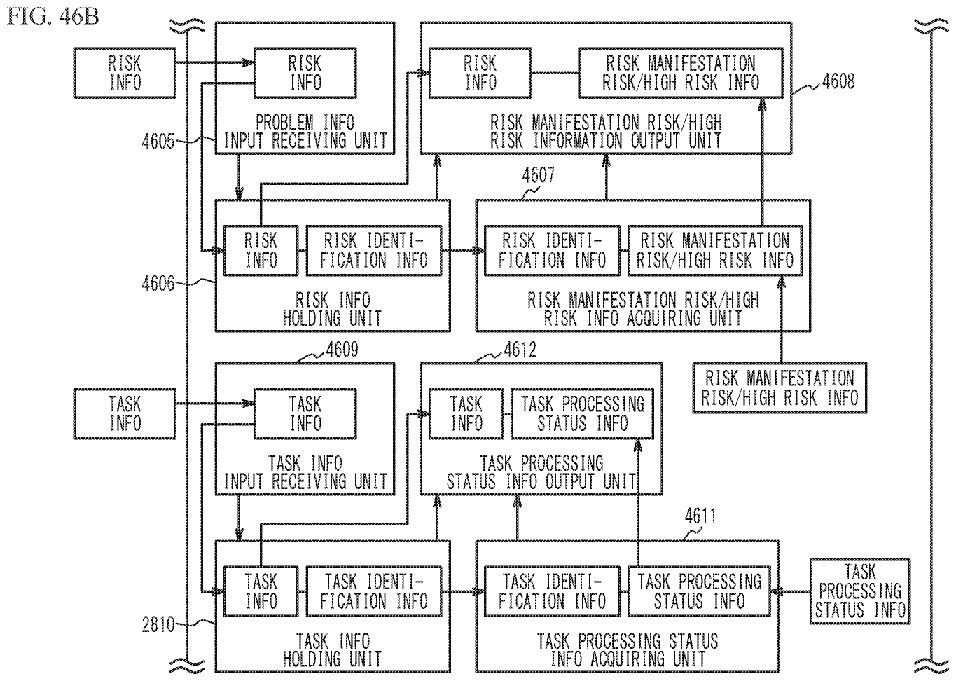

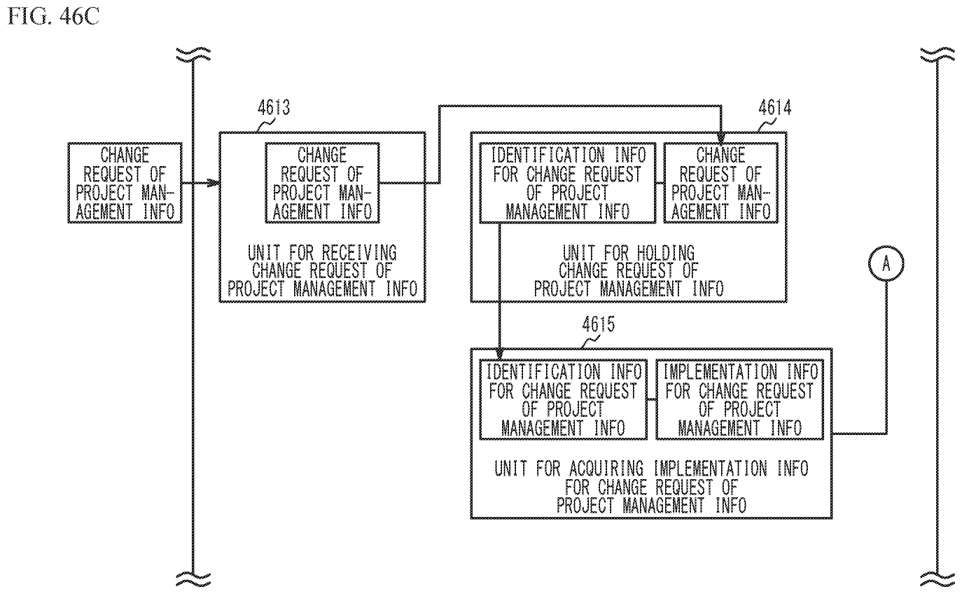

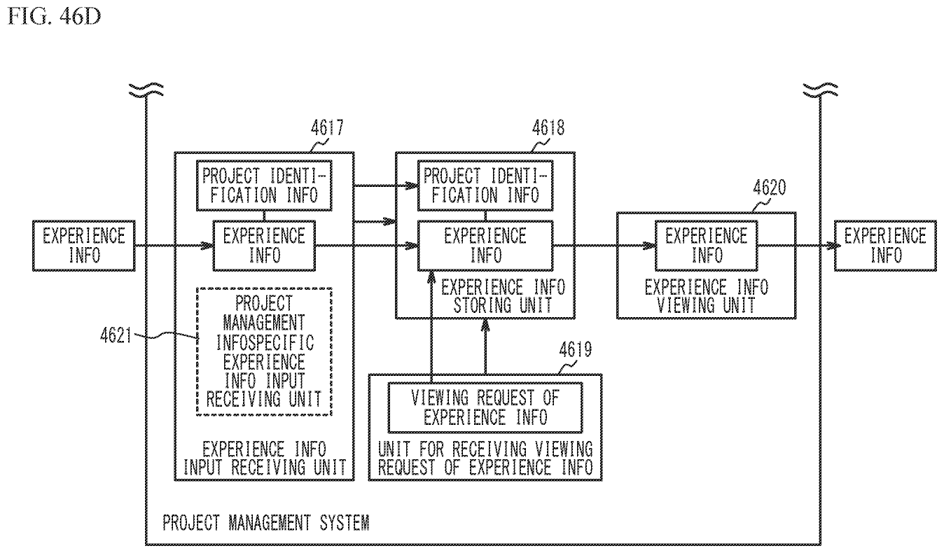

FIGS. 46A to 46D are diagrams illustrating a functional configuration of the project management system according to the sixth embodiment. The project management system according to the present embodiment includes a problem information input receiving unit (4601), a problem information holding unit (4602), a problem solution status information acquiring unit (4603), a problem solution status information output unit (4604), a risk information input receiving unit (4605), a risk information holding unit (4606), a risk manifestation risk/high risk information acquiring unit (4607), a risk manifestation risk/high risk information output unit (4608), a task information input receiving unit (4609), a task information holding unit (4610), a task processing status information acquiring unit (4611), a task processing status information output unit (4612), a unit for receiving change request of project management information (4613), a unit for holding change request of project management information (4614), a unit for acquiring implementation information for change request of project management information (4615), a project management information changing unit (4616), an experience information input receiving unit (4617), an experience information storing unit (4618), a unit for receiving viewing request of experience information (4619), and an experience information viewing unit (4620). Then, the experience information input receiving unit includes a project management information-specific experience information input receiving unit (4621). Hereinafter, the content of each function will be specifically described. Since each function except for the project management information-specific experience information input receiving unit included in the experience information input receiving unit is the same as that in the first embodiment, the explanation is limited to the function of the project management information-specific experience information input receiving unit.

The “project management information-specific experience information input receiving unit” has a function of receiving the input of the experience information in association with the project management information.

<Hardware Configuration>

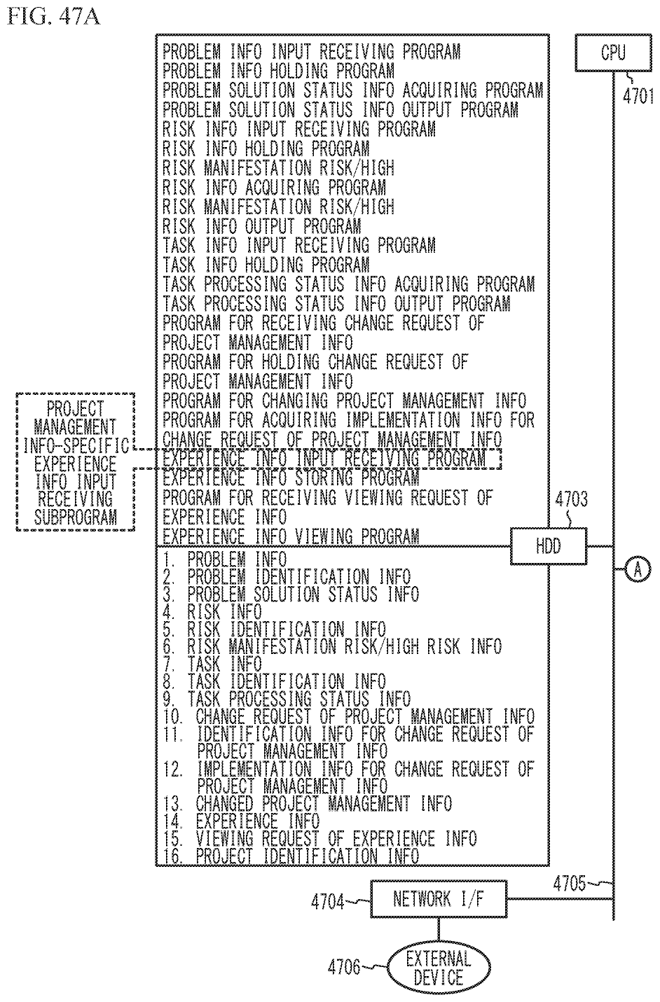

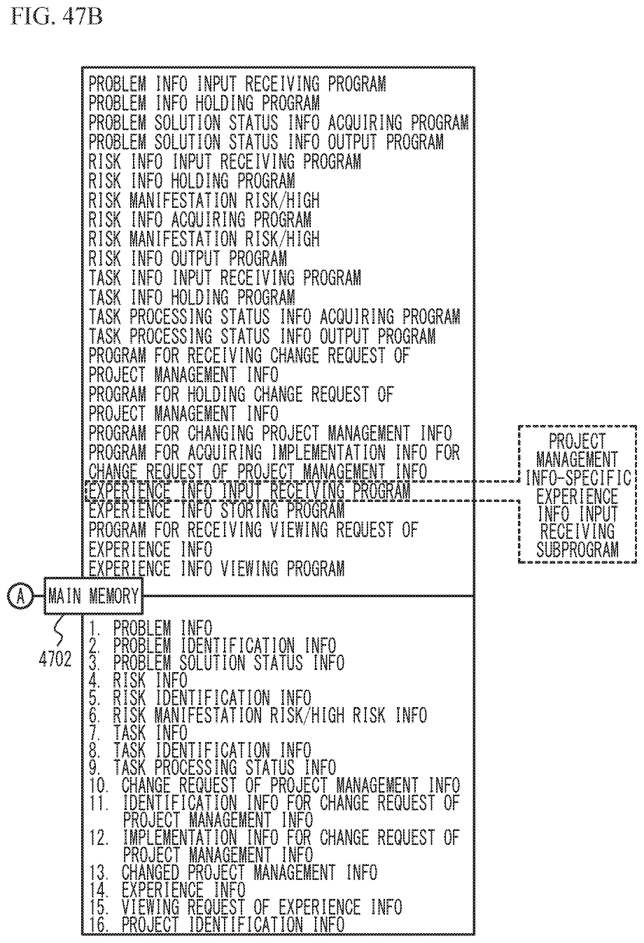

FIGS. 47A and 47B are diagrams illustrating the hardware configuration of the project management system according to the sixth embodiment. As illustrated in FIGS. 47A and 47B, the project management system according to the sixth embodiment includes a “CPU (central processing unit)” (4701) which performs various arithmetic operations, and a “main memory” (4702). Further, the project management system includes a “HDD” (4703) that holds predetermined information, and a “network I/F (interface)” (4704) that transmits and receives information to and from user terminal devices (4706) associated with a plurality of user identification information. The CPU, the main memory, the HDD and the network I/F are connected to each other by a data communication path such as a “system bus” (4705) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, and an experience information input receiving program. The experience information input receiving program includes a project management information-specific experience information input receiving subprogram.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, the experience information and the viewing request, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the experience information input receiving program stored in the main memory to receive the input of the experience information, which includes the successful experience information indicating the successful experience or/and the failure experience information indicating the failure experience, in association with the project identification information that identifies the project through the network interface. The CPU executes the experience information storing program to store the experience information that received the input, in association with the project identification information. The CPU executes the program for receiving viewing request of experience information stored in the main memory to receive the viewing request of the stored experience information. The CPU executes the experience information viewing program stored in the main memory to allow the user to view the experience information according to the received viewing request.

If necessary, the CPU executes the program for receiving change request of project management information stored in the main memory to receive the input of the change request of the project management information through the network interface. The CPU executes the program for holding change request of project management information to hold the change request of project management information in association with the identification information for change request of project management information. The CPU executes the program for acquiring implementation information for change request of project management information stored in the main memory to acquire the implementation information for change request of project management information, which is information indicating the implementation of the change request of the held project management information, in association with the identification information for change request of project management information. The CPU executes the program for changing project management information stored in the main memory to change the project management information based on the acquired implementation information for change request of project management information. Since the change request of project management information is also a type of the project management information, the experience information may be entered in association with the change request of project management information. This is because the change request of project management information is one of the most important pieces of information in project management, and the experience is invaluable.

<Flow of Processing>

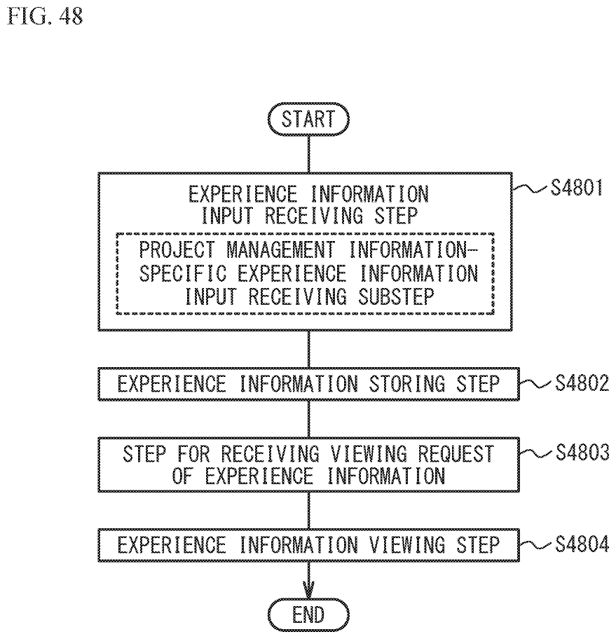

FIG. 48 is a flowchart illustrating processing when the project management system according to the sixth embodiment is used. The parts that overlap with the first embodiment are not illustrated in the figure, but it is assumed that the flow of processing in the first embodiment exists. In the sixth embodiment, there are an experience information input receiving step, an experience information storing step, a step for receiving viewing request of experience information, and an experience information viewing step, in addition to the processing of the first embodiment, in any order. The experience information input receiving step includes a project management information-specific experience information input receiving substep. Hereinafter, the project management information-specific experience information input receiving substep will be described.

The “project management information-specific experience information input receiving substep” receives the input of the experience information in association with the project management information.

<Conclusion>

As described above, it is possible to provide a project management system that can search for the experience information that the user wants to know from past projects.

### Seventh Embodiment

The seventh embodiment provides the project management system that, in addition to the features of the first embodiment, is configured to complete a reception by embedding information in a template for specifying the content of the change request.

Hereinafter, the functional configuration, the hardware configuration, and the flow of processing of the project management system according to the seventh embodiment will be described in order.

<Functional Configuration>

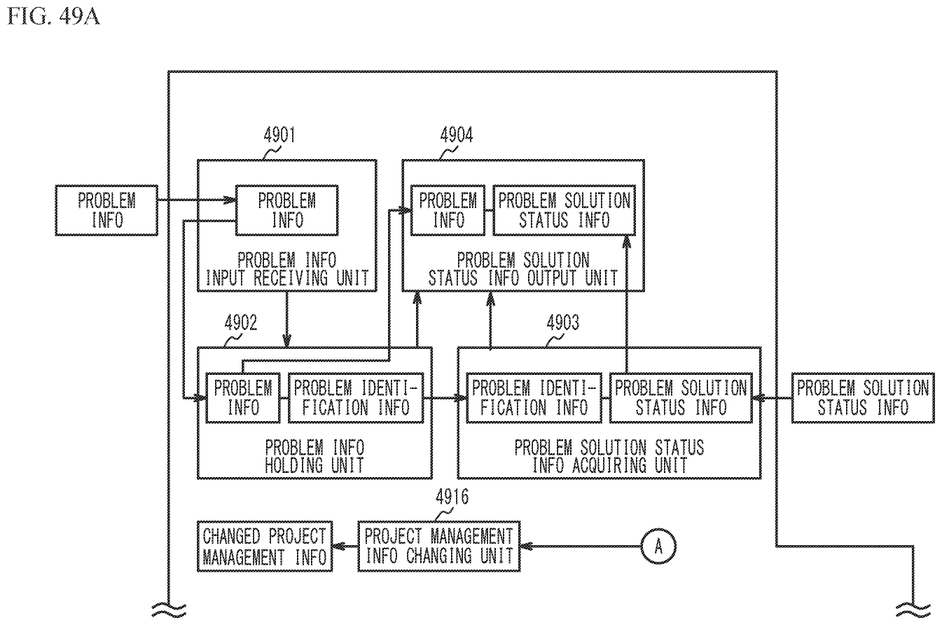

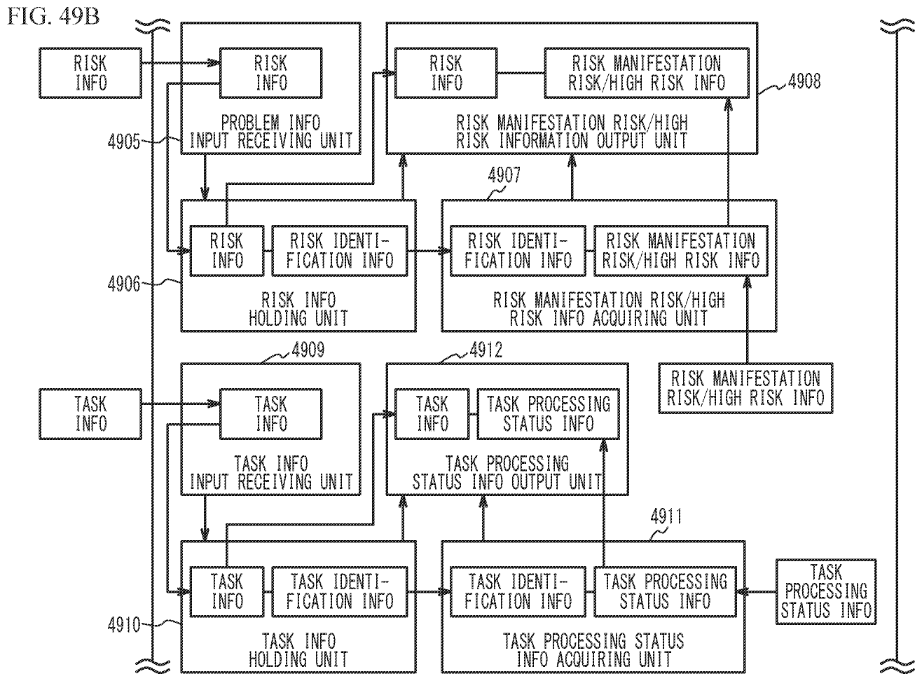

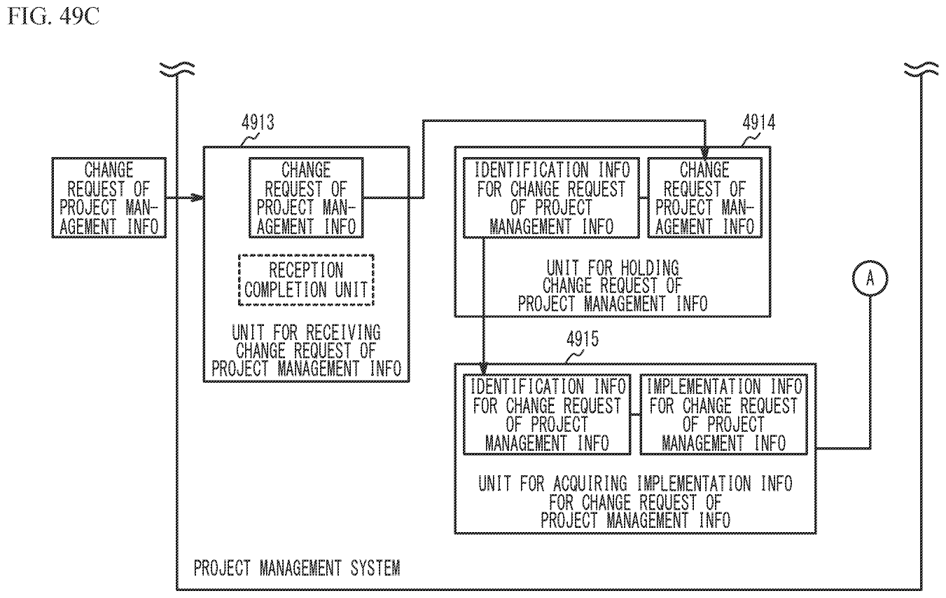

FIGS. 49A to 49C are diagrams illustrating a functional configuration of the project management system according to the seventh embodiment. The project management system according to the present embodiment includes a problem information input receiving unit (4901), a problem information holding unit (4902), a problem solution status information acquiring unit (4903), a problem solution status information output unit (4904), a risk information input receiving unit (4905), a risk information holding unit (4906), a risk manifestation risk/high risk information acquiring unit (4907), a risk manifestation risk/high risk information output unit (4908), a task information input receiving unit (4909), a task information holding unit (4910), a task processing status information acquiring unit (4911), a task processing status information output unit (4912), a unit for receiving change request of project management information (4913), a unit for holding change request of project management information (4914), a unit for acquiring implementation information for change request of project management information (4915), and a project management information changing unit (4916). The unit for receiving change request of project management information (4913) includes a reception completion unit (4917). Hereinafter, the content of each function will be specifically described. Since each function except for the reception completion unit is the same as that in the first embodiment, the explanation is limited to the function of the reception completion unit.

The “reception completion unit” include a function of completing the reception by embedding the information in the template for specifying the contents of the change request.

<Hardware Configuration>

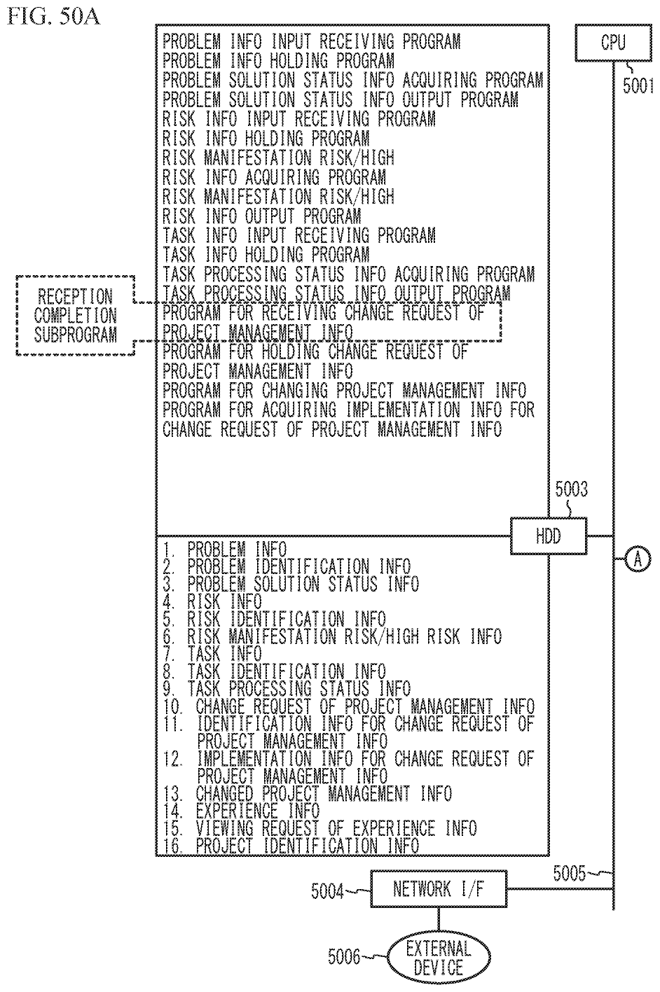

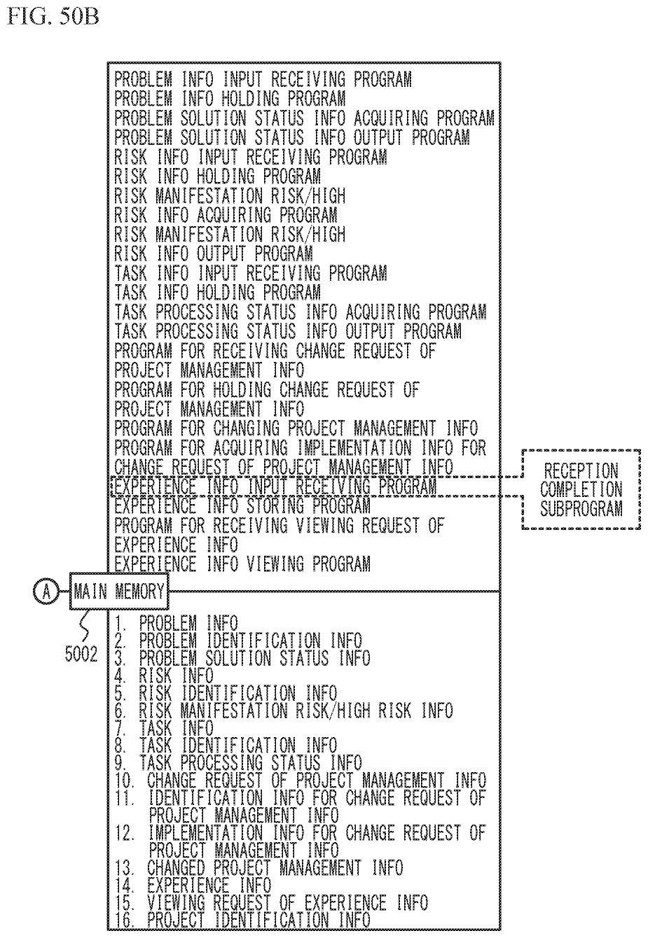

FIGS. 50A and 50B are diagrams illustrating the hardware configuration of the project management system according to the seventh embodiment. As illustrated in FIGS. 50A and 50B, the project management system according to the seventh embodiment includes a “CPU (central processing unit)” (5001) which performs various arithmetic operations, and a “main memory” (5002). Further, the project management system includes a “HDD” (5003) that holds predetermined information, and a “network I/F (interface)” (5004) that transmits and receives information to and from user terminal devices (5006) associated with a plurality of user identification information. The CPU, the main memory, the HDD and the network I/F are connected to each other by a data communication path such as a “system bus” (5005) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, and the program for changing project management information. The program for receiving change request of project management information includes a reception completion subprogram.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. Receiving the content of the change request of the project management information is completed by embedding the information in the template to identify the content of the change request. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

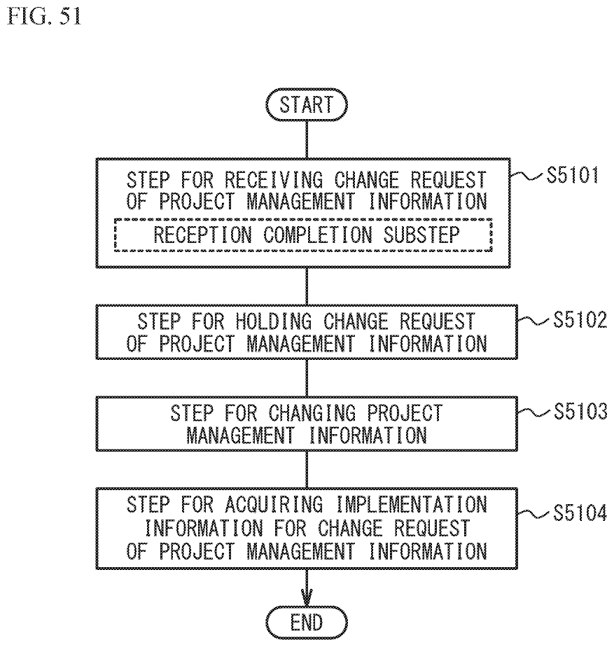

FIG. 51 is a flowchart illustrating processing when the project management system according to the seventh embodiment is used. The parts that overlap with the first embodiment are not illustrated in the figure, but it is assumed that the flow of processing in the first embodiment exists. In the seventh embodiment, the flow of the processing for changing the project management information includes a step for receiving change request of project management information (S5101), a step for holding change request of project management information (S5102), a step for acquiring implementation information for change request of project management information (S5103), a step for changing project management information (S5104). In addition to the above, the step for receiving change request of project management information (S5101) includes a reception completion substep. Hereinafter, the reception completion substep will be described.

The “reception completion substep” completes the reception by embedding the information in the template for specifying the contents of the change request.

<Conclusion>

As described above, it is possible to provide a project management system that can prevent leakage of the content of the change request.

### Eighth Embodiment

The eighth embodiment provides the project management system that, in addition to the features of the first embodiment, is configured to generate the implementation information for change request of project management information, which is information to implement the change of the project management information, by embedding information in a template for specifying the information necessary to implement the change request.

Hereinafter, the functional configuration, the hardware configuration, and the flow of processing of the project management system according to the eighth embodiment will be described in order.

<Functional Configuration>

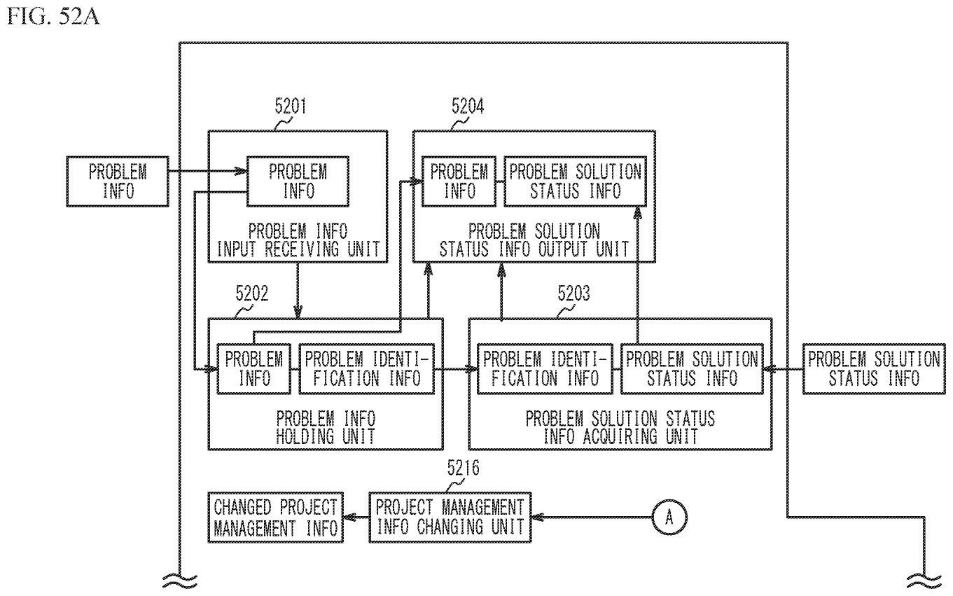

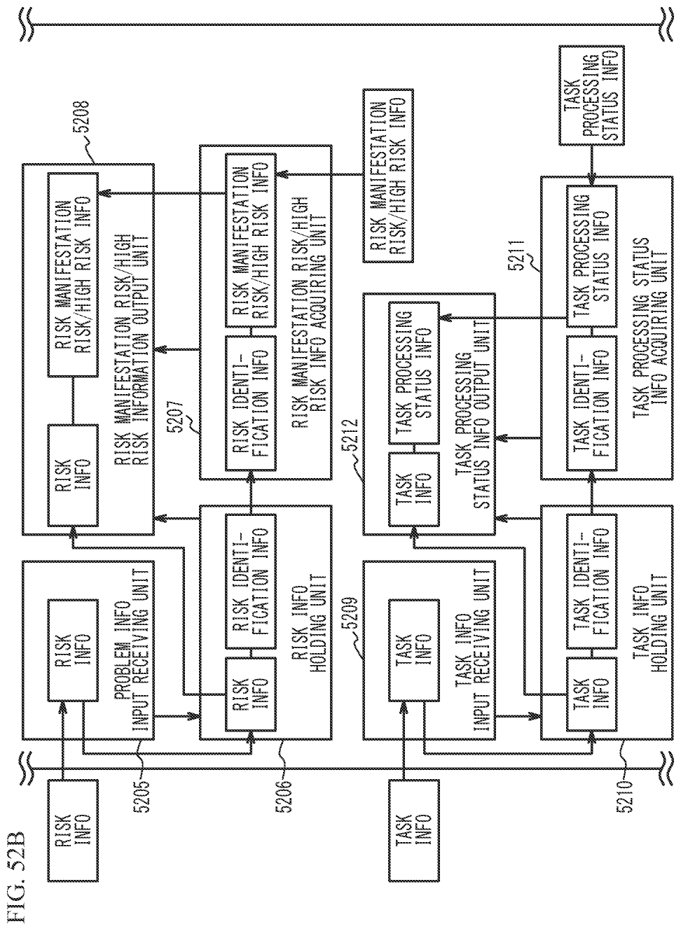

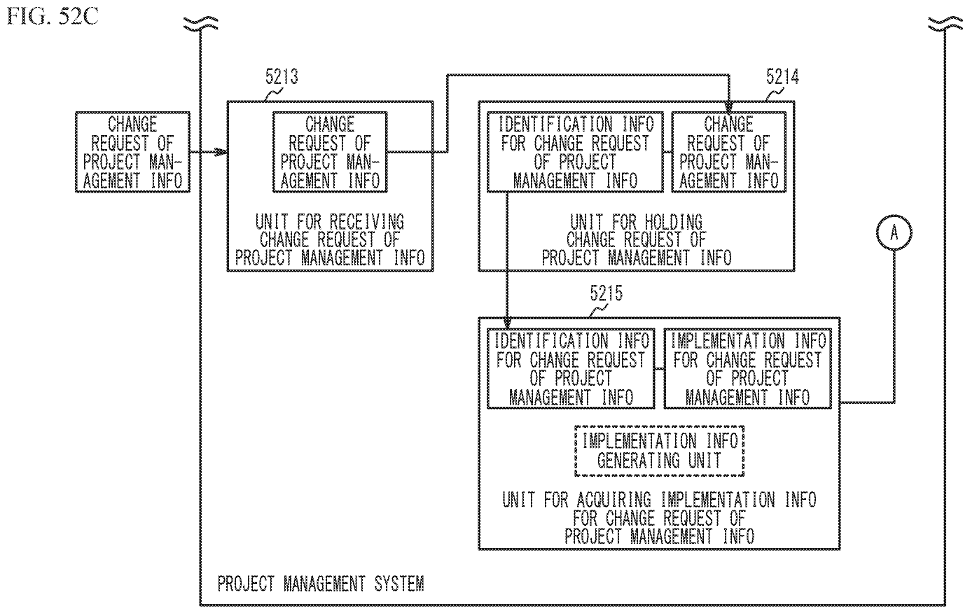

FIGS. 52A to 52C are diagrams illustrating a functional configuration of the project management system according to the eighth embodiment. The project management system according to the present embodiment includes a problem information input receiving unit (5201), a problem information holding unit (5202), a problem solution status information acquiring unit (5203), a problem solution status information output unit (5204), a risk information input receiving unit (5205), a risk information holding unit (5206), a risk manifestation risk/high risk information acquiring unit (5207), a risk manifestation risk/high risk information output unit (5208), a task information input receiving unit (5209), a task information holding unit (5210), a task processing status information acquiring unit (5211), a task processing status information output unit (5212), a unit for receiving change request of project management information (5213), a unit for holding change request of project management information (5214), a unit for acquiring implementation information for change request of project management information (5215), and a project management information changing unit (5216). The unit for acquiring implementation information for change request of project management information (5215) includes an implementation information generating unit (5217). Hereinafter, the content of each function will be specifically described. Since each function except for the implementation information generating unit is the same as that in the first embodiment, the explanation is limited to the function of the implementation information generating unit.

The “implementation information generating unit” include a function of generating the implementation information for change request of project management information, which is information to implement the change of the project management information, by embedding information in a template for specifying the information necessary to implement the change request.

<Hardware Configuration>

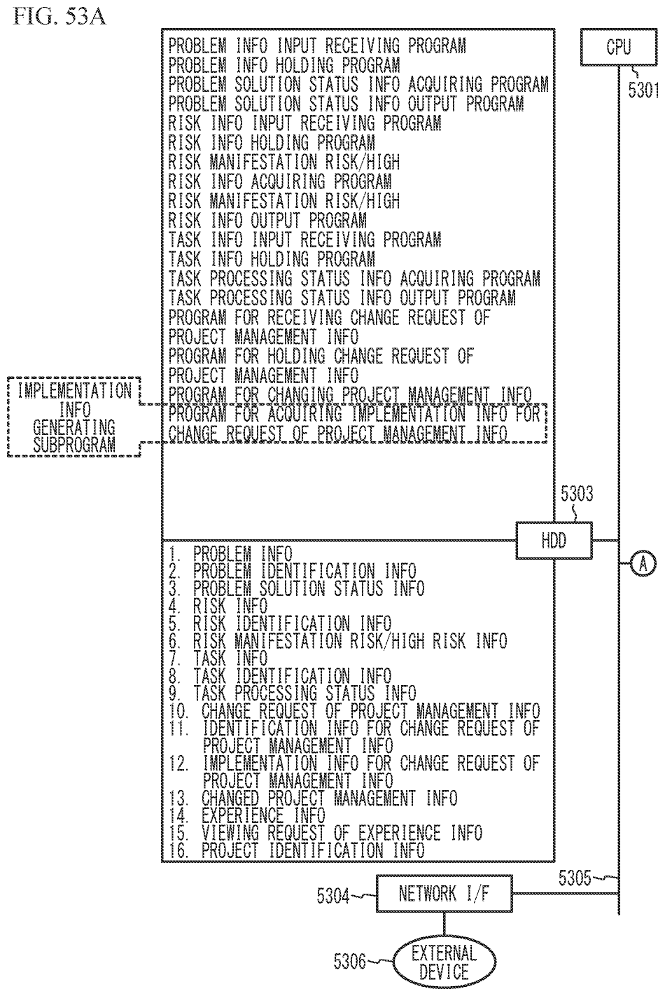

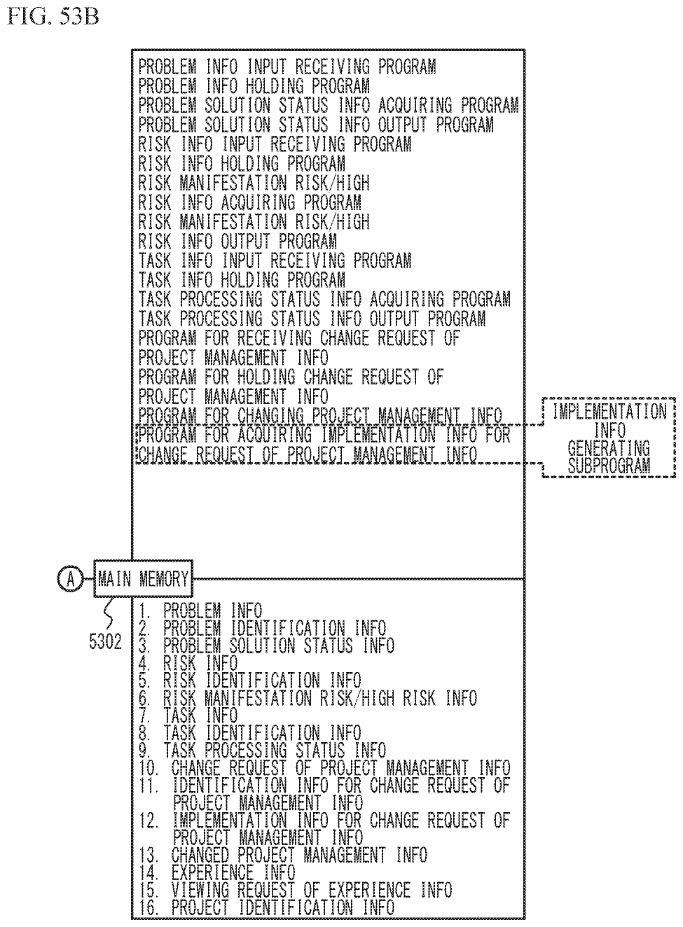

FIGS. 53A and 53B are diagrams illustrating the hardware configuration of the project management system according to the eighth embodiment. As illustrated in FIGS. 53A and 53B, the project management system according to the eighth embodiment includes a “CPU (central processing unit)” (5301) which performs various arithmetic operations, and a “main memory” (5302). Further, the project management system includes a “HDD” (5303) that holds predetermined information, and a “network I/F (interface)” (5304) that transmits and receives information to and from user terminal devices (5306) associated with a plurality of user identification information. The CPU, the main memory, the HDD and the network I/F are connected to each other by a data communication path such as a “system bus” (5305) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, and the program for changing project management information. The program for acquiring implementation information for change request of project management information includes an implementation information generating subprogram.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. Here, the change of the project management information is implemented by embedding the information in the template for specifying the information necessary to implement the change request. The CPU executes the program for changing project management information stored in the main memory to change the project management information based on the acquired implementation information for the change request of the project management information.

<Flow of Processing>

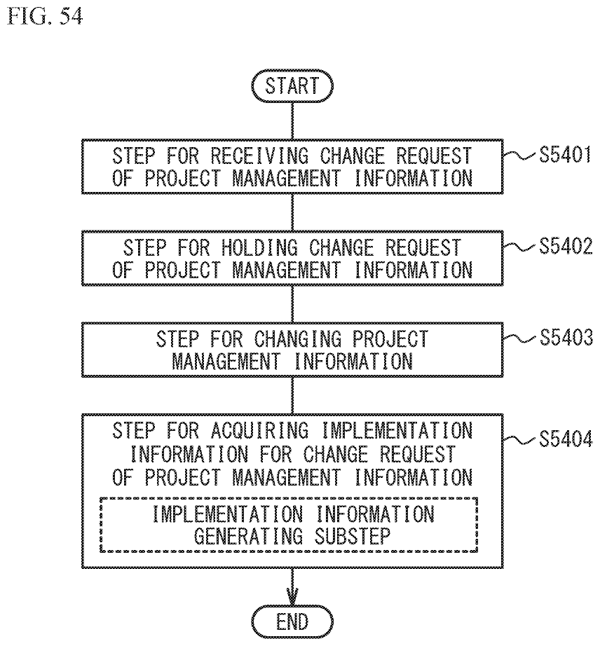

FIG. 54 is a flowchart illustrating processing when the project management system according to the eighth embodiment is used. The parts that overlap with the first embodiment are not illustrated in the figure, but it is assumed that the flow of processing in the first embodiment exists. In the eighth embodiment, the flow of the processing for changing the project management information includes a step for receiving change request of project management information (S5401), a step for holding change request of project management information (S5402), a step for acquiring implementation information for change request of project management information (S5403), a step for changing project management information (S5404). In addition to the above, the step for changing project management information (S5404) includes an implementation information generating substep. Hereinafter, the implementation information generating substep will be described.

The “implementation information generating substep” generates the implementation information for change request of project management information, which is information to implement the change of the project management information, by embedding information in a template for specifying the information necessary to implement the change request.

<Conclusion>

As described above, it is possible to provide a project management system that allows even an inexperienced person to consider and input data to be considered without leakage, although the degree of freedom is reduced by guiding the content of the change request to some extent.

### Ninth Embodiment

The ninth embodiment provides the project management system that, in addition to the features of the first embodiment, is configured to receive an input of the risk information according to a risk navigation template that prompts input of information to be clarified in order to objectify the risk.

Hereinafter, the functional configuration, the hardware configuration, and the flow of processing of the project management system according to the ninth embodiment will be described in order.

<Functional Configuration>

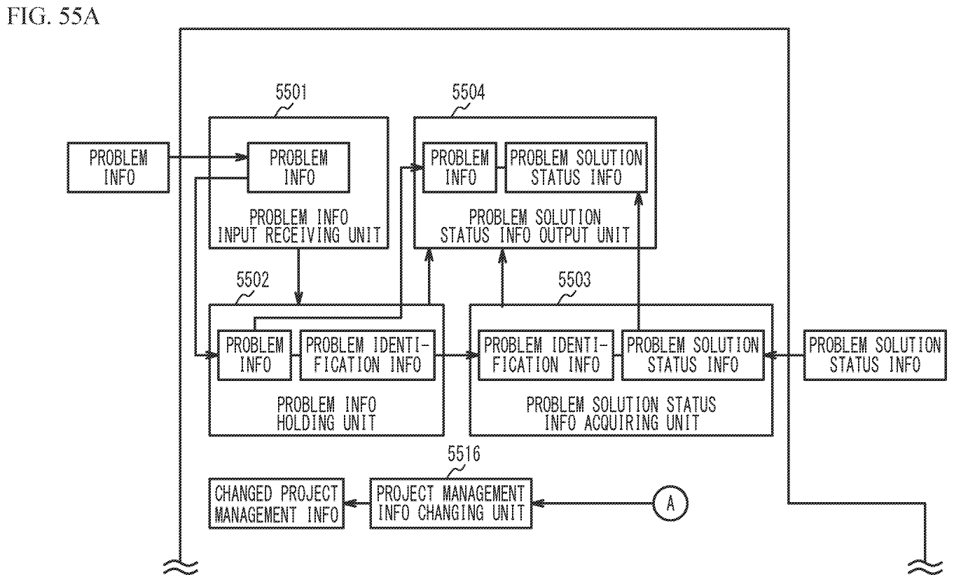

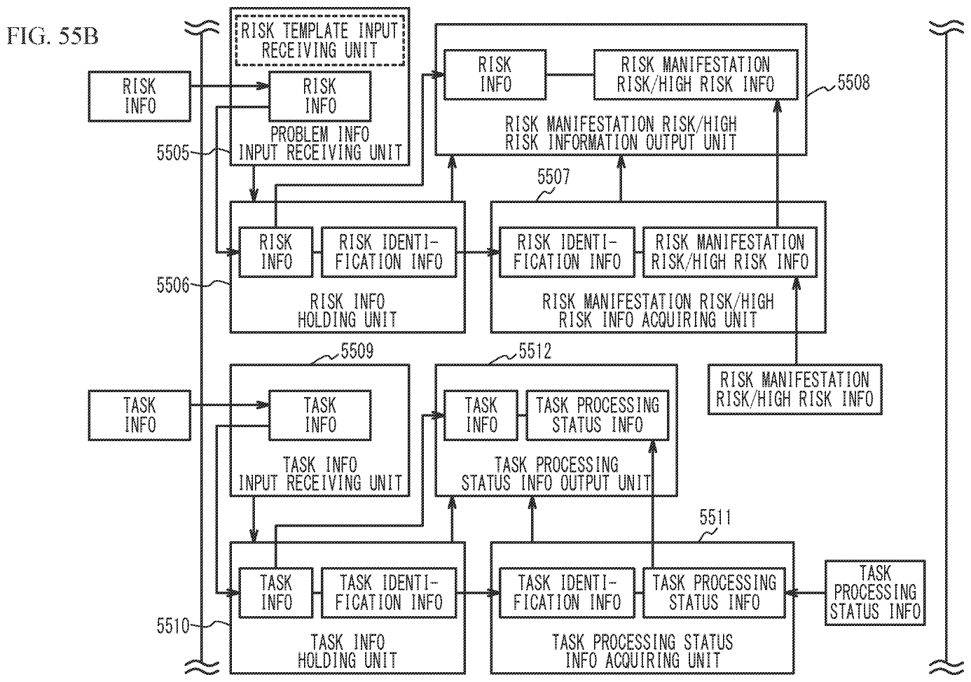

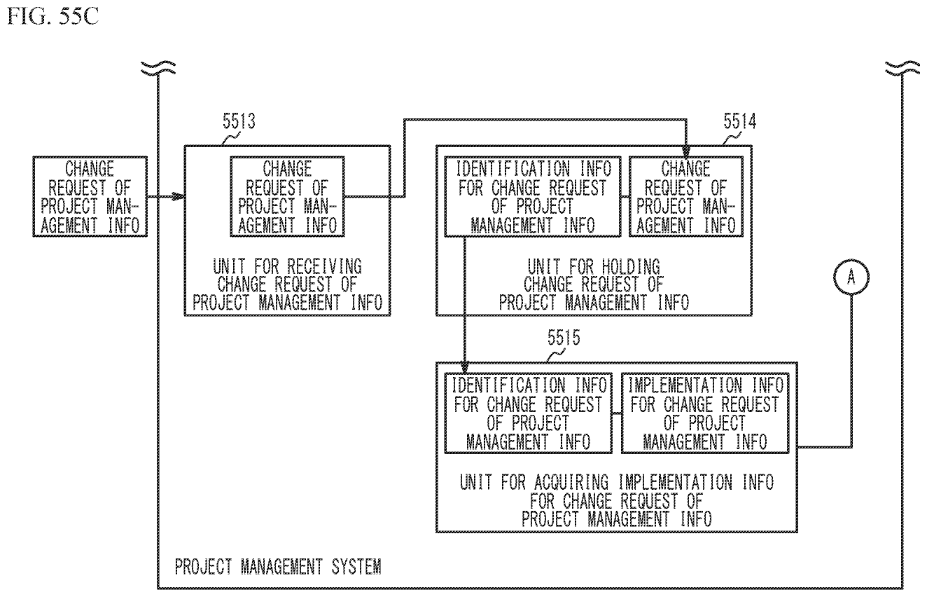

FIGS. 55A to 55C are diagrams illustrating a functional configuration of the project management system according to the ninth embodiment. The project management system according to the present embodiment includes a problem information input receiving unit (5501), a problem information holding unit (5502), a problem solution status information acquiring unit (5503), a problem solution status information output unit (5504), a risk information input receiving unit (5505), a risk information holding unit (5506), a risk manifestation risk/high risk information acquiring unit (5507), a risk manifestation risk/high risk information output unit (5508), a task information input receiving unit (5509), a task information holding unit (5510), a task processing status information acquiring unit (5511), a task processing status information output unit (5512), a unit for receiving change request of project management information (5513), a unit for holding change request of project management information (5514), a unit for acquiring implementation information for change request of project management information (5515), and a project management information changing unit (5516). The risk information input receiving unit (5505) includes a risk template input receiving unit (5517). Hereinafter, the content of each function will be specifically described. Since each function except for the risk template input receiving unit is the same as that in the first embodiment, the explanation is limited to the function of the risk template input receiving unit.

The “risk template input receiving unit” has a function of receiving the input of the risk information according to the risk navigation template that prompts input of information to be clarified in order to objectify the risk. It is preferable to configure the system so that the input of the risk information is not completed when even one input is not made in the template. In addition, the risk template may be configured to have a guide information button and guide the user who has difficulty in understanding the content to be input to what the input field should be described. In addition, the input field should be configured to illustrate an example of input by providing an example button to illustrate an example of input. In addition, the system can be configured to allow the artificial intelligence to learn from the various project management information, the progress status of the project, the completion result of the project and other past cases, and to complete the entry of the risk information by defaulting the risk information to the risk template and allowing the user to edit it.

<Hardware Configuration>

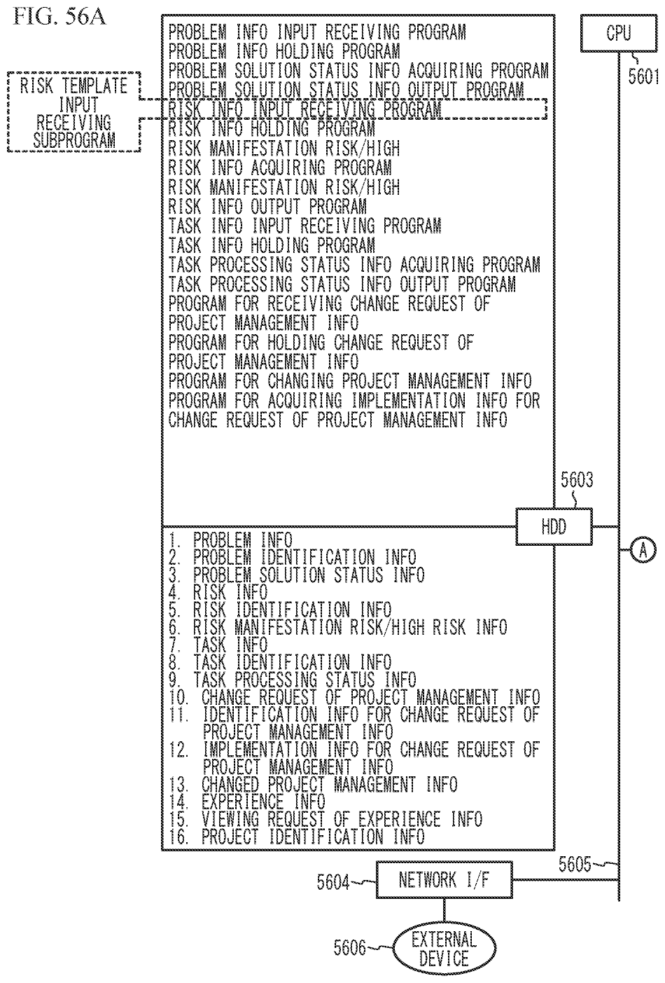

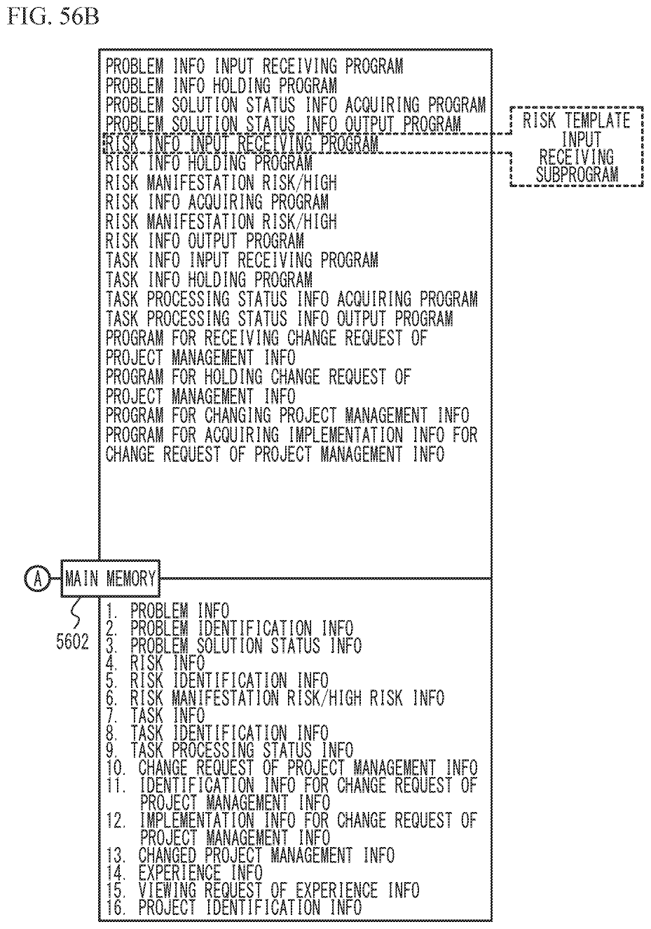

FIGS. 56A and 56B are diagrams illustrating the hardware configuration of the project management system according to the ninth embodiment. As illustrated in FIGS. 56A and 56B, the project management system according to the ninth embodiment includes a “CPU (central processing unit)” (5601) which performs various arithmetic operations, and a “main memory” (5602). Further, the project management system includes a “HDD” (5603) that holds predetermined information, and a “network I/F (interface)” (5604) that transmits and receives information to and from user terminal devices (5606) associated with a plurality of user identification information. The CPU, the main memory, the HDD and the network I/F are connected to each other by a data communication path such as a “system bus” (5605) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, and the program for changing project management information. The risk information input receiving program includes a risk template input receiving subprogram.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. Here, the input of the risk information is received according to the risk navigation template that prompts input of information to be clarified in order to objectify the risk. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

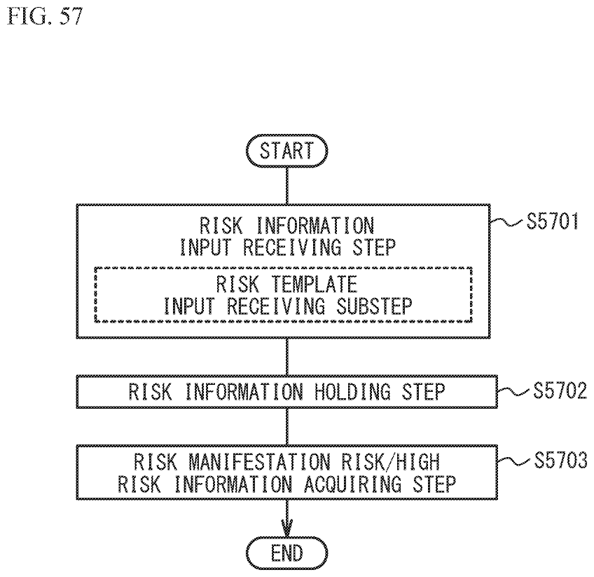

FIG. 57 is a flowchart illustrating processing when the project management system according to the ninth embodiment is used. The parts that overlap with the first embodiment are not illustrated in the figure, but it is assumed that the flow of processing in the first embodiment exists. In the ninth embodiment, the flow of the processing for changing the project management information includes a risk information input receiving step (S5701), a risk information holding step (S5702), and a risk manifestation risk/high risk information acquiring step (S5703). In addition to the above, the risk information input receiving step (S5701) includes a risk template input receiving substep. Hereinafter, the risk template input receiving substep will be described.

The “risk template input receiving substep” receives input of the risk information according to the risk navigation template that prompts input of information to be clarified in order to objectify the risk.

<Conclusion>

As described above, it is possible to provide a project management system that allows even an inexperienced person to consider what to be considered without leakage and input the risk information, although the degree of freedom is reduced by guiding risk-related considerations to some extent.

### Tenth Embodiment

The tenth embodiment provides the project management system that, in addition to the features of the first embodiment, is configured to receive an input of the risk information according to a risk quantification navigation template that prompts an input of information for quantifying a risk.

Hereinafter, the functional configuration, the hardware configuration, and the flow of processing of the project management system according to the tenth embodiment will be described in order.

<Functional Configuration>

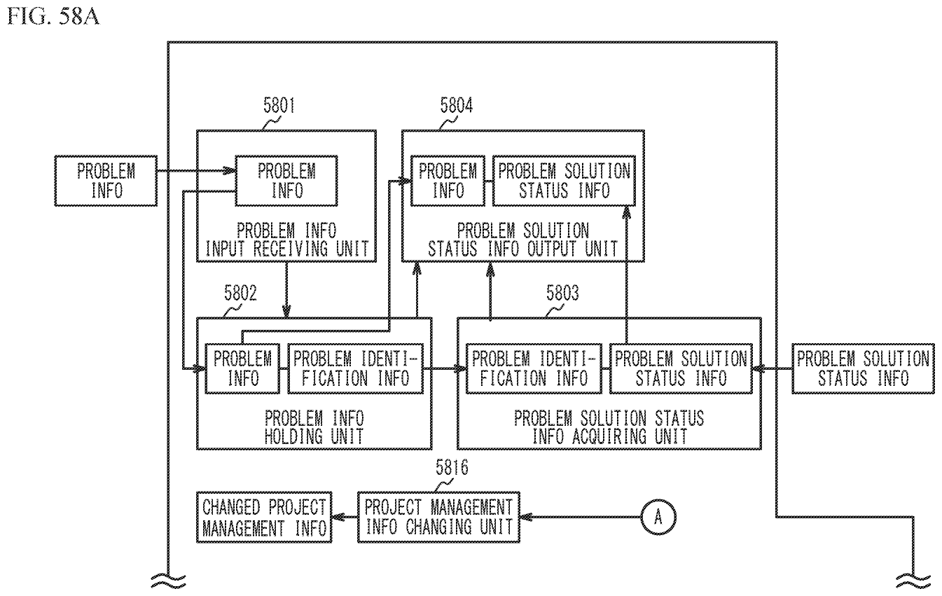

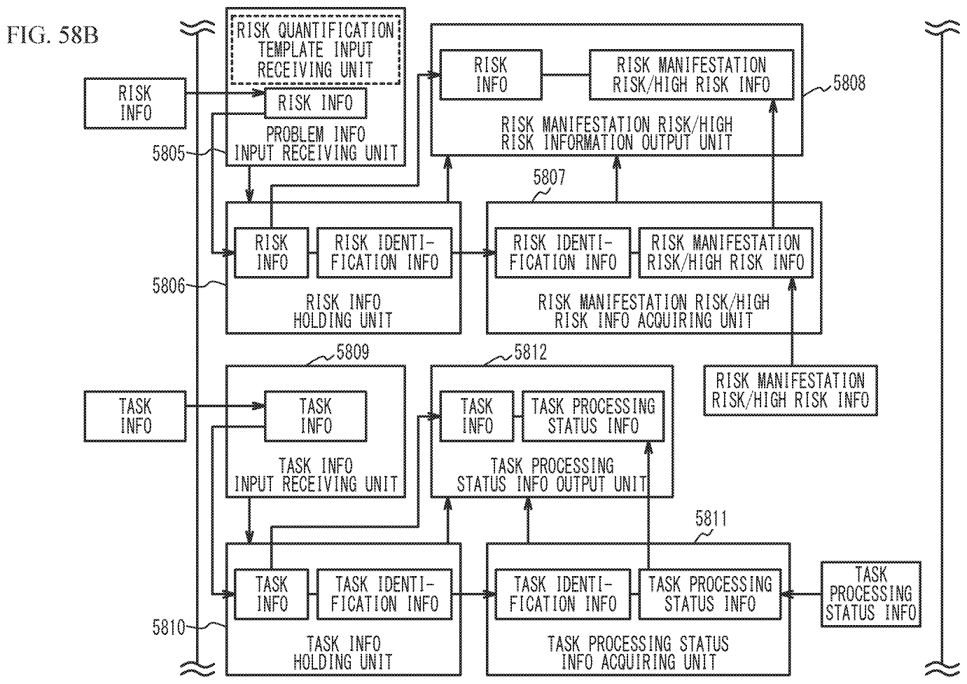

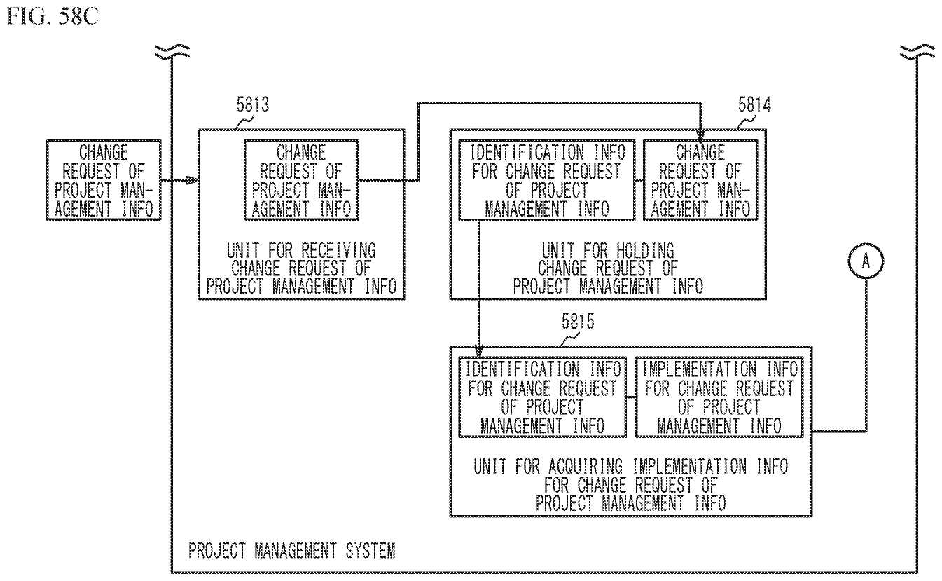

FIGS. 58A to 58C are diagrams illustrating a functional configuration of the project management system according to the tenth embodiment. The project management system according to the present embodiment includes a problem information input receiving unit (5801), a problem information holding unit (5802), a problem solution status information acquiring unit (5803), a problem solution status information output unit (5804), a risk information input receiving unit (5805), a risk information holding unit (5806), a risk manifestation risk/high risk information acquiring unit (5807), a risk manifestation risk/high risk information output unit (5808), a task information input receiving unit (5809), a task information holding unit (5810), a task processing status information acquiring unit (5811), a task processing status information output unit (5812), a unit for receiving change request of project management information (5813), a unit for holding change request of project management information (5814), a unit for acquiring implementation information for change request of project management information (5815), and a project management information changing unit (5816). The risk information input receiving unit (5805) includes a risk quantification template input receiving unit (5817). Hereinafter, the content of each function will be specifically described. Since each function except for the risk quantification template input receiving unit is the same as that in the first embodiment, the explanation is limited to the function of the risk quantification template input receiving unit.

The “risk quantification template input receiving unit” has a function of receiving an input of the risk information according to the risk quantification navigation template that prompts the input of information for quantifying the risk.

<Hardware Configuration>

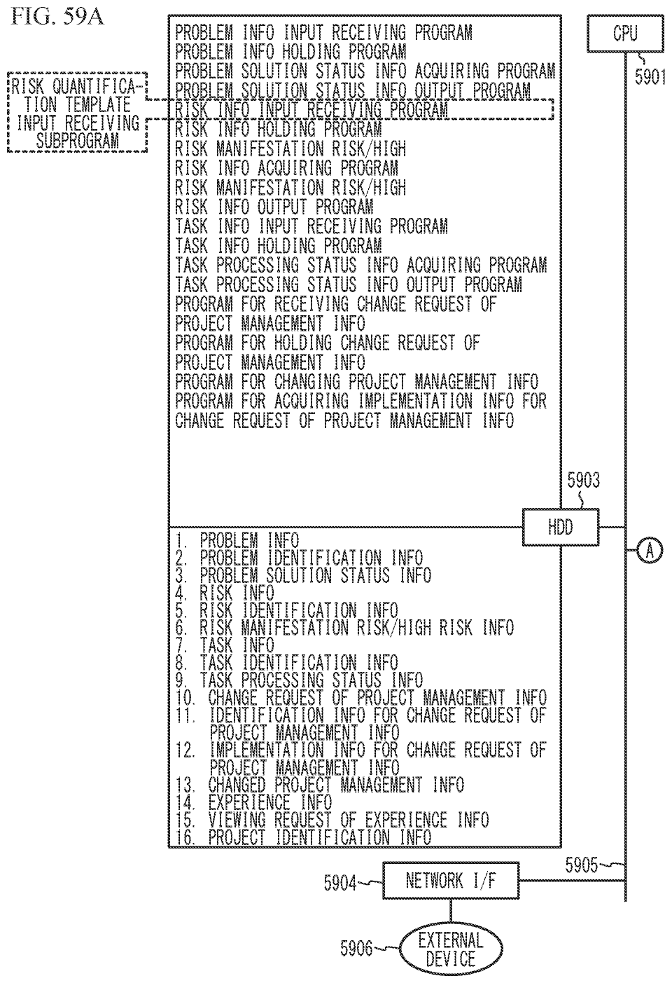

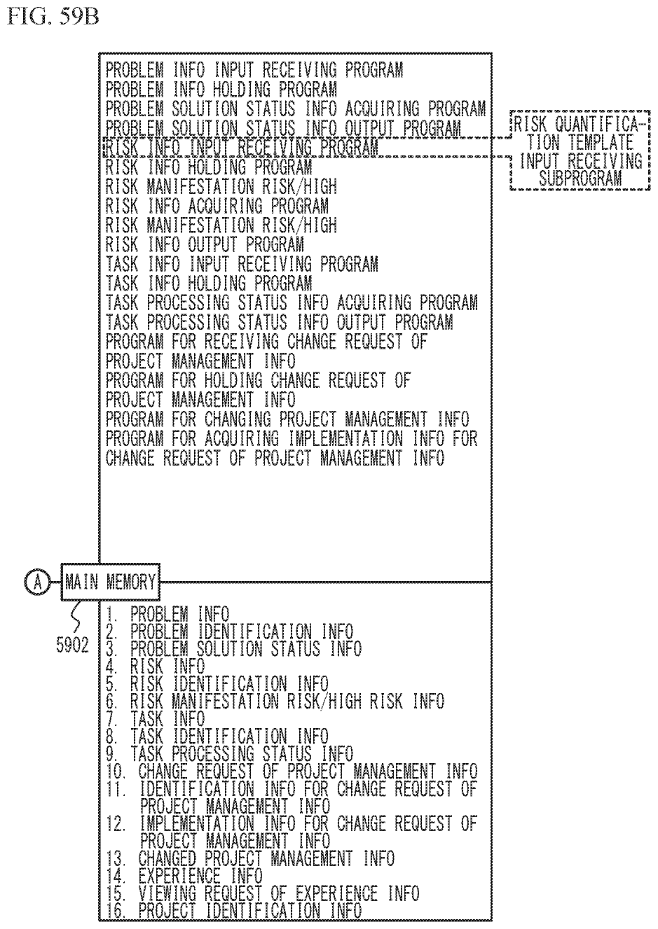

FIGS. 59A and 59B are diagrams illustrating the hardware configuration of the project management system according to the tenth embodiment. As illustrated in FIGS. 59A and 59B, the project management system according to the tenth embodiment includes a “CPU (central processing unit)” (5901) which performs various arithmetic operations, and a “main memory” (5902). Further, the project management system includes a “HDD” (5903) that holds predetermined information, and a “network I/F (interface)” (5904) that transmits and receives information to and from user terminal devices (5906) associated with a plurality of user identification information. The CPU, the main memory, the HDD and the network I/F are connected to each other by a data communication path such as a “system bus” (5905) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, and the program for changing project management information. The risk information input receiving program includes a risk quantification template input receiving subprogram.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. Here, the input of the risk information is received according to the risk quantification navigation template that prompts the input of information for quantifying the risk. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

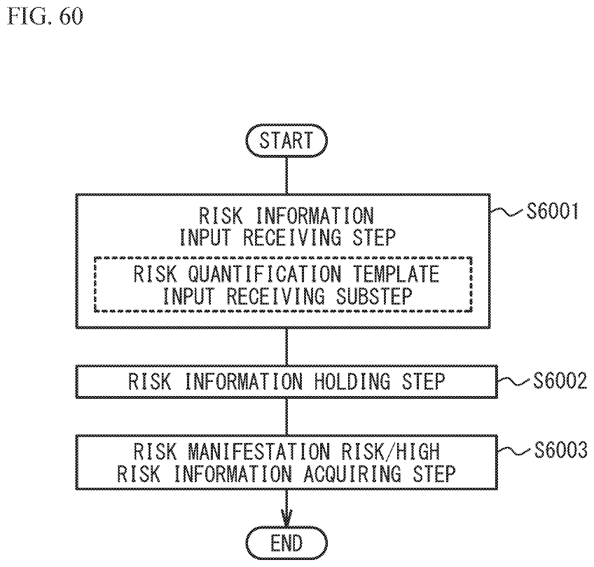

FIG. 60 is a flowchart illustrating processing when the project management system according to the tenth embodiment is used. The parts that overlap with the first embodiment are not illustrated in the figure, but it is assumed that the flow of processing in the first embodiment exists. In the tenth embodiment, the flow of the processing for changing the project management information includes a risk information input receiving step (S6001), a risk information holding step (S6002), and a risk manifestation risk/high risk information acquiring step (S6003). In addition to the above, the risk information input receiving step (S6001) includes a risk quantification template input receiving substep. Hereinafter, the risk template input receiving substep will be described.

The “risk template input receiving substep” receives input of the risk information according to the risk quantification navigation template that prompts the input of information for quantifying the risk.

### Eleventh Embodiment

The eleventh embodiment provides the project management system that, in addition to the features of the first embodiment, is configured to map the held risk information.

Hereinafter, the functional configuration, the hardware configuration, and the flow of processing of the project management system according to the eleventh embodiment will be described in order.

<Functional Configuration>

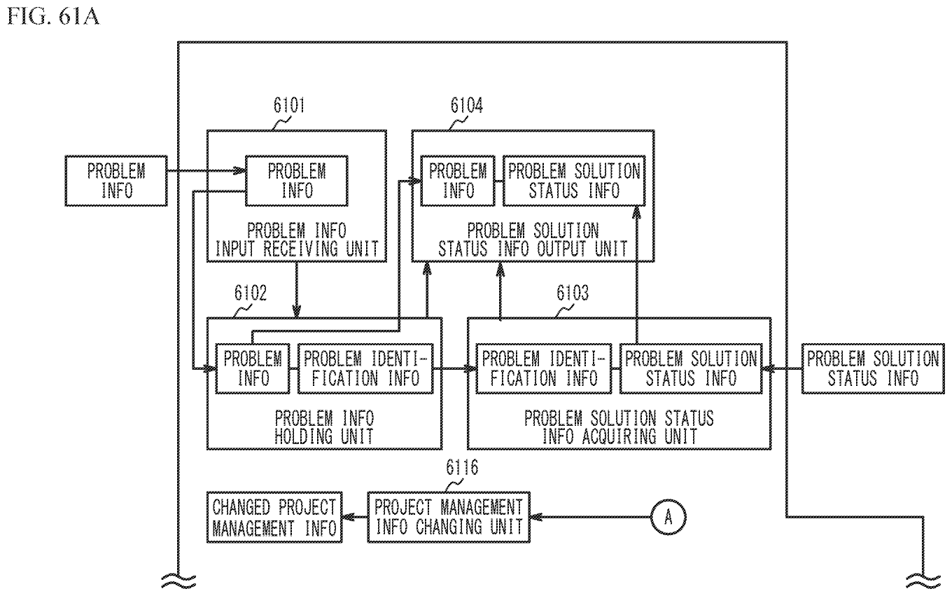

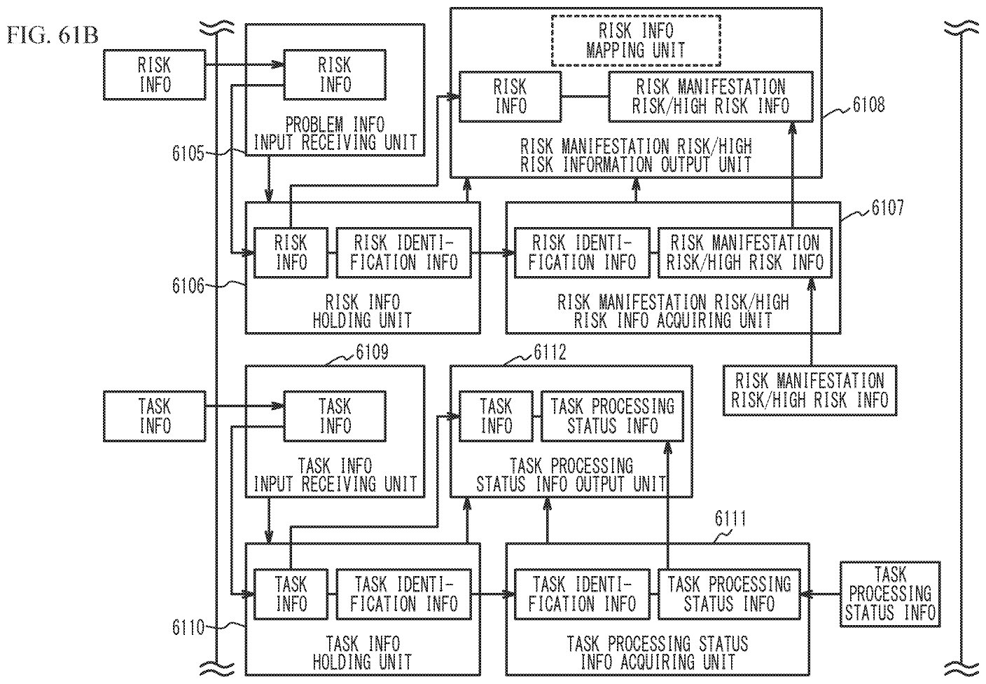

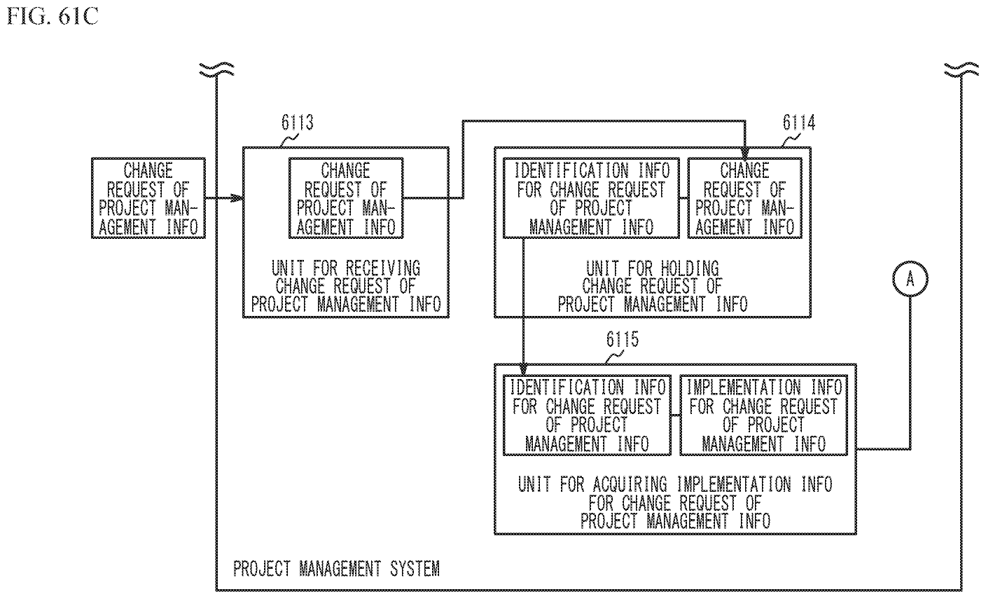

FIGS. 61A to 61C are diagrams illustrating a functional configuration of the project management system according to the eleventh embodiment. The project management system according to the present embodiment includes a problem information input receiving unit (6101), a problem information holding unit (6102), a problem solution status information acquiring unit (6103), a problem solution status information output unit (6104), a risk information input receiving unit (6105), a risk information holding unit (6106), a risk manifestation risk/high risk information acquiring unit (6107), a risk manifestation risk/high risk information output unit (6108), a task information input receiving unit (6109), a task information holding unit (6110), a task processing status information acquiring unit (6111), a task processing status information output unit (6112), a unit for receiving change request of project management information (6113), a unit for holding change request of project management information (6114), a unit for acquiring implementation information for change request of project management information (6115), and a project management information changing unit (6116). The risk manifestation risk/high risk information output unit (6108) includes a risk information mapping unit (6117). Hereinafter, the content of each function will be specifically described. Since each function except for the risk information mapping unit is the same as that in the first embodiment, the explanation is limited to the function of the risk information mapping unit.

The “risk information mapping unit” has a function of mapping the held risk information.

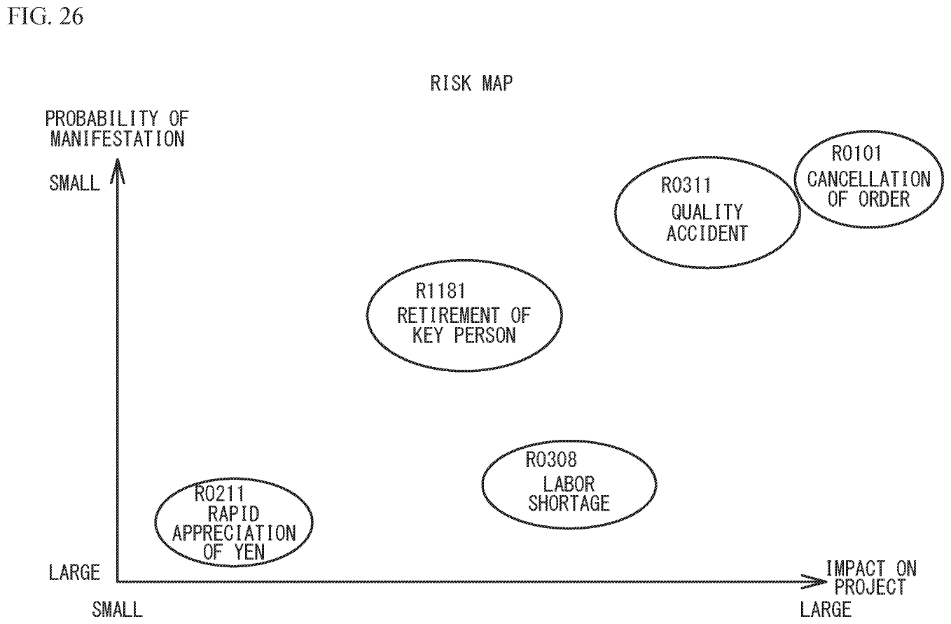

FIG. 26 is a diagram illustrating an example of mapped risk information (risk map). As illustrated in FIG. 26, a degree of the impact on the project and the possibility of the manifestation are illustrated as basic axes. The positional relationship between large and small of the risk information is not limited to examples in FIG. 26. In the case of the examples in FIG. 26, the rapid appreciation of the yen (R0211) has a high probability of the manifestation, but it has a small impact on the project. Labor shortage (R0308) has a relatively high probability of the manifestation, but it also has a relatively large impact on the project. The retirement of a key person (R1181) has a moderate probability of manifestation and a moderate impact on the project. Each of the quality accident (R0311) and the cancellation of the order (R0101) has a low probability of the manifestation, but has a large impact on the project. In this way, although the degree of the impact on the project and the possibility of the manifestation have to be expressed as “large” or “small” in words, the positioning of each risk can be imagined concretely by making a map.

<Hardware Configuration>

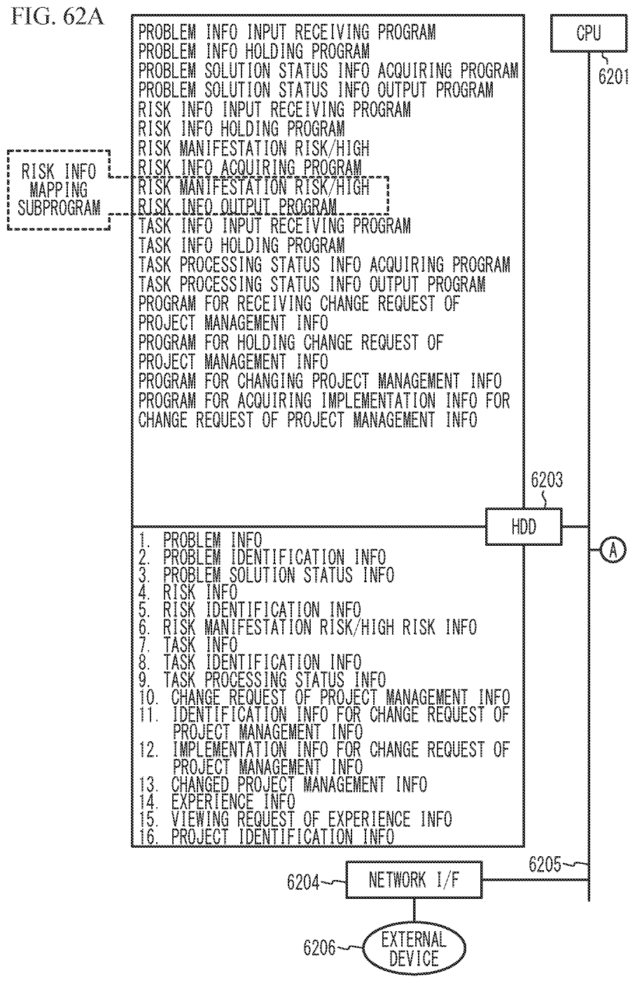

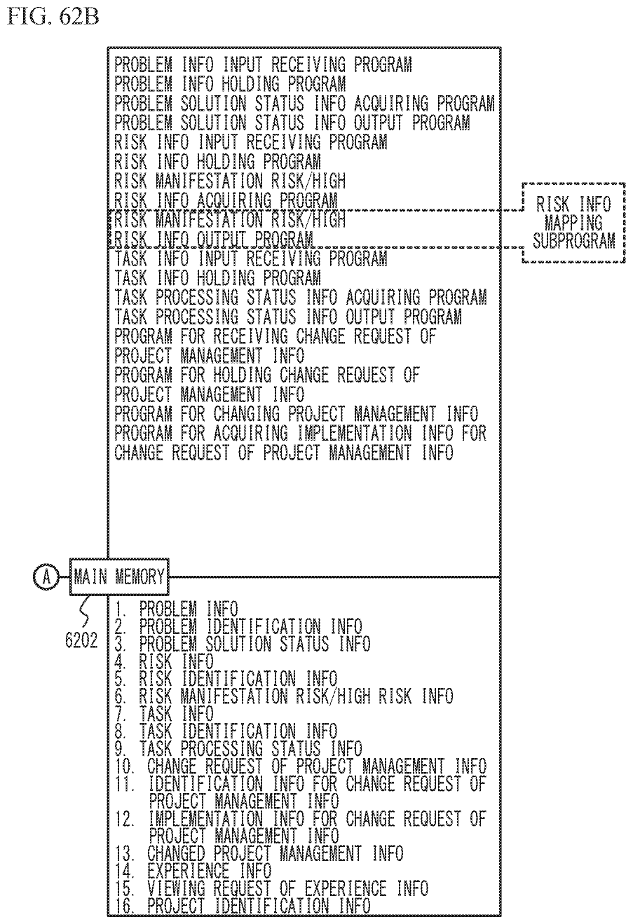

FIGS. 62A and 62B are diagram illustrating the hardware configuration of the project management system according to the eleventh embodiment. As illustrated in FIGS. 62A and 62B, the project management system according to the eleventh embodiment includes a “CPU (central processing unit)” (6201) which performs various arithmetic operations, and a “main memory” (6202). Further, the project management system includes a “HDD” (6203) that holds predetermined information, and a “network IN (interface)” (6204) that transmits and receives information to and from user terminal devices (6206) associated with a plurality of user identification information. The CPU, the main memory, the HDD and the network I/F are connected to each other by a data communication path such as a “system bus” (6205) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, and the program for changing project management information. The risk manifestation risk/high risk information output program includes a risk information mapping subprogram.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result. Here, the held risk information is output in a mapped state.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

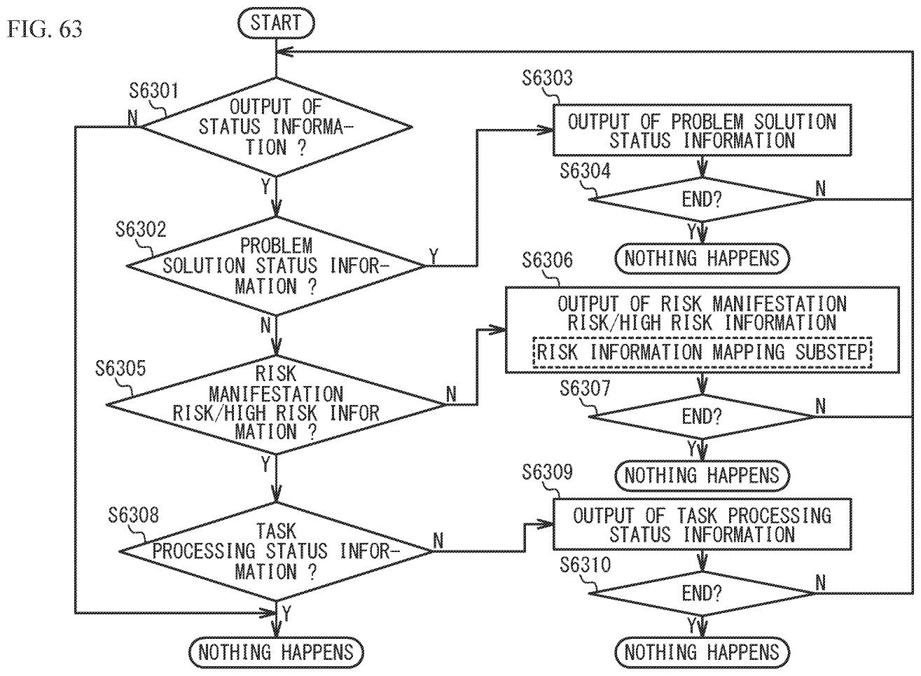

FIG. 63 is a flowchart illustrating processing (limited to points related to output) when the project management system in the present embodiment is used. The output of each piece of information can be in any order. First, the CPU determines whether to output the status information (here, the status information includes, but not limited to, information indicating the progress of the problem information, the risk information, and the task information) (S6301). When the determination of S6301 is YES, the CPU determines whether to output the problem solution status information (S6302). When the determination of S6302 is YES, the CPU outputs the problem solution status information (S6303). The CPU determines whether to end the output (S6304). When the determination of S6304 is NO, the procedure returns to S6301. When the determination of S6302 is NO, the CPU determines whether to output the risk manifestation risk/high risk information (S6305). When the determination of S6305 is YES, the CPU outputs the risk manifestation risk/high risk information (S6306). In S6306, a risk information mapping substep is also executed. The CPU determines whether to end the output (S6307). When the determination of S6307 is NO, the procedure returns to S6301. When the determination of S6305 is NO, the CPU determines whether to output the task processing status information (S6308). When the determination of S6308 is YES, the CPU outputs the task processing status information (S6309). The CPU determines whether to end the output (S6310). When the determination of S6310 is NO, the procedure returns to S3401. When the determination of S6301 is NO, the determination of S6304 is YES, the determination of S6307 is YES, the determination of S6308 is NO, and the determination of S6310 is YES, nothing happens. The overall flow is as described above. Since the processing method can be configured to have the risk information mapping substep when outputting the risk manifestation risk/high risk information in addition to the features of the first embodiment, the risk information mapping substep will be described below.

The “risk information mapping substep” executes mapping of the held risk information.

<Conclusion>

As described above, it is possible to provide a project management system in which the risk information can be grasped at a glance.

### Twelfth Embodiment

The twelfth embodiment provides the project management system that, in addition to the features of the first embodiment, is configured to acquire interrelated information (interdependent information is also treated as a type of this information herein), which is information indicating the interrelationship of the problem information, the risk information, the task information and the premise information, and to held the interrelated information.

Hereinafter, the functional configuration, the hardware configuration, and the flow of processing of the project management system according to the twelfth embodiment will be described in order.

<Functional Configuration>

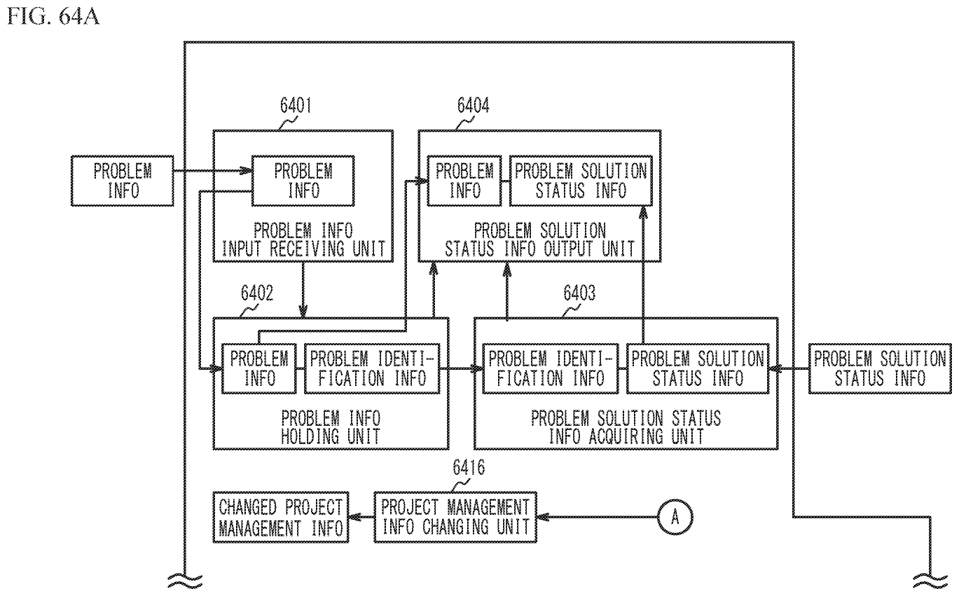

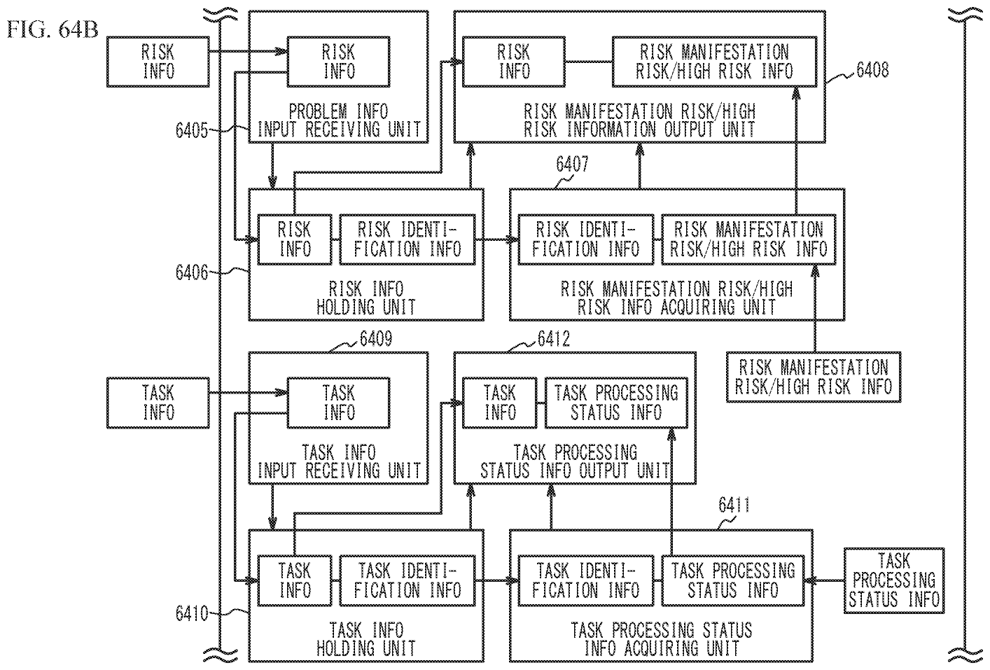

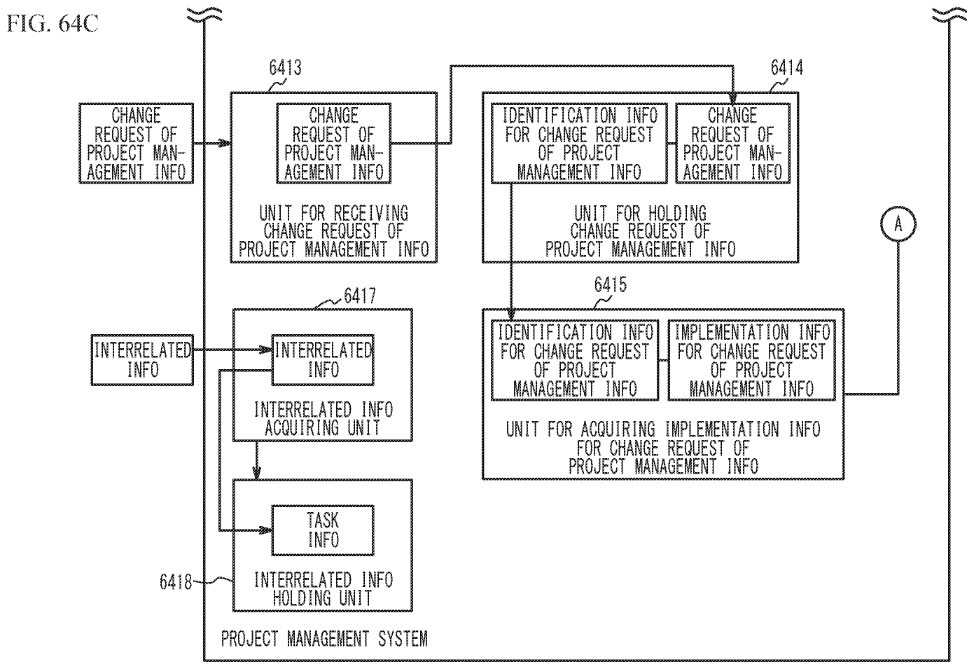

FIGS. 64A to 64C are diagrams illustrating a functional configuration of the project management system according to the twelfth embodiment. The project management system according to the present embodiment includes a problem information input receiving unit (6401), a problem information holding unit (6402), a problem solution status information acquiring unit (6403), a problem solution status information output unit (6404), a risk information input receiving unit (6405), a risk information holding unit (6406), a risk manifestation risk/high risk information acquiring unit (6407), a risk manifestation risk/high risk information output unit (6408), a task information input receiving unit (6409), a task information holding unit (6410), a task processing status information acquiring unit (6411), a task processing status information output unit (6412), a unit for receiving change request of project management information (6413), a unit for holding change request of project management information (6414), a unit for acquiring implementation information for change request of project management information (6415), a project management information changing unit (6416), an interrelated information acquiring unit (6417), and an interrelated information holding unit (6418). Hereinafter, the content of each function will be specifically described. Since each function except for the interrelated information acquiring unit and the interrelated information holding unit is the same as that in the first embodiment, the explanation is limited to the functions of the interrelated information acquiring unit and the interrelated information holding unit.

The “interrelated information acquiring unit” acquires the interrelated information which is information indicating the interrelationship of the problem information, the risk information, the task information and the premise information. For example, the interrelationship information between the problem information and the task information is information indicating the relationship that the problem indicated by the task information is solved by completing the task indicated by all the associated task information. The interrelationship information between the risk information and the problem information is information that indicates a relationship that makes it impossible to solve the problem indicated by the problem information when the risk indicated by the risk information is manifested, or information that indicates a relationship with the problem information indicating the problem that must be solved as a new problem when the risks is manifested. The interrelationship information between the premise information and another project management information is information indicating that the another project management information is changed when the premise information is destroyed. The interrelationship information may also indicate a relationship between the same categories. For example, the interrelationship information between the problem information and another project information is information that indicates a relationship that makes it unnecessary to solve the problem indicated by the another problem information when the problem indicated by one problem information is solved. The interrelationship information between task information and another task information is information indicating a relationship in which the task indicated by one task information must be completed before the task indicated by the another task information must be started. The system may have a project progress work instruction unit that gives various instructions and advices based on these interrelationship information and the information indicating the degree of progress of the project (e.g. the progress information of problems and tasks, and the overall progress information composed based on the progress information of problems and tasks).

The “interrelated information holding unit” has a function of holding the acquired interrelationship information.

<Hardware Configuration>

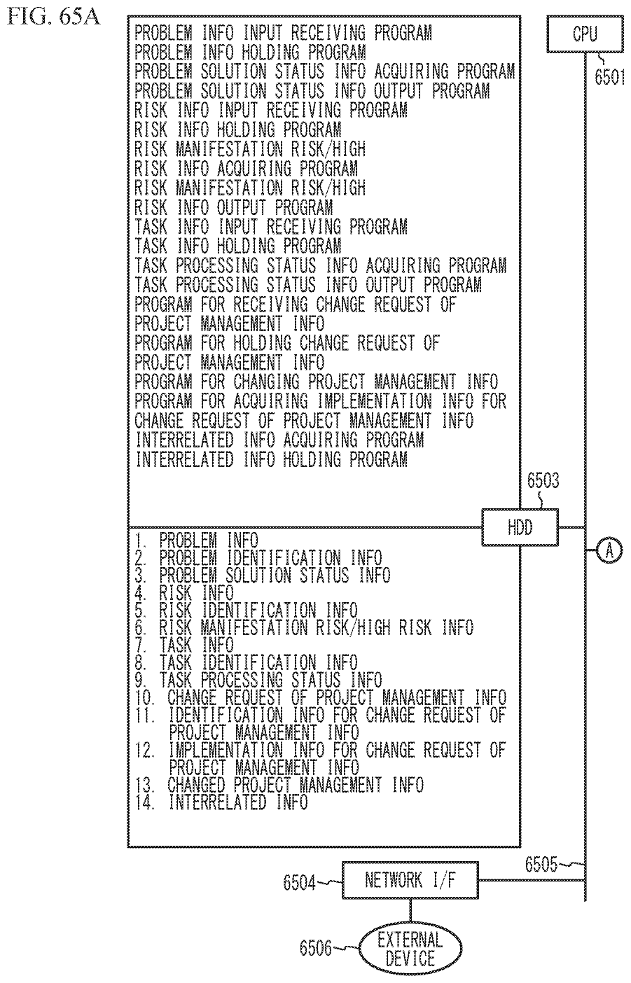

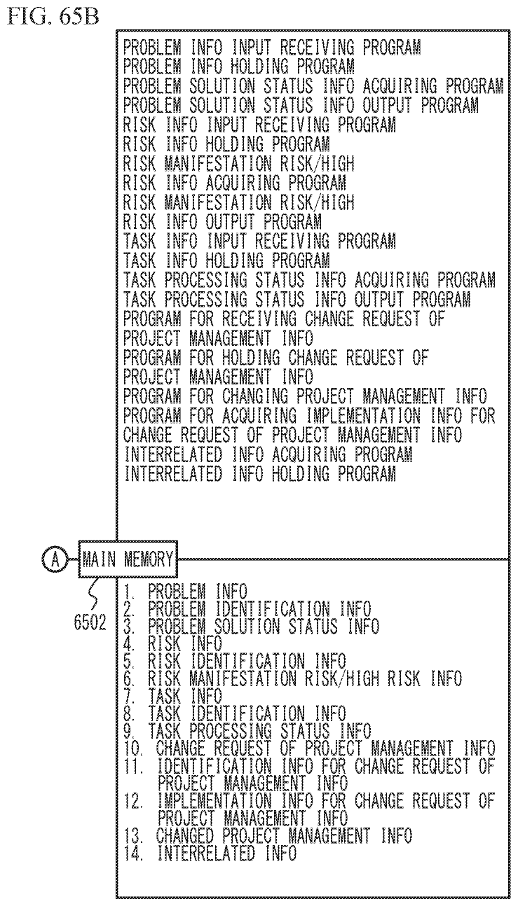

FIGS. 65A and 65B are diagrams illustrating the hardware configuration of the project management system according to the twelfth embodiment. As illustrated in FIGS. 65A and 65B, the project management system according to the eleventh embodiment includes a “CPU (central processing unit)” (6501) which performs various arithmetic operations, and a “main memory” (6502). Further, the project management system includes a “HDD” (6503) that holds predetermined information, and a “network I/F (interface)” (6504) that transmits and receives information to and from user terminal devices (6506) associated with a plurality of user identification information. The CPU, the main memory, the HDD and the network I/F are connected to each other by a data communication path such as a “system bus” (6505) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, an interrelated information acquiring program, and an interrelated information holding program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment. Moreover, in the present embodiment, each of the main memory and the HDD stores the interrelationship information.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the interrelated information acquiring program stored in the main memory to acquire the interrelated information which is information indicating the interrelationship of the problem information, the risk information, the task information and the premise information. The CPU executes the interrelated information holding program to hold the acquired interrelated information.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

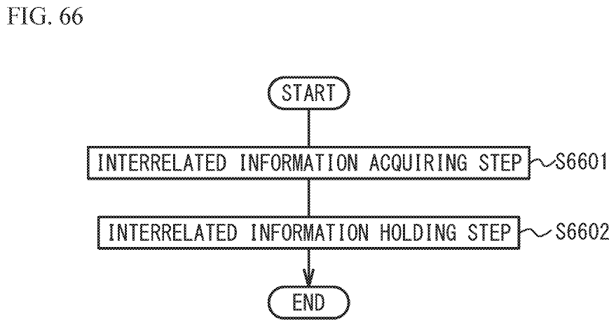

FIG. 66 is a flowchart illustrating processing when the project management system according to the twelfth embodiment is used. The parts that overlap with the first embodiment are not illustrated in the figure, but it is assumed that the flow of processing in the first embodiment exists. In the twelfth embodiment, the flow of the processing includes an interrelated information acquiring step (S6601) and an interrelated information holding step (S6602). Hereinafter, the interrelated information acquiring step and the interrelated information holding step will be described.

The “interrelated information acquiring step” acquires the interrelated information which is information indicating the interrelationship of the problem information, the risk information, the task information and the premise information.

The “interrelated information holding step” holds the acquired interrelationship information.

### Thirteenth Embodiment

The thirteenth embodiment provides the project management system that, in addition to the features of the twelfth embodiment, is configured to, when the problem information and the task information are associated with each other, generate the problem solution status information, which is information indicating that the held problem has been solved, based on the task processing status information of the associated task information, and transmit the problem solution status information to the problem solution status information acquiring unit.

Hereinafter, the functional configuration, the hardware configuration, and the flow of processing of the project management system according to the thirteenth embodiment will be described in order.

<Functional Configuration>

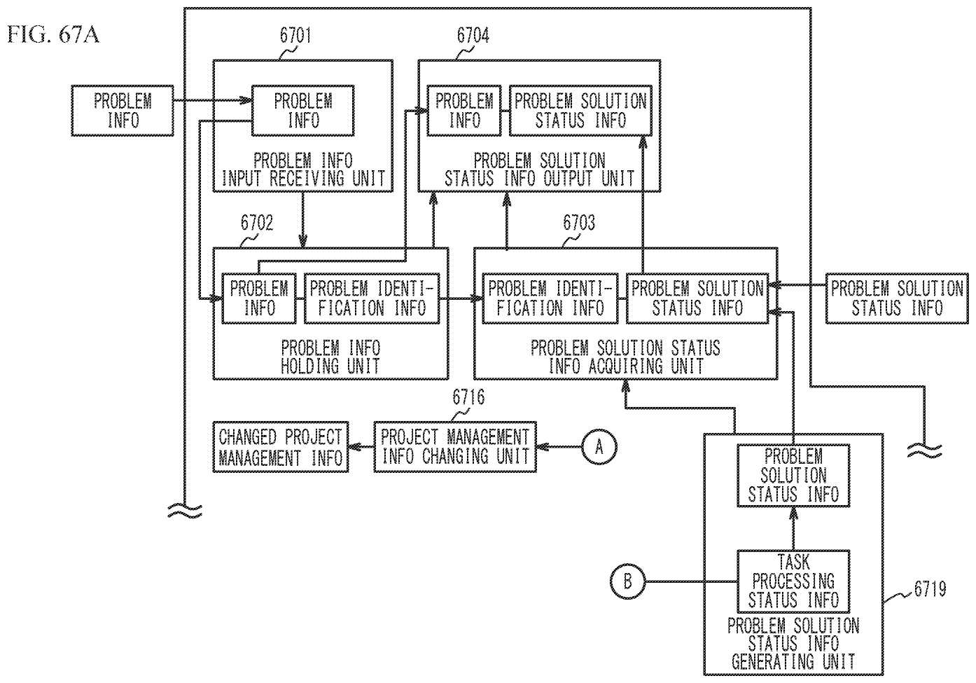

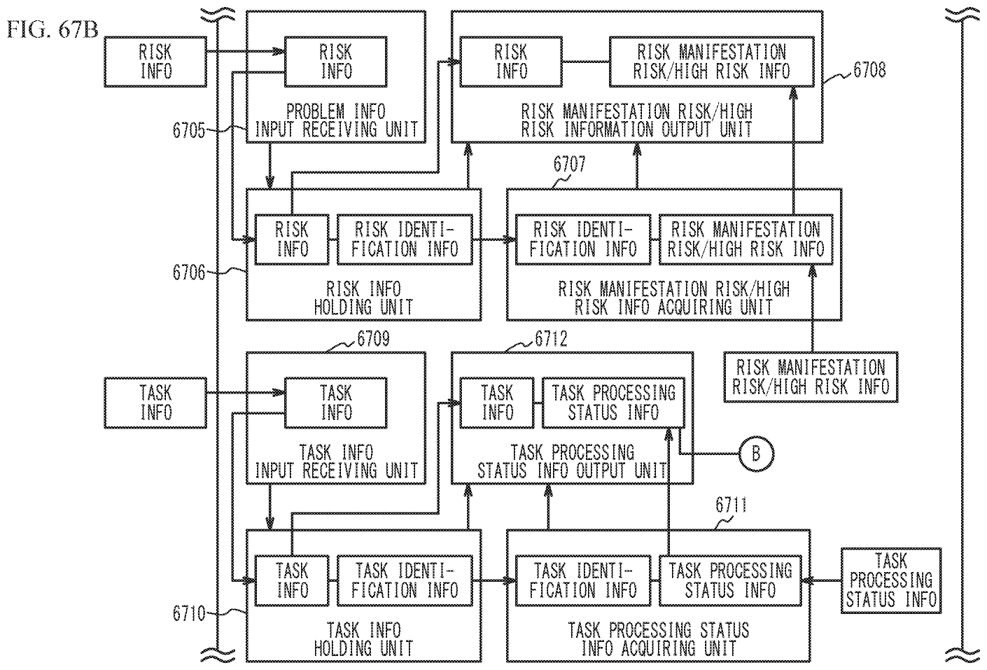

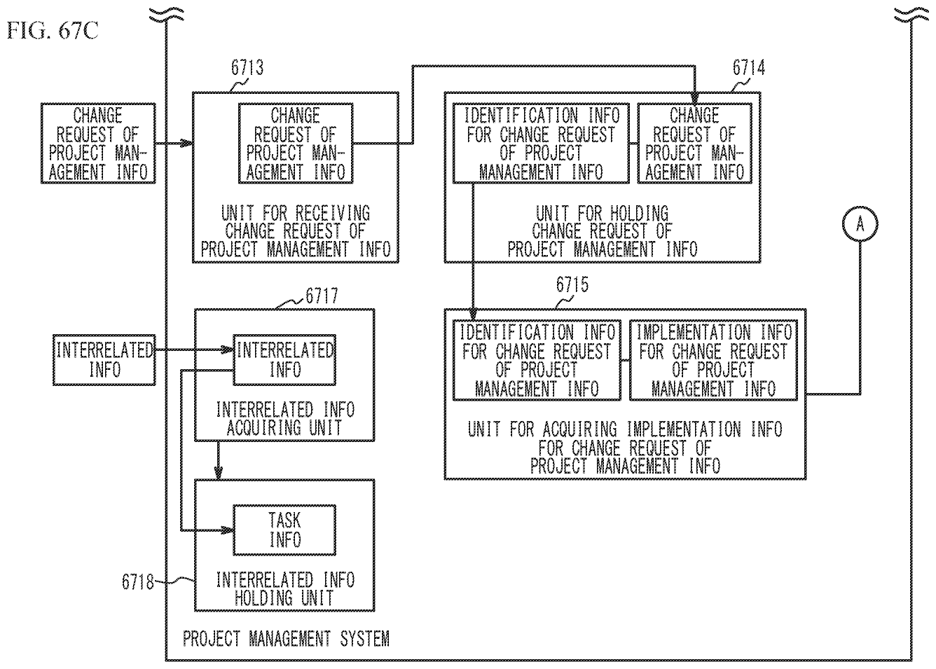

FIGS. 67A to 67C are diagrams illustrating a functional configuration of the project management system according to the thirteenth embodiment. The project management system according to the present embodiment includes a problem information input receiving unit (6701), a problem information holding unit (6702), a problem solution status information acquiring unit (6703), a problem solution status information output unit (6704), a risk information input receiving unit (6705), a risk information holding unit (6706), a risk manifestation risk/high risk information acquiring unit (6707), a risk manifestation risk/high risk information output unit (6708), a task information input receiving unit (6709), a task information holding unit (6710), a task processing status information acquiring unit (6711), a task processing status information output unit (6712), a unit for receiving change request of project management information (6713), a unit for holding change request of project management information (6714), a unit for acquiring implementation information for change request of project management information (6715), a project management information changing unit (6716), an interrelated information acquiring unit (6717), an interrelated information holding unit (6718) and a problem solution status information generating unit (6719). Hereinafter, the content of each function will be specifically described. Since each function except for the problem solution status information generating unit is the same as that in the twelfth embodiment, the explanation is limited to the function of the problem solution status information generating unit.

The “problem solution status information generating unit” has a function of, when the problem information and the task information are associated with each other, generating the problem solution status information, which is information indicating that the held problem has been solved, based on the task processing status information of the associated task information, and transmitting the problem solution status information to the problem solution status information acquiring unit.

<Hardware Configuration>

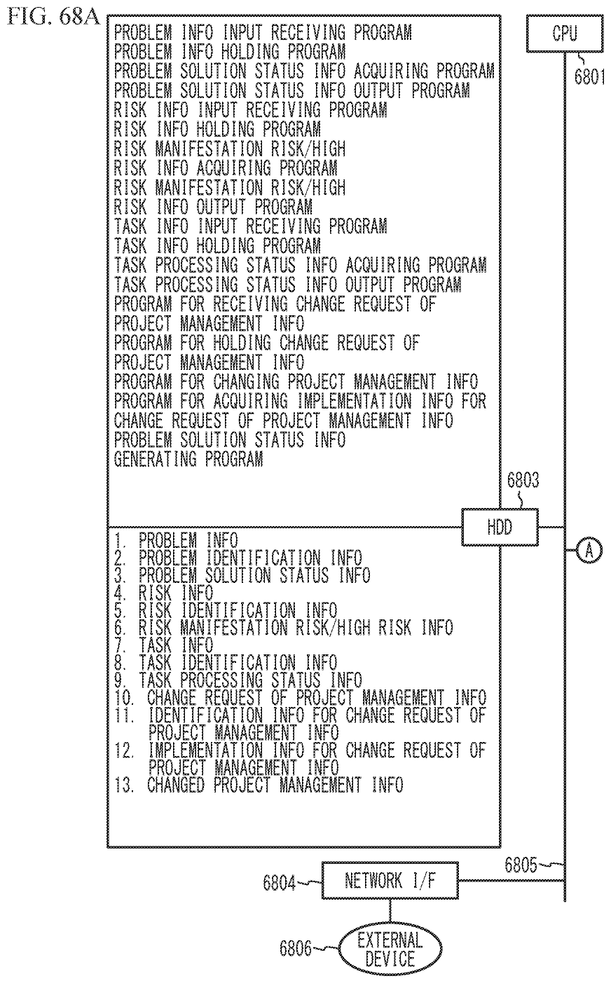

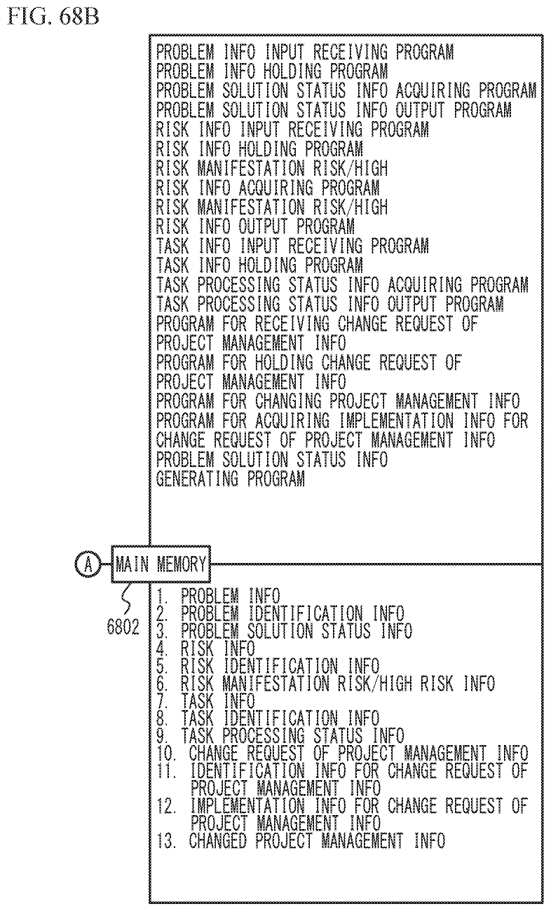

FIGS. 68A and 68B are diagrams illustrating the hardware configuration of the project management system according to the thirteenth embodiment. As illustrated in FIGS. 68A and 68B, the project management system according to the thirteenth embodiment includes a “CPU (central processing unit)” (6801) which performs various arithmetic operations, and a “main memory” (6802). Further, the project management system includes a “HDD” (6803) that holds predetermined information, and a “network I/F (interface)” (6804) that transmits and receives information to and from user terminal devices (6806) associated with a plurality of user identification information. The CPU, the main memory, the HDD and the network I/F are connected to each other by a data communication path such as a “system bus” (6805) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, the interrelated information acquiring program, the interrelated information holding program, and a problem solution status information generating program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, the implementation information for the change request of the project management information, and the interrelated information, as in the first embodiment.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the interrelated information acquiring program stored in the main memory to acquire the interrelated information which is information indicating the interrelationship of the problem information, the risk information, the task information and the premise information. The CPU executes the interrelated information holding program to hold the acquired interrelated information.

Next, the CPU executes the problem solution status information generating program stored in the main memory to, when the problem information and the task information are associated with each other, generate the problem solution status information, which is information indicating that the held problem has been solved, based on the task processing status information of the associated task information, and transmit the problem solution status information to the problem solution status information acquiring unit.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

<Flow of Processing>

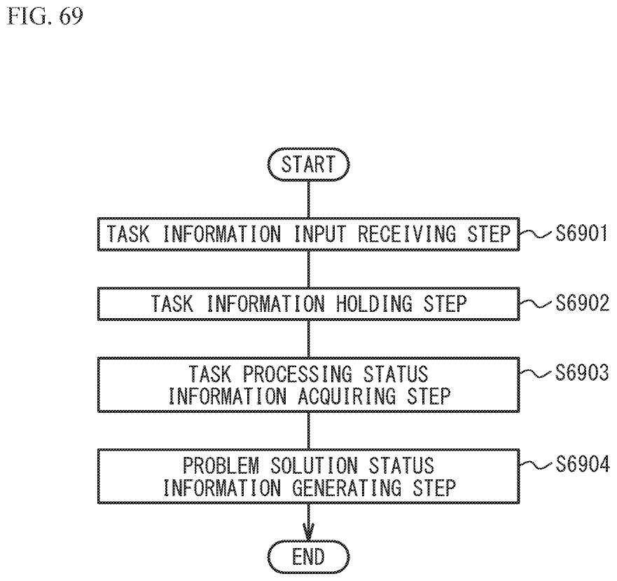

FIG. 69 is a flowchart illustrating processing when the project management system according to the thirteenth embodiment is used. The parts that overlap with the first embodiment are not illustrated in the figure, but it is assumed that the flow of processing in the first embodiment exists. In the thirteenth embodiment, the flow of the processing related to the task information includes a task information input receiving step (S6901), a task information holding step (S6902), a task processing status information acquiring step (S6903), and a problem solution status information generating step (S6904). Hereinafter, the problem solution status information generating step will be described.

The “problem solution status information generating step” generates, when the problem information and the task information are associated with each other, the problem solution status information, which is information indicating that the held problem has been solved, based on the task processing status information of the associated task information, and transmits the problem solution status information to the problem solution status information acquiring unit.

<Conclusion>

As described above, it is possible to provide a project management system that can automatically lead the status of the problem solution by inputting the contents of task processing according to the guidance, even for an inexperienced user, although the degree of freedom is reduced by guiding an issue to be considered regarding the status of the problem solution.

### Fourteenth Embodiment

The fourteenth embodiment provides the project management system that, in addition to the features of the second embodiment, is configured to receive an input of the change of the premise information associated with the project management information and to prompt the correction of the project management information associated with the premise information.

Hereinafter, the functional configuration, the hardware configuration, and the flow of processing of the project management system according to the fourteenth embodiment will be described in order.

<Functional Configuration>

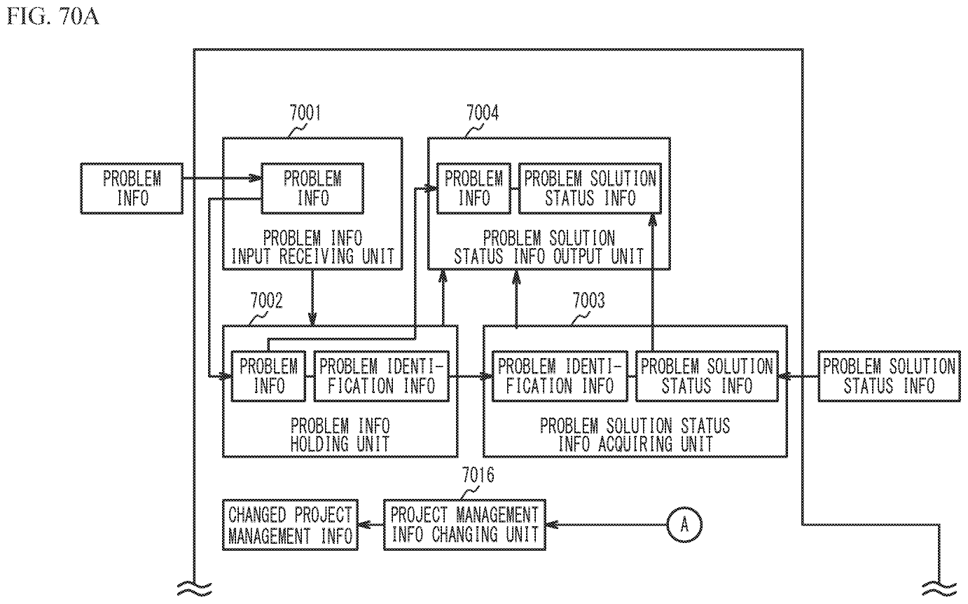

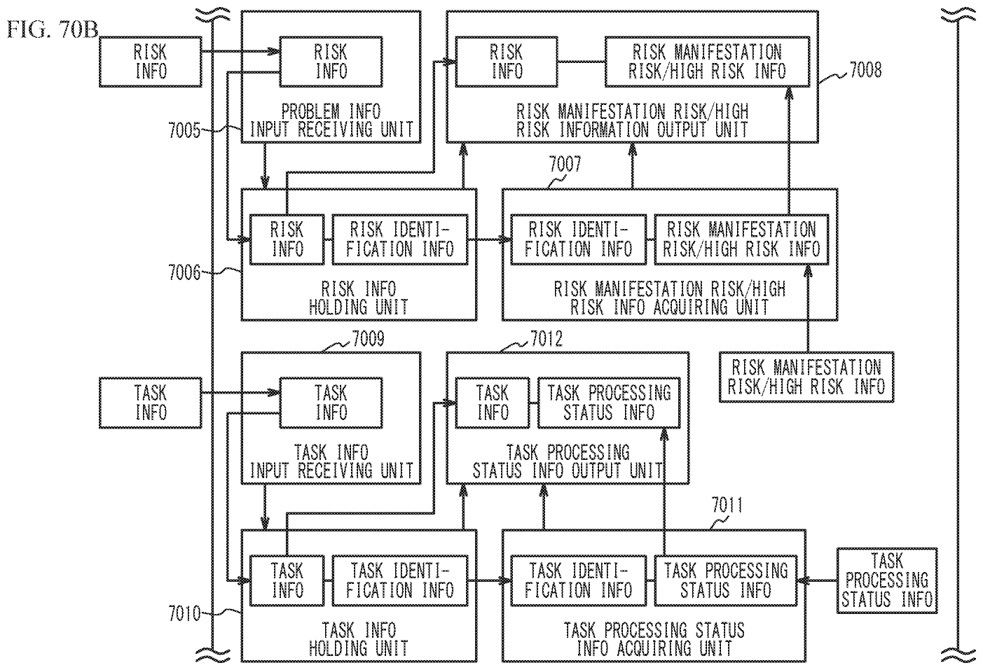

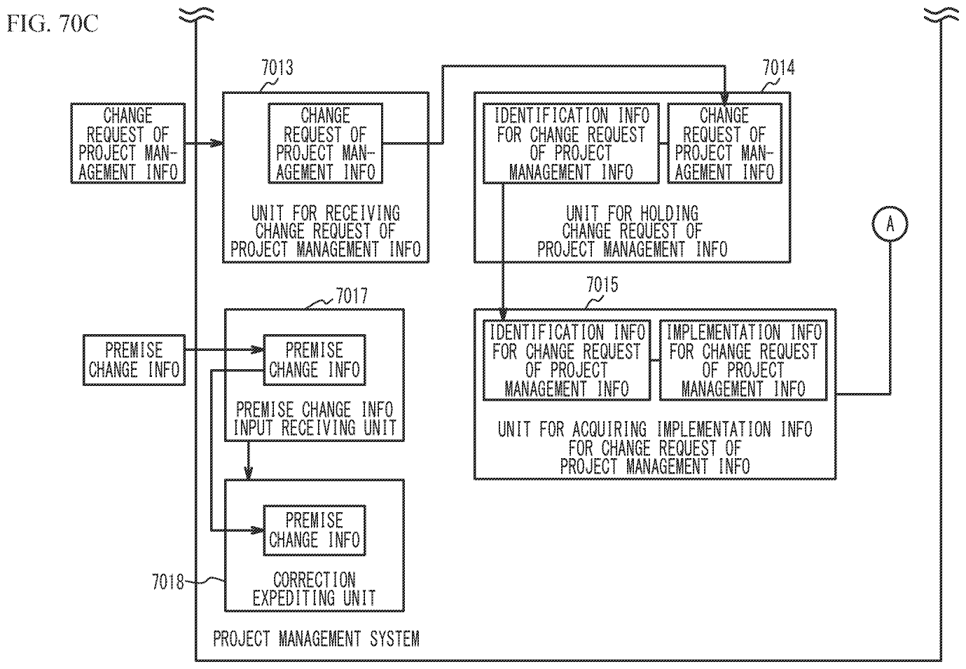

FIGS. 70A to 70C are diagrams illustrating a functional configuration of the project management system according to the fourteenth embodiment. The project management system according to the present embodiment includes a problem information input receiving unit (7001), a problem information holding unit (7002), a problem solution status information acquiring unit (7003), a problem solution status information output unit (7004), a risk information input receiving unit (7005), a risk information holding unit (7006), a risk manifestation risk/high risk information acquiring unit (7007), a risk manifestation risk/high risk information output unit (7008), a task information input receiving unit (7009), a task information holding unit (7010), a task processing status information acquiring unit (7011), a task processing status information output unit (7012), a unit for receiving change request of project management information (7013), a unit for holding change request of project management information (7014), a unit for acquiring implementation information for change request of project management information (7015), and a project management information changing unit (7016), a premise change input receiving unit (7017), and a correction prompting unit (7018). Hereinafter, the content of each function will be specifically described. Since each function except for the premise change input receiving unit and the correction prompting unit is the same as that in the first embodiment, the explanation is limited to the functions of the premise change input receiving unit and the correction prompting unit.

The “premise change input receiving unit” has a function of receiving the input of the change of the premise information associated with the project management information. The premise information may be generated in a free-form, or it may be input and generated partially according to a template. In the latter case, the meaning of the premise is identified for each input field, and premise element attribute identification information is attached to the input content. An example of a list of element attributes includes, for example, “1. amount of fund, stock price, bond, loan amount, investment amount”, “2. cooperation, alliance, joint development, joint business, merger”, “3. president, executive, leader, developer, salesperson, programmer, SE”, “4. land, building, research facility, development equipment”, “5. interest rate, dividend, maturity period”, “6. economic trend, price index, industrial index”, “7. number of employees, number of seconded employees, number of part-timers, number of outsourced employees”, “8. law on communication, law on transportation, law on finance”, “9. communication technology progress, computing technology progress, transportation technology progress, biotechnology progress”, “10. administrative approval, bill enactment, test success/failure, performance test pass”, “11. climate, weather, disaster (earthquake, tsunami, volcano, flood), pollution” and so on. It is preferable that the system stores a rule that instruct which of the project management information should be corrected according to the changed element attributes of the premise (i.e., the system may include an instruction unit for correcting the project management information for each element attribute of the premise). For example, if the premise of the above “1” is broken, the system is configured to output correction instructions for the project management information that can affect costs, sales, and profits. Therefore, it is preferable that each project management information is managed in association with the premise element attribute identification information of the premise information that may be affected by the project management information. The system may be configured to allow the user to enter the associations of the project management information when registering, entering, or correcting the project management information, or it may be configured to record and hold, in each holding unit, the premise element attribute identification information that may be affected by the system based on the entry of the project management information, in association with that the identification information of the project management information.

The “correction prompting unit” has a function of prompting the correction of the project management information associated with the premise information.

<Hardware Configuration>

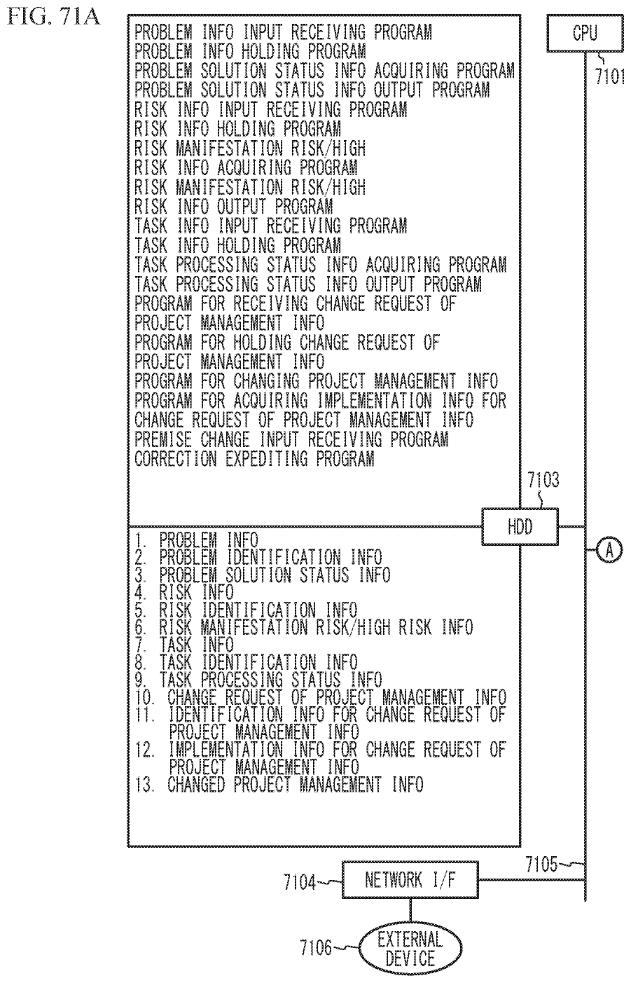

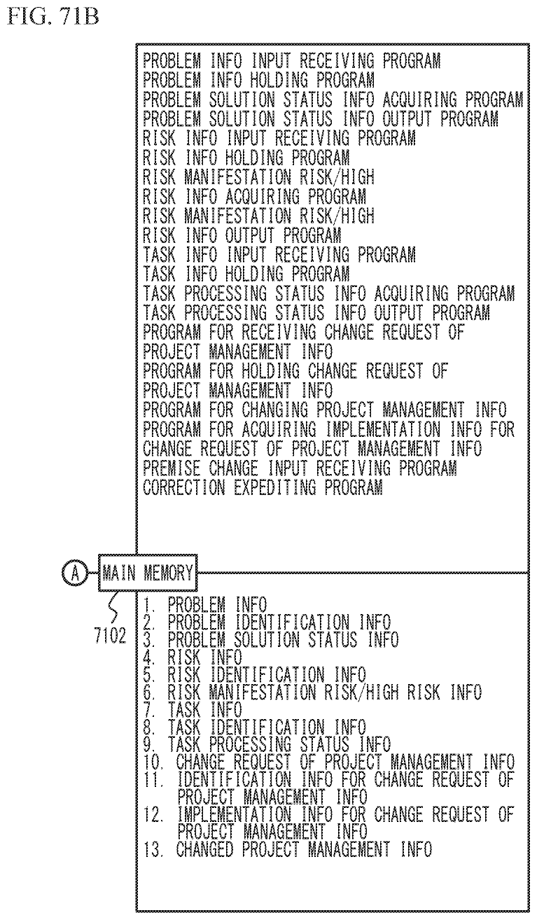

FIGS. 71A and 71B are diagrams illustrating the hardware configuration of the project management system according to the fourteenth embodiment. As illustrated in FIGS. 71A and 71B, the project management system according to the tenth embodiment includes a “CPU (central processing unit)” (7101) which performs various arithmetic operations, and a “main memory” (7102). Further, the project management system includes a “HDD” (7103) that holds predetermined information, and a “network 1/F (interface)” (7104) that transmits and receives information to and from user terminal devices (7106) associated with a plurality of user identification information. The CPU, the main memory, the HDD and the network I/F are connected to each other by a data communication path such as a “system bus” (7105) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, a premise change input receiving program, and a correction prompting program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment. In addition, in the present embodiment, the premise information is stored in each of the main memory and the HDD.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

Next, the CPU executes the premise change input receiving program stored in the main memory to receive the input of the change of the premise information associated with project management information through the network interface. The CPU executes the correction prompting program to prompt the correction of the project management information associated with the premise information through the network interface.

<Flow of Processing>

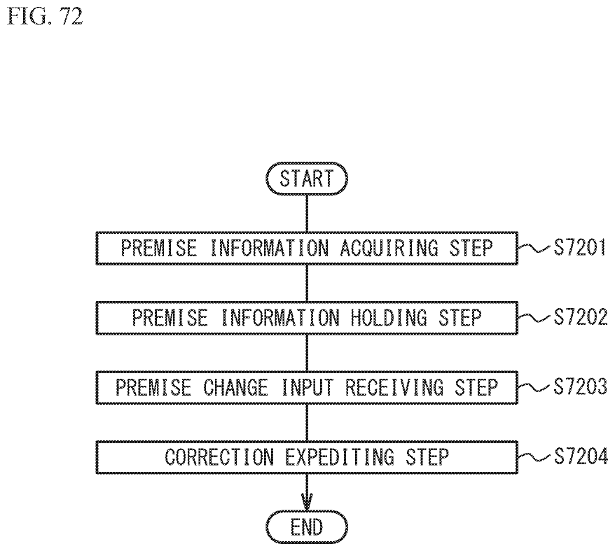

FIG. 72 is a flowchart illustrating processing when the project management system according to the fourteenth embodiment is used. In the present embodiment, in addition to the processing of the second embodiment, there are a premise change input receiving step and a correction prompting step, in any order. Hereinafter, the premise change input receiving step and the correction prompting step will be described.

The “premise change input receiving step” receives the input of the change of the premise information associated with the project management information.

The “correction prompting step” prompts the correction of the project management information associated with the premise information.

<Conclusion>

As a result, it is possible to provide a project management system that can prompt the user to correct the project management information when the need to correct the project management information arises in response to the change in the premise information.

### Fifteenth Embodiment

The fifteenth embodiment provides the project management system that, in addition to the features of the first embodiment, is configured to receive an input of a stakeholder related to the achievement of the goal of the project in association with an index value indicating an attribute of the stakeholder, generate a map of the stakeholder using the stakeholder and the received index value associated with the stakeholder, and output the generated map.

Hereinafter, the functional configuration, the hardware configuration, and the flow of processing of the project management system according to the fifteenth embodiment will be described in order.

<Functional Configuration>

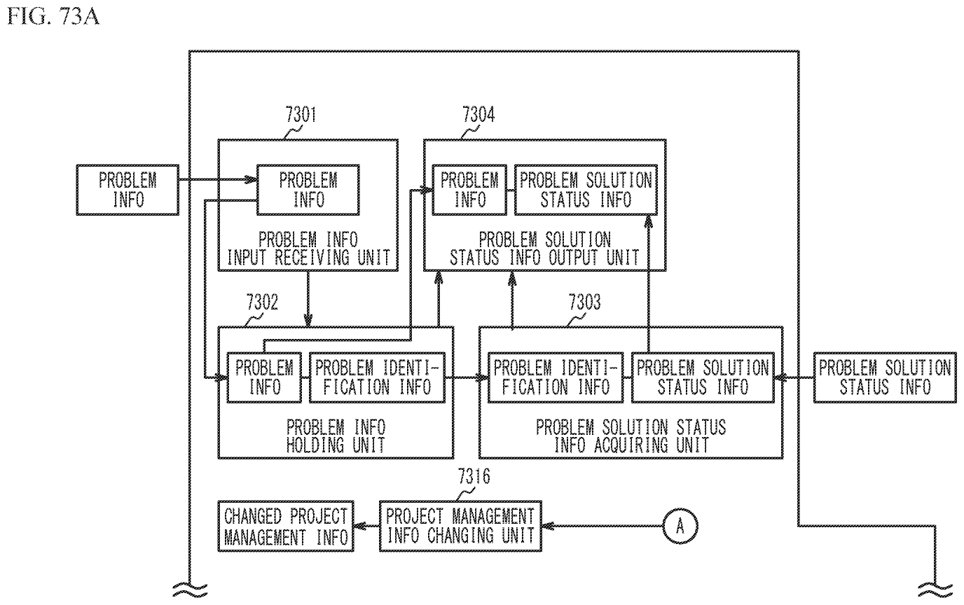

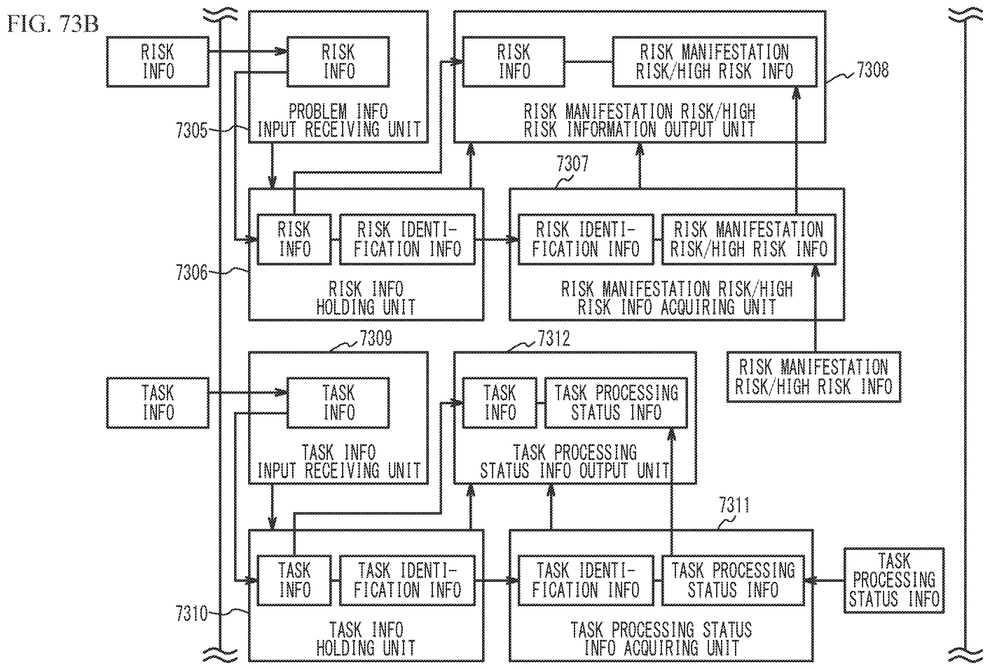

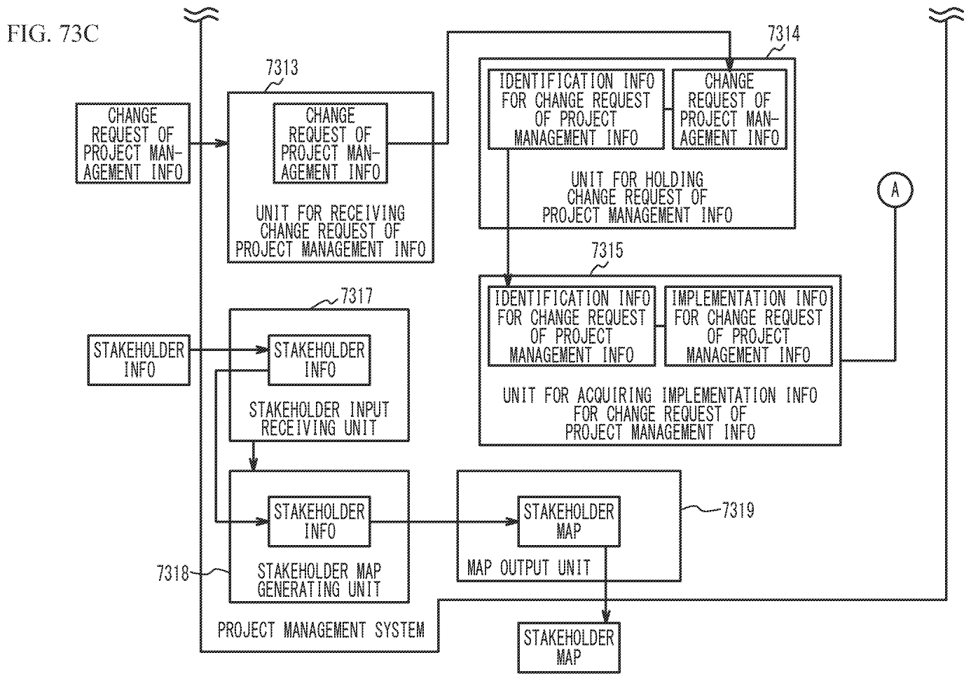

FIGS. 73A to 73C are diagrams illustrating a functional configuration of the project management system according to the fifteenth embodiment. The project management system according to the present embodiment includes a problem information input receiving unit (7301), a problem information holding unit (7302), a problem solution status information acquiring unit (7303), a problem solution status information output unit (7304), a risk information input receiving unit (7305), a risk information holding unit (7306), a risk manifestation risk/high risk information acquiring unit (7307), a risk manifestation risk/high risk information output unit (7308), a task information input receiving unit (7309), a task information holding unit (7310), a task processing status information acquiring unit (7311), a task processing status information output unit (7312), a unit for receiving change request of project management information (7313), a unit for holding change request of project management information (7314), a unit for acquiring implementation information for change request of project management information (7315), and a project management information changing unit (7316), a stakeholder input receiving unit (7317), a stakeholder map generating unit (7318), and a map output unit (7319). Hereinafter, the content of each function will be specifically described. Since each function except for the stakeholder input receiving unit, the stakeholder map generating unit and the map output unit is the same as that in the first embodiment, the explanation is limited to the functions of the stakeholder input receiving unit, the stakeholder map generating unit and the map output unit.

The “stakeholder input receiving unit” has a function of receiving the input of the stakeholder related to the achievement of the goal of the project in association with the index value indicating the attribute of the stakeholder.

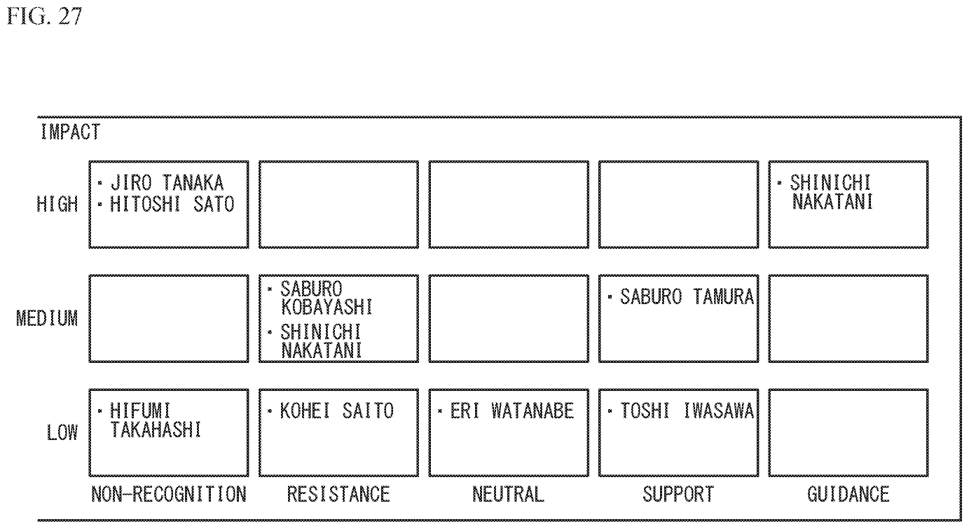

The “stakeholder map generating unit” has a function of generating the map of the stakeholder using the stakeholder and the received index value associated with the stakeholder. As illustrated in FIG. 27, for example, one axis indicates a level of impact on the project, another axis indicates a degree of action on the project (non-recognition, resistance, neutral, support, guidance, etc.), and identification information of the stakeholder is placed in a space generated by these two axes. The identification information of the stakeholder can be configured to move in the map with a mouse, keyboard, and so on, and can be configured to generate a new problem in the project or to make the problem disappear, by moving in the map. Therefore, the system can be configured to prepare the arrangement of the stakeholder, and the problem and the task that must exist in the arrangement in advance, and then suggest the change in problem to the user in response to the change of the arrangement (problem change suggesting unit), or the system can be configured to automatically execute the pre-prepared problem change (automatic problem changing unit). It can also be configured to change the task instead of the problem (a task change suggesting unit and an automatic task changing unit). Furthermore, it can be configured to change the risk or the premise information. It is also possible to automatically perform the risk change and the premise change (a risk/premise changing unit, and a risk/premise change suggesting unit) by preparing in advance the risk that should exist there and the premise information that should be in that case, in association with the predetermined position of the stakeholder.

The “map output unit” has a function of outputting the generated map. This output can be on paper or on a display such as a touch panel controllable with a mouse or cursor. It is also desirable to provide a position changing unit for changing the position of the stakeholder along with a map editing unit to receive the deletion of an existing stakeholder in the map editing unit (a unit for receiving deletion of existing stakeholder), or desirable to receive the input of a new stakeholder in the map editing unit (a new stakeholder input receiving unit).

<Hardware Configuration>

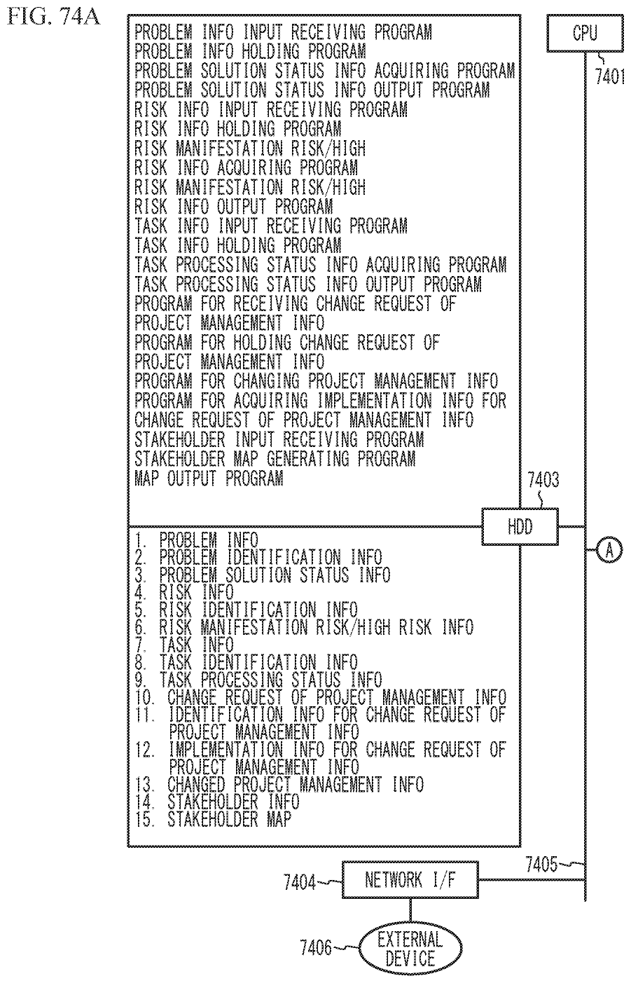

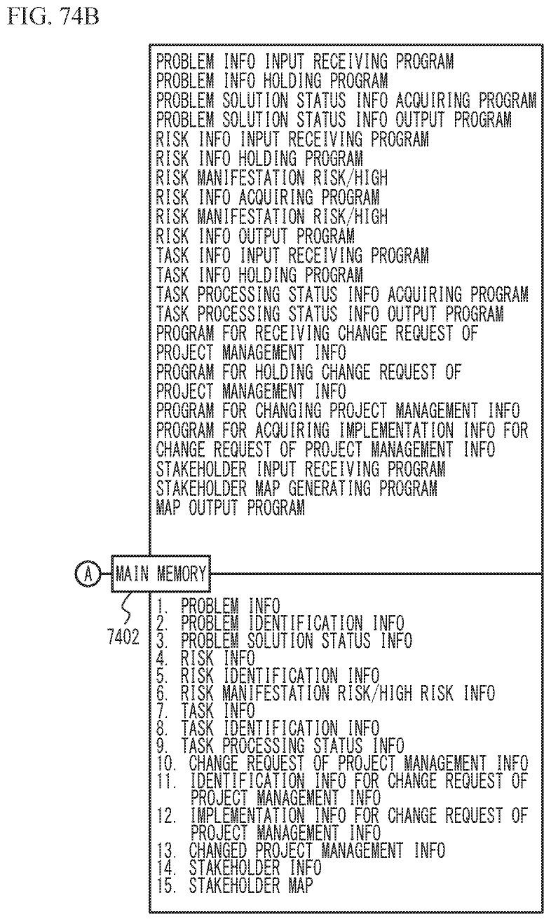

FIGS. 74A and 74B are diagrams illustrating the hardware configuration of the project management system according to the fifteenth embodiment. As illustrated in FIG. 74A and 74B, the project management system according to the tenth embodiment includes a “CPU (central processing unit)” (7401) which performs various arithmetic operations, and a “main memory” (7402). Further, the project management system includes a “HDD” (7403) that holds predetermined information, and a “network I/F (interface)” (7404) that transmits and receives information to and from user terminal devices (7406) associated with a plurality of user identification information. The CPU, the main memory, the HDD and the network I/F are connected to each other by a data communication path such as a “system bus” (7405) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, a stakeholder input receiving program, a stakeholder map generating program and a map output program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment. In addition, in the present embodiment, the stakeholder information is stored in each of the main memory and the HDD.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

Next, the CPU executes the stakeholder input receiving program stored in the main memory to receive the input of the stakeholder related to the achievement of the goal of the project through the network interface in association with an index value indicating the attribute of the stakeholder. Next, the CPU executes the stakeholder map generating program stored in the main memory to generate the map of the stakeholder using the stakeholder and the received index value associated with the stakeholder. Next, the CPU executes the map output program stored in the main memory to output the generated map through the network interface.

<Flow of Processing>

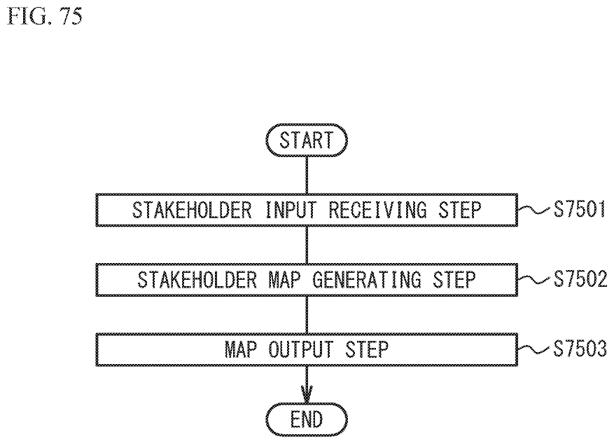

FIG. 75 is a flowchart illustrating processing when the project management system according to the fifteenth embodiment is used. The parts that overlap with the first embodiment are not illustrated in the figure, but it is assumed that the flow of processing in the first embodiment exists. In the fifteenth embodiment, there are a stakeholder input receiving step (S7501), a stakeholder map generating step (S7502), and a map output step (S7503), in addition to the processing of the first embodiment, in any order. Hereinafter, the stakeholder input receiving step, the stakeholder map generating step, and the map output step will be described.

The “stakeholder input receiving step” receives the input of the stakeholder related to the achievement of the goal of the project in association with the index value indicating the attribute of the stakeholder.

The “stakeholder map generating unit” generates the map of the stakeholder using the stakeholder and the received index value associated with the stakeholder.

The “map output step” outputs the generated map.

<Conclusion>

As described above, it is possible to provide a project management system that allows the user to grasp the attributes of the key players at a glance in accomplishing the project, so that the project can proceed smoothly.

### Sixteenth Embodiment

The sixteenth embodiment provides the project management system that, in addition to the features of the first embodiment, is configured to acquire a status information map, which is information that maps the status information, and to output the acquired status information map.

Hereinafter, the functional configuration, the hardware configuration, and the flow of processing of the project management system according to the sixteenth embodiment will be described in order.

<Functional Configuration>

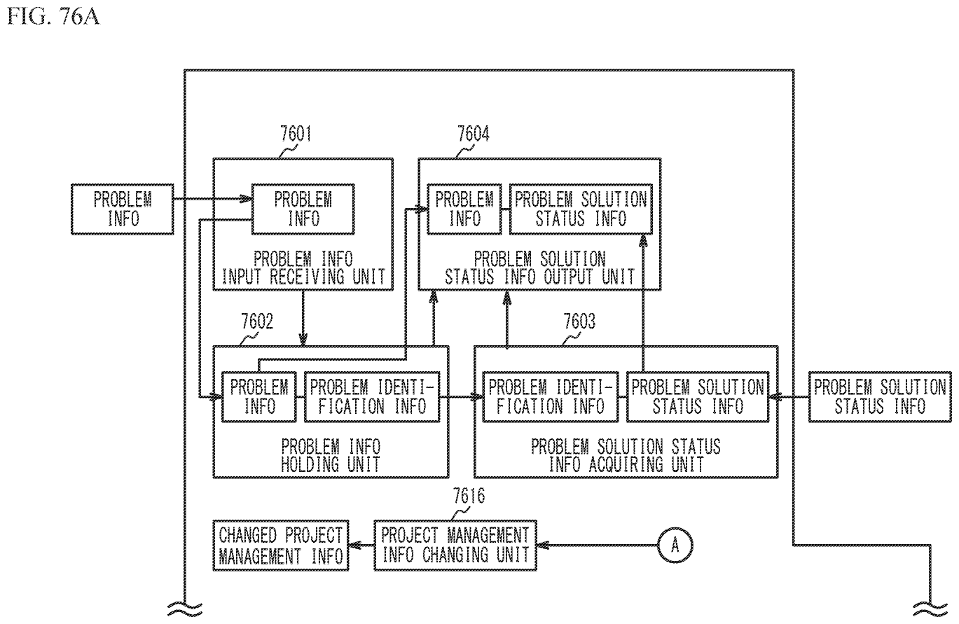

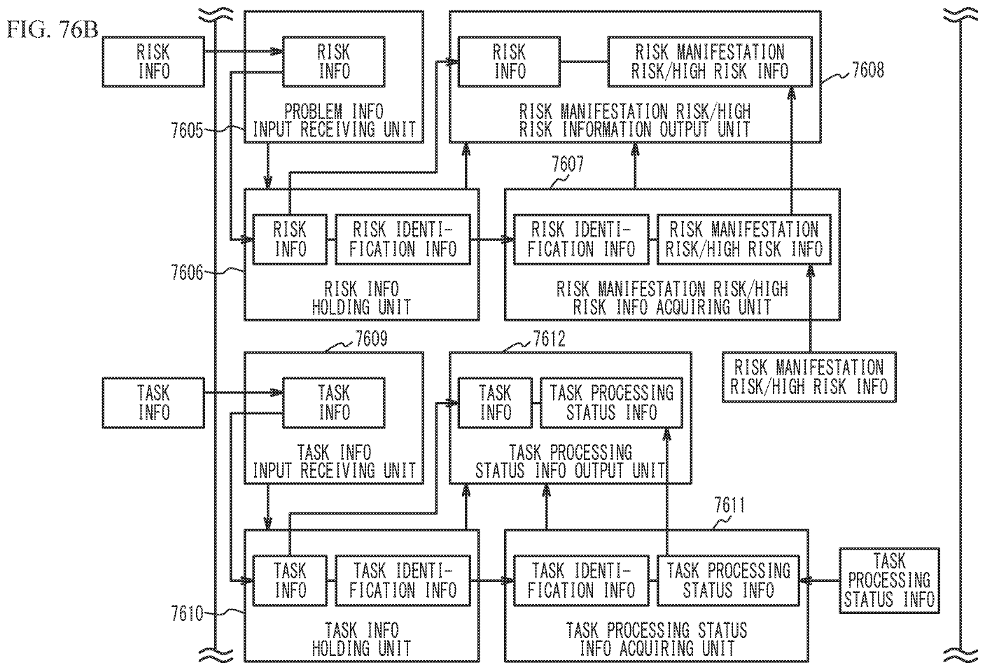

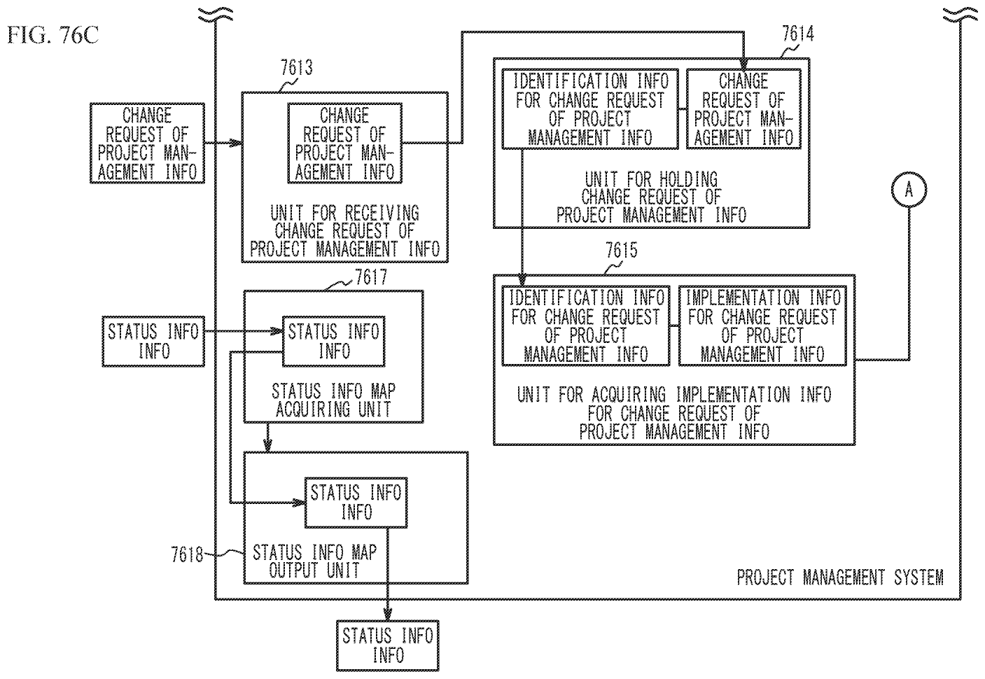

FIGS. 76A to 76C are diagrams illustrating a functional configuration of the project management system according to the sixteenth embodiment. The project management system according to the present embodiment includes a problem information input receiving unit (7601), a problem information holding unit (7602), a problem solution status information acquiring unit (7603), a problem solution status information output unit (7604), a risk information input receiving unit (7605), a risk information holding unit (7606), a risk manifestation risk/high risk information acquiring unit (7607), a risk manifestation risk/high risk information output unit (7608), a task information input receiving unit (7609), a task information holding unit (7610), a task processing status information acquiring unit (7611), a task processing status information output unit (7612), a unit for receiving change request of project management information (7613), a unit for holding change request of project management information (7614), a unit for acquiring implementation information for change request of project management information (7615), a project management information changing unit (7616), a status information map acquiring unit (7617), and a status information map output unit (7618). Hereinafter, the content of each function will be specifically described. Since each function except for the status information map acquiring unit and the status information map output unit is the same as that in the first embodiment, the explanation is limited to the functions of the status information map acquiring unit and the status information map output unit.

The “status information map acquiring unit” has a function of acquiring the status information map which is information that maps the status information.

The “status information map output unit” has a function of outputting the acquired status information map. The status information map output unit displays the percentage of achievement against 100% completion by using a pie chart for each task (by identification information) or a pie chart for each problem, which is indicated by a hierarchical structure, etc. If the user clicks on the pie chart or the identification information of the problem or task with the cursor or mouse, the information about the problem, the task, the achievement status, and other information related to the information may be displayed in a pop-up window. For example, a member identifier for the task may be displayed, and clicking on the member identifier may open an e-mail generating window for the member or allow the user to make a phone call to the member. Further, the communication may be configured to be done through the SNS. The SNS is composed of its task members, and it may be configured to be shared by all members. The system may be configured so that, in the case of work delays, a report on the cause of the delay by the member may be recorded and made available for viewing, or measures to resolve the delay may be recorded and made available for viewing (a report viewing unit). In addition, the system may be configured so that other task members can offer their support by clicking (a support offering unit).

<Hardware Configuration>

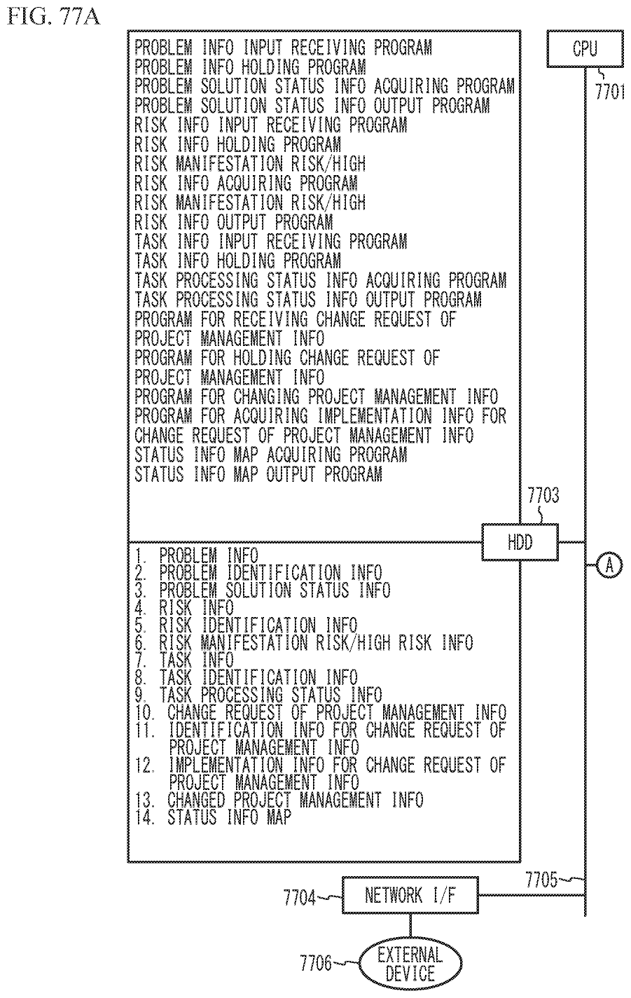

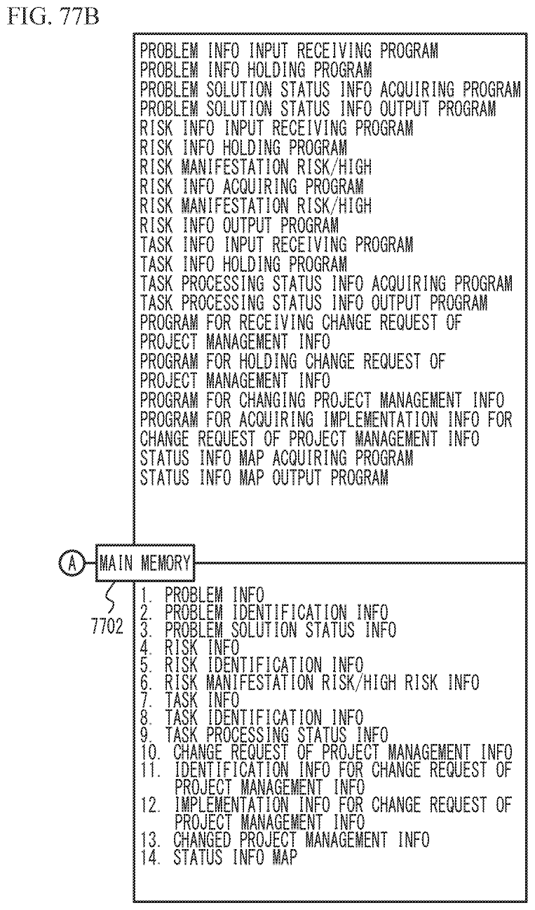

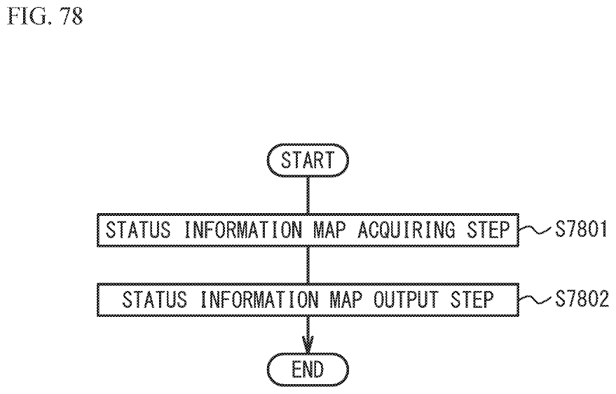

FIGS. 77A and 77B is a diagram illustrating the hardware configuration of the project management system according to the sixteenth embodiment. As illustrated in FIGS. 77A and 77B, the project management system according to the sixteenth embodiment includes a “CPU (central processing unit)” (7701) which performs various arithmetic operations, and a “main memory” (7702). Further, the project management system includes a “HDD” (7703) that holds predetermined information, and a “network IN (interface)” (7704) that transmits and receives information to and from user terminal devices (7706) associated with a plurality of user identification information. The CPU, the main memory, the HDD and the network UF are connected to each other by a data communication path such as a “system bus” (7705) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, a status information map acquiring program, and a status information map output program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment. In addition, in the present embodiment, the status information map is stored in each of the main memory and the HDD.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

The CPU executes the status information map acquiring program in the main memory to acquire the status information map which is information that maps the status information. The CPU executes the status information map output program in the main memory to output the acquired status information map.

<Flow of Processing>

FIG. 76 is a flowchart illustrating processing when the project management system according to the sixteenth embodiment is used. The parts that overlap with the first embodiment are not illustrated in the figure, but it is assumed that the flow of processing in the first embodiment exists. In the sixteenth embodiment, there are a status information map acquiring step (S7801) and a status information map output step (S7802), in addition to the processing of the first embodiment, in any order. Hereinafter, the status information map acquiring step and the status information map output step will be described.

The “status information map acquiring step” acquires the status information map which is information that maps the status information.

The “status information map output step” outputs the acquired status information map.

<Conclusion>

As described above, it is possible to provide a project management system that allows the user to grasp the progress of the project information, such as the problem information, the task information, and the risk information, at a glance.

### Seventeenth Embodiment

The seventeenth embodiment provides the project management system that, in addition to the features of the first embodiment, is configured to hold member team identification information that identifies a member or a team composed of members to achieve the goal of the project, hold a member team project management information relationship that associates member team identification information with the project management information in which the member team is engaged, and output the held member team project management information relationship.

Hereinafter, the functional configuration, the hardware configuration, and the flow of processing of the project management system according to the seventeenth embodiment will be described in order.

<Functional Configuration>

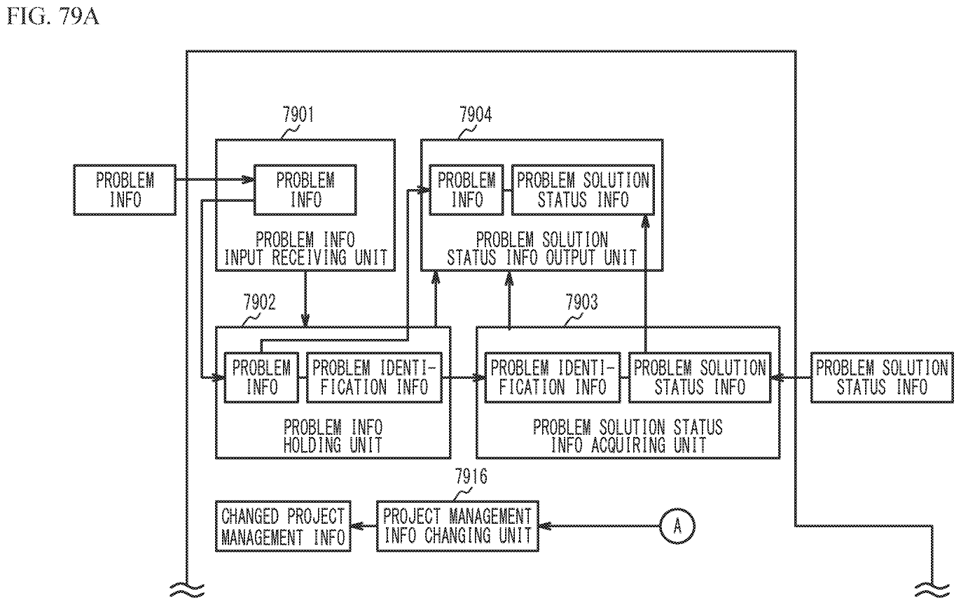

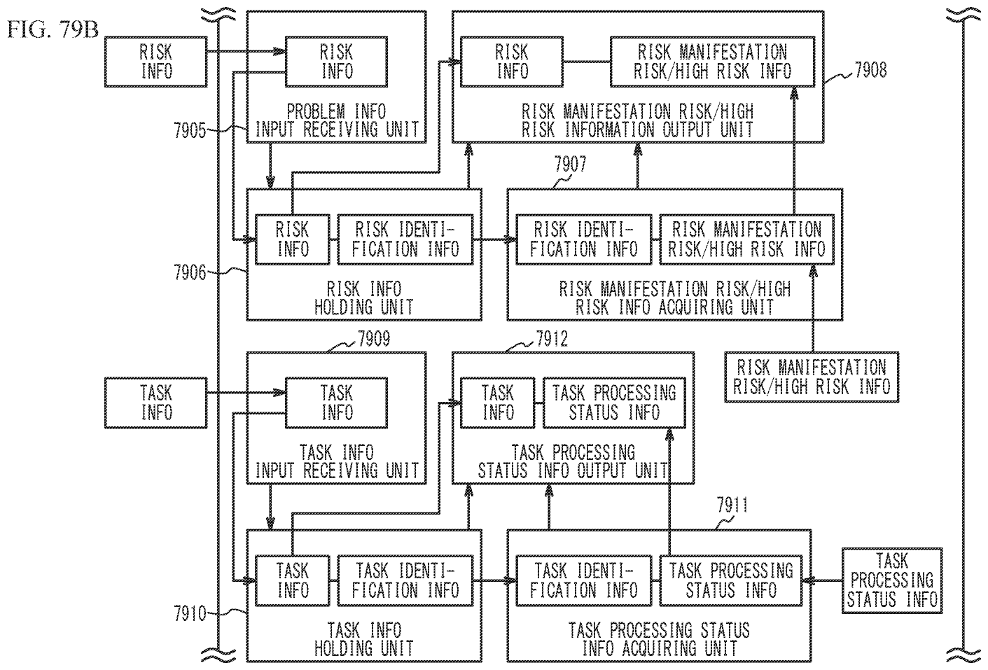

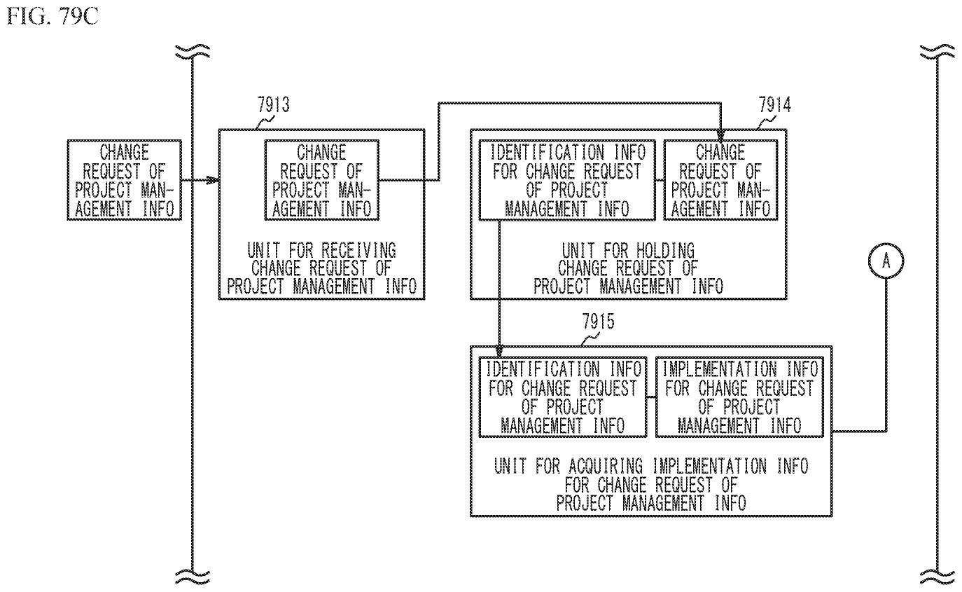

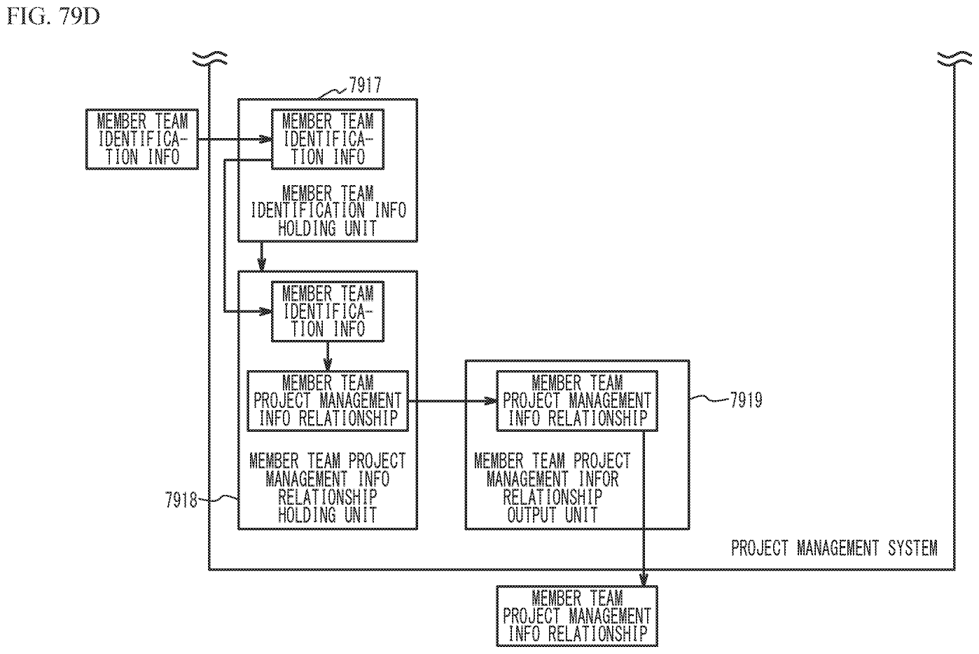

FIGS. 79A to 79D are diagrams illustrating a functional configuration of the project management system according to the seventeenth embodiment. The project management system according to the present embodiment includes a problem information input receiving unit (7901), a problem information holding unit (7902), a problem solution status information acquiring unit (7903), a problem solution status information output unit (7904), a risk information input receiving unit (7905), a risk information holding unit (7906), a risk manifestation risk/high risk information acquiring unit (7907), a risk manifestation risk/high risk information output unit (7908), a task information input receiving unit (7909), a task information holding unit (7910), a task processing status information acquiring unit (7911), a task processing status information output unit (7912), a unit for receiving change request of project management information (7913), a unit for holding change request of project management information (7914), a unit for acquiring implementation information for change request of project management information (7915), a project management information changing unit (7916), a member team identification information holding unit (7917), a member team project management information relationship holding unit (7918), and a member team project management information relationship output unit (7919). Hereinafter, the content of each function will be specifically described. Since each function except for the member team identification information holding unit, the member team project management information relationship holding unit, and the member team project management information relationship output unit is the same as that in the first embodiment, the explanation is limited to the functions of the member team identification information holding unit, the member team project management information relationship holding unit, and the member team project management information relationship output unit.

The “member team identification information holding unit” has a function of holding the member team identification information that identifies the member or the team composed of members to achieve the goal of the project.

The “member team project management information relationship holding unit” has a function of holding the member team project management information relationship that associates the member team identification information with the project management information in which the member team is engaged.

The “member team project management information relationship output unit” has a function of outputting the held member team project management information relationship.

<Hardware Configuration>

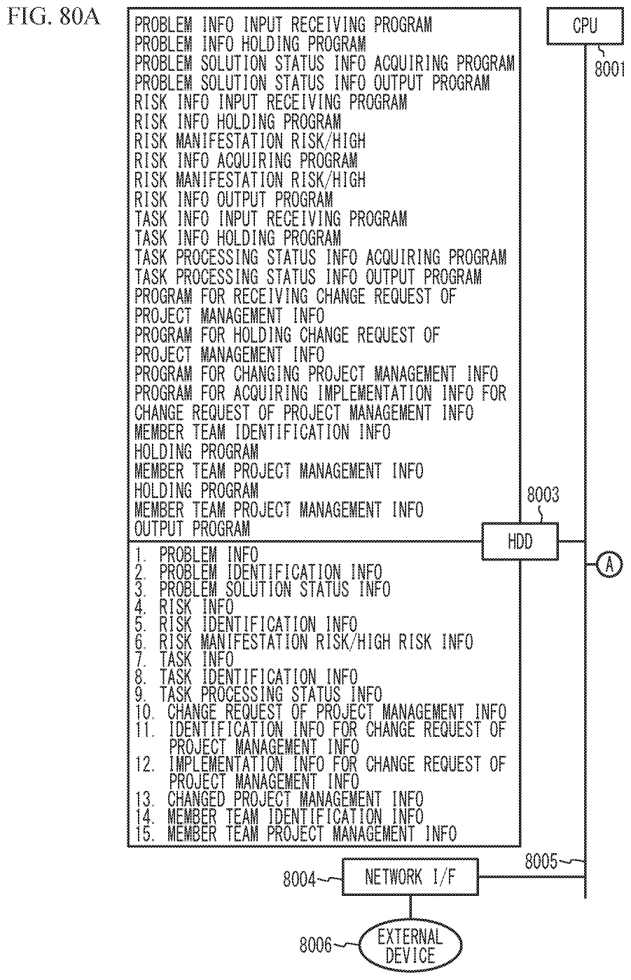

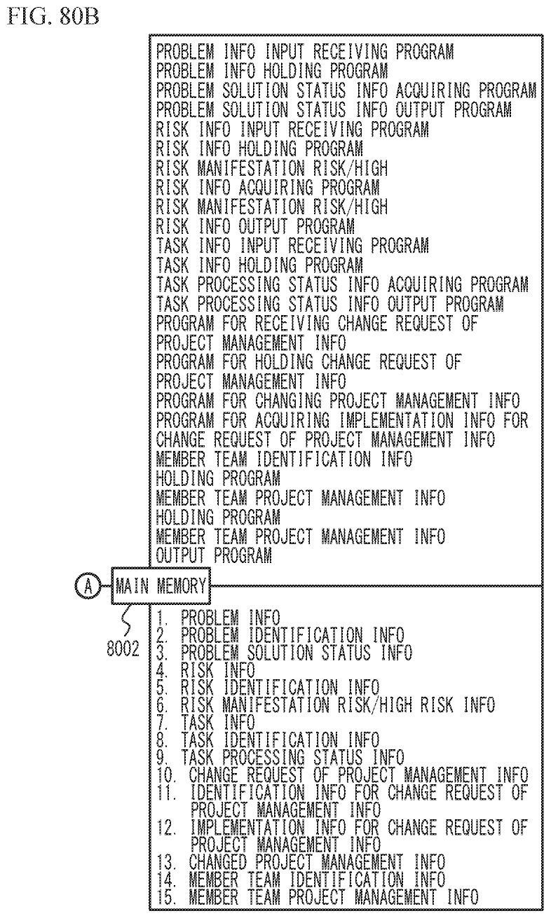

FIGS. 80A and 80B are diagrams illustrating the hardware configuration of the project management system according to the seventeenth embodiment. As illustrated in FIGS. 80A and 80B, the project management system according to the seventeenth embodiment includes a “CPU (central processing unit)” (8001) which performs various arithmetic operations, and a “main memory” (8002). Further, the project management system includes a “HDD” (8003) that holds predetermined information, and a “network I/F (interface)” (8004) that transmits and receives information to and from user terminal devices (8006) associated with a plurality of user identification information. The CPU, the main memory, the HDD and the network I/F are connected to each other by a data communication path such as a “system bus” (8005) to transmit and receive information and perform processing.

The main memory is used to read programs for various processes to be executed by the CPU, and at the same time, it provides a work area for the programs. A plurality of address is assigned to each of the main memory and the CPU. The programs executed by the CPU can exchange data with each other and perform processing by specifying and accessing the address.

In the present embodiment, the programs stored in the main memory are the problem information input receiving program, the problem information holding program, the problem solution status information acquiring program, the problem solution status information output program, the risk information input receiving program, the risk information holding program, the risk manifestation risk/high risk information acquiring program, the risk manifestation risk/high risk information output program, the task information input receiving program, the task information holding program, the task processing status information acquiring program, the task processing status information output program, the program for receiving change request of project management information, the program for holding change request of project management information, the program for acquiring implementation information for change request of project management information, the program for changing project management information, a member team identification information holding program, a member team project management information relationship holding program, and a member team project management information relationship output program.

In addition, each of the main memory and the HDD stores the problem information, the problem identification information, the problem solution status information, the risk information, the risk identification information, the risk manifestation risk/high risk information, the task information, the task identification information, the task processing status information, the change request of project management information, the identification information for the change request of the project management information, and the implementation information for the change request of the project management information, as in the first embodiment. In addition, in the present embodiment, member team identification information and member team project management information relationship are stored in each of the main memory and the HDD.

The CPU executes the problem information input receiving program stored in the main memory to receive one or more inputs of the problem information, which is the project management information and indicates the problem that must be resolved to achieve the goal of the project, through the network interface. The CPU executes the problem information holding program to store one or more problem information in association with the problem identification information. The CPU executes the problem solution status information acquiring program stored in the main memory to acquire the problem solution status information, which indicates a status in which the held problem is solved, in association with the problem identification information. The CPU executes the problem solution status information output program stored in the main memory to associate the held problem information and the problem solution status information with each other through the network interface to output an associated result.

Next, the CPU executes the risk information input receiving program stored in the main memory to receive one or more inputs of the risk information, which is the project management information and indicates the risk assumed under a predetermined condition in achieving the goal of the project, through the network interface. The CPU executes the risk information holding program to hold one or more input risk information in association with the risk identification information. The CPU executes the risk manifestation risk/high risk information acquiring program stored in the main memory to acquire the risk manifestation risk/high risk information, which indicates that the held risk has manifested or that the risk has increased, in association with the risk identification information. The CPU executes the risk manifestation risk/high risk status output program stored in the main memory to associate the held risk information and the risk manifestation risk/high risk information with each other through the network interface to output an associated result.

Next, the CPU executes the task information input receiving program stored in the main memory to receive one or more inputs of the task information, which is the project management information and indicates the task that must be processed to achieve the goal of the project, through the network interface. The CPU executes the task information holding program to store one or more input task information in association with the task identification information. The CPU executes the task processing status information acquiring program stored in the main memory to acquire the task processing status information that indicates the processing status of the held task in association with the task identification information. The CPU executes the task processing status information output program stored in the main memory to associate the held task information and the task processing status information with each other through the network interface to output an associated result.

Next, the CPU executes the program for receiving change request of project management information stored in the main memory to receive input of the change request of the project management information through the network interface. The CPU executes the program for holding change request of project management information to hold the received change request of the project management information in association with the identification information for the change request of the project management information. The CPU executes the program for acquiring implementation information for change request of project management information stored in the main memory to acquire the implementation information for the change request of the project management information, which indicates the implementation of the change request of the held project management information, in association with the identification information for the change request of the project management information. The CPU executes the program for changing project management information stored in the main memory to change the project management information based on the acquired implementation information for the change request of the project management information.

Next, the CPU executes the member team identification information holding program stored in the main memory to hold the member team identification information that identifies the member or the team composed of members to achieve the goal of the project. The CPU executes the member team project management information holding program stored in the main memory to hold the member team project management information relationship that associates the member team identification information with the project management information in which the member team is engaged. The CPU executes the member team project management information output program stored in the main memory to output the held member team project management information relationship.

<Flow of Processing>

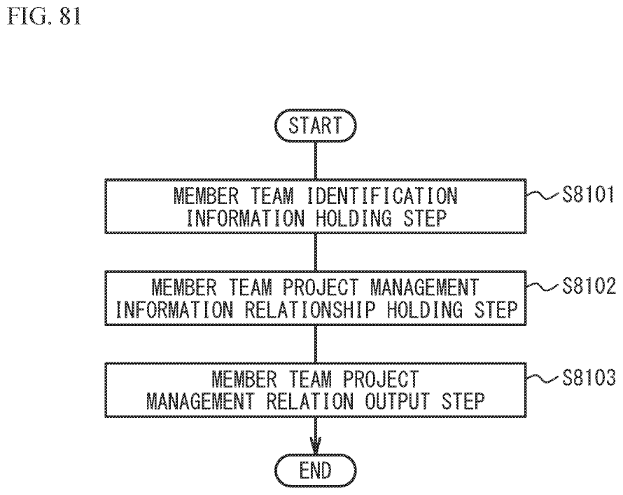

FIG. 81 is a flowchart illustrating processing when the project management system according to the seventeenth embodiment is used. The parts that overlap with the first embodiment are not illustrated in the figure, but it is assumed that the flow of processing in the first embodiment exists. In the seventeenth embodiment, there are a member team identification information holding step (S8101), a member team project management information relationship holding step (S8102) and a member team project management information relationship output step (S8103), in addition to the processing of the first embodiment, in any order. Hereinafter, the member team identification information holding step, the member team project management information relationship holding step and the member team project management information relationship output step will be described.

The “member team identification information holding step” holds the member team identification information that identifies the member or the team composed of members to achieve the goal of the project.

The “member team project management information relationship holding step” holds the member team project management information relationship that associates the member team identification information with the project management information in which the member team is engaged.

The “member team project management information relationship output step” outputs the held member team project management information relationship.

<Conclusion>

As described above, it is possible to provide a project management system that can manage the progress of the project (including the risk status and the stakeholders) not only for each project but also for each team.

What is claimed is:

1. A project management system comprising:
a memory;
a processor coupled to the memory and the processor configured to:
receive one or more inputs of problem information which is project management information and indicates a problem that must be resolved to achieve a goal of a project;
hold one or more problem information in association with the problem identification information;
acquire problem solution status information, which indicates a status in which the held problem is solved, in association with the problem identification information;
associate the held problem information and the problem solution status information with each other to output an associated result;
receive one or more inputs of risk information which is the project management information and indicates a risk assumed under a predetermined condition in achieving the goal of the project;
hold one or more input risk information in association with risk identification information;
acquire risk manifestation risk/high risk information, which indicates that the held risk has manifested or that the risk has increased, in association with the risk identification information;
associate the held risk information with the risk manifestation risk/high risk information with each other to output an associated result;
receive one or more inputs of task information which is the project management information and indicates a task that must be processed to achieve the goal of the project;
holding one or more input task information in association with task identification information;
acquire task processing status information which indicates a processing status of the held task, in association with the task identification information;
associate the held task information with the task processing status information to output an associated result;
receive an input of a change request of the project management information;
hold the received change request of the project management information in association with the identification information for the change request of the project management information;
acquire implementation information for the change request of the project management information, which indicates the implementation of the change request of the held project management information, in association with the identification information for the change request of the project management information; and
change the project management information based on the acquired implementation information for the change request of the project management information.

2. The project management system according to claim 1, wherein
the processor is further configured to:
acquire premise information, which is information that is a premise capable of identifying the project management information, in association with the project management information; and
hold the acquired premise information in association with the project management information.

3. The project management system according to claim 1, wherein
the processor is further configured to:
generate the problem information that must be solved based on the manifested risk and record the problem information in the problem information holding unit in association with the problem identification information, when the risk manifestation risk/high risk information, which is information indicating that the held risk has manifested, is acquired in association with the risk identification information.

4. The project management system according to claim 3, wherein
the processor is further configured to:
input the task information to be associated with the newly generated and held problem information, in association with the problem information.

5. The project management system according to claim 1, wherein
the processor is further configured to:
receive an input of experience information which includes successful experience information indicating a successful experience or/and failure experience information indicating a failure experience;
store the received experience information in association with the project identification information;
receive a viewing request of the stored experience information; and
allow a user to view the experience information according to the received viewing request.

6. The project management system according to claim 5, wherein
the experience information includes one or more pieces of text information, video information, attached document information, still image information, and audio information.

7. The project management system according to claim 5, wherein
the to receive an input of the experience information includes to receive an input of the experience information in association with the project management information.

8. The project management system according to claim 1, wherein
the to receive an input of the change request of the project management information includes to complete a reception by embedding information in a template for specifying contents of the change request.

9. The project management system according to claim 1, wherein
the to acquire implementation information for the change request of the project management information includes to generate the implementation information for the change request of the project management information, which is information to implement the change of the project management information, by embedding information in a template for specifying information necessary to implement the change request.

10. The project management system according to claim 1, wherein
the to receive one or more inputs of risk information includes to receive an input of the risk information according to a risk navigation template that prompts input of information to be clarified in order to objectify the risk.

11. The project management system according to claim 1, wherein
the to receive one or more inputs of risk information includes to receive an input of the risk information according to a risk quantification navigation template that prompts an input of information for quantifying the risk.

12. The project management system according to claim 1, wherein
the to associate the held risk information with the risk manifestation risk/high risk information includes to map the held risk information.

13. The project management system according to claim 1, wherein
the processor is further configured to:
acquire interrelated information which is information indicating an interrelationship of the problem information, the risk information, the task information and the premise information; and
hold the acquired interrelationship information.

14. The project management system according to claim 13, wherein
the processor is further configured to:
when the problem information and the task information are associated with each other, generate the problem solution status information, which is information indicating that the held problem has been solved, based on the task processing status information of the associated task information, and transmit the problem solution status information to the to acquire problem solution status information.

15. The project management system according to claim 1, wherein
the processor is further configured to:
receive an input of the change of premise information associated with the project management information; and
prompt a correction of the project management information associated with the premise information.

16. The project management system according to claim 1, wherein
the processor is further configured to:
receive an input of a stakeholder related to the achievement of the goal of the project in association with an index value indicating an attribute of the stakeholder;
generate a map of the stakeholder using the stakeholder and the received index value associated with the stakeholder; and
output the generated map.

17. The project management system according to claim 1, wherein
the processor is further configured to:
acquire status information map which is information that maps status information; and
output the acquired status information map.

18. The project management system according to claim 1, wherein
the processor is further configured to:
hold member team identification information that identifies a member or a team composed of members to achieve the goal of the project;
hold a member team project management information relationship that associates the member team identification information with the project management information in which a member team is engaged; and
output the held member team project management information relationship.

19. A method of operating a project management system executed by a computer to execute a process, the process comprising:
receiving one or more inputs of problem information which is project management information and indicates a problem that must be resolved to achieve a goal of a project;
holding one or more problem information in association with the problem identification information;
acquiring problem solution status information, which indicates a status in which the held problem is solved, in association with the problem identification information;
associating the held problem information and the problem solution status information with each other to output an associated result;
receiving one or more inputs of risk information which is the project management information and indicates a risk assumed under a predetermined condition in achieving the goal of the project;
holding one or more input risk information in association with risk identification information;
acquiring risk manifestation risk/high risk information, which indicates that the held risk has manifested or that the risk has increased, in association with the risk identification information;
associating the held risk information with the risk manifestation risk/high risk information with each other to output an associated result;
receiving one or more inputs of task information which is the project management information and indicates a task that must be processed to achieve the goal of the project;
holding one or more input task information in association with task identification information;
acquiring task processing status information which indicates a processing status of the held task, in association with the task identification information;
associating the held task information with the task processing status information to output an associated result;
receiving an input of a change request of the project management information;
holding the received change request of the project management information in association with the identification information for the change request of the project management information;
acquiring implementation information for the change request of the project management information, which indicates the implementation of the change request of the held project management information, in association with the identification information for the change request of the project management information; and
changing the project management information based on the acquired implementation information for the change request of the project management information.

20. A non-transitory computer-readable medium having stored therein a program for causing a computer to execute a process, the process comprising:
receiving one or more inputs of problem information which is project management information and indicates a problem that must be resolved to achieve a goal of a project;
holding one or more problem information in association with the problem identification information;
acquiring problem solution status information, which indicates a status in which the held problem is solved, in association with the problem identification information;
associating the held problem information and the problem solution status information with each other to output an associated result;
receiving one or more inputs of risk information which is the project management information and indicates a risk assumed under a predetermined condition in achieving the goal of the project;
holding one or more input risk information in association with risk identification information;
acquiring risk manifestation risk/high risk information, which indicates that the held risk has manifested or that the risk has increased, in association with the risk identification information;
associating the held risk information with the risk manifestation risk/high risk information with each other to output an associated result;
receiving one or more inputs of task information which is the project management information and indicates a task that must be processed to achieve the goal of the project;
holding one or more input task information in association with task identification information;
acquiring task processing status information which indicates a processing status of the held task, in association with the task identification information;
associating the held task information with the task processing status information to output an associated result;
receiving an input of a change request of the project management information;
holding the received change request of the project management information in association with the identification information for the change request of the project management information;
acquiring implementation information for the change request of the project management information, which indicates the implementation of the change request of the held project management information, in association with the identification information for the change request of the project management information; and
changing the project management information based on the acquired implementation information for the change request of the project management information.
